(19) United States
(12) Patent Application Publication
(10) Pub. No.: US 2025/0102874 A1
(43) Pub. Date: Mar. 27, 2025

(54) ELECTROCHROMIC DEVICE WITH MAXIMUM LOCAL CELL POTENTIAL ALIGNED WITH SENSE VOLTAGE

(71) Applicant: HALIO, INC., HAYWARD, CA (US)

(72) Inventors: HUGUES DUNCAN, HAYWARD, CA (US); GREGG HIGASHI, Hayward, CA (US); HOWARD S. BERGH, HAYWARD, CA (US)

(21) Appl. No.: 18/898,524

(22) Filed: Sep. 26, 2024

Related U.S. Application Data
(60) Provisional application No. 63/585,889, filed on Sep. 27, 2023.

(51) Int. Cl. G02F 1/155; G02F 1/153; G02F 1/163; G09G 3/38

(52) U.S. Cl. CPC G02F 1/155; G02F 1/1533; G02F 1/163; G09G 3/38; G02F 2001/1552; G09G 2310/0243

(57) ABSTRACT

An electrochromic device is provided. The device includes a first transparent substrate, a second transparent substrate, a first electrically conductive layer with a first resistance gradient arranged on an inner surface of the first transparent substrate, a second electrically conductive layer with a second resistance gradient arranged on an inner surface of the second transparent substrate. The device includes a first bus bar in contact with the first electrically conductive layer, a second bus bar in contact with the second electrically conductive layer, a first sense voltage pad arranged on the inner surface of the first transparent substrate configured to measure a local cell potential at a sense voltage measurement position within the electrochromic device, wherein the first and second resistance gradients are configured to form a region comprising a maximum local cell potential approximately coinciding with the sense voltage measurement position.

### CROSS REFERENCE TO RELATED APPLICATIONS

This application is a non-provisional application for patent entitled to a filing date and claiming the benefit of earlier-filed U.S. Patent Provisional Application No. 63/585,889, filed Sep. 27, 2023, which is hereby incorporated herein by reference in its entirety.

### BACKGROUND

Commercial switchable glazing devices are well known for use as mirrors in motor vehicles, automotive windows, aircraft window assemblies, sunroofs, skylights, and architectural windows. Such devices may comprise, for example, inorganic electrochromic devices, organic electrochromic devices, switchable mirrors, and hybrids of these having two conducting layers with one or more active layers between the conducting layers. When a voltage is applied across these conducting layers the optical properties of a layer or layers in between change. Such optical property changes are typically a modulation of the transmissivity of the visible or the solar subportion of the electromagnetic spectrum. For convenience, the two optical states will be referred to as a lightened state and a darkened state in the following discussion, but it should be understood that these are merely examples and relative terms (i.e., one of the two states is “lighter” or more transmissive than the other state) and that there could be a set of lightened and darkened states between the extremes that are attainable for a specific electrochromic device; for example, it is feasible to switch between intermediate lightened and darkened states in such a set.

Switching between a lightened and a darkened state in relatively small electrochromic devices such as an electrochromic rear-view mirror assembly is typically quick and uniform, whereas switching between the lightened and darkened state in a large area electrochromic device can be slow and spatially non-uniform. Gradual, non-uniform coloring or switching is a common problem associated with large area electrochromic devices. This problem, commonly referred to as the “iris effect,” is typically the result of the voltage drop through the transparent conductive coatings providing electrical contact to one side or both sides of the device. For example, when a voltage is initially applied to the device, the potential is typically the greatest in the vicinity of the edge of the device (where the voltage is applied) and the least at the center of the device. As a result, there may be a significant difference between the transmissivity near the edge of the device and the transmissivity at the center of the device. Over time, however, the difference in applied voltage between the center and edge decreases and the difference in transmissivity at the center and edge of the device decreases. In such circumstances, the electrochromic medium will typically display non-uniform transmissivity by initially changing the transmissivity of the device in the vicinity of the applied potential, with the transmissivity gradually and progressively changing towards the center of the device as the switching progresses. While the iris effect is most commonly observed in relatively large devices, it also can be present in smaller devices that have correspondingly higher resistivity conducting layers.

### BRIEF DESCRIPTION OF THE DRAWINGS

To facilitate further description of the embodiments, the following drawings are provided in which:

FIG. 1A is a schematic cross-section of a multi-layer electrochromic device, in accordance with some embodiments.

FIGS. 1B and 1C show schematic examples of electrochromic devices including a sense voltage pad, in accordance with some embodiments.

FIG. 2 is a schematic of an electrochromic device with a substrate 2008, an electrically conductive layer 2001 on top of the substrate, and a bus bar applied to one edge 2003.

FIG. 3A is schematic of a top electrically conductive layer 2001, a bottom electrically conductive layer 2002, a contact (bus bar 2003) to the top electrically conductive layer is made at x=0, and a contact (bus bar 2004) to the bottom electrically conductive layer is made at x=xₜ,

FIG. 3B includes a plot of R(x), the sheet resistance of the top electrically conductive layer 2001 in FIG. 3A as a function of position (x), and R′(x), and the sheet resistance of the bottom electrically conductive layer 2002 in FIG. 3A as a function of position (x), in an embodiment.

FIG. 4 is a schematic of a patterned electrically conductive layer 301 with a transparent conducting material with a number of sets of scribed lines 302, which are patterned into the transparent conducting material. The dark areas in the magnified region in FIG. 4 are a pattern of lines that represent gaps in the electrically conductive layer.

FIG. 5 is a schematic of a patterned electrically conductive layer 301 with a transparent conducting material with a number of sets of scribed lines 302, which are patterned into the transparent conducting material. FIG. 5 shows an example where the sets of scribed lines all contain 2 scribed lines, the valve width 306 and the offset 308 between segments in adjacent scribed lines are all constant for every set of scribed lines xₙ, but the length of the scribed segments 304a, 304b and 304c are different for different sets of scribed lines, causing the resistance to the flow of electrons traversing a set of scribed lines to be different for different sets of scribed lines.

FIG. 6 is a schematic of a patterned electrically conductive layer 3501 with a transparent conducting material with a number of sets of scribed lines 3502 patterned into the transparent conducting material, and a bus bar 3511. Additionally, FIG. 6 includes a plot of resistance between the bus bar and a line parallel to the bus bar is (where the bus bar is at x=0, and the parallel line is at a position x) versus position (x), for different embodiments.

FIG. 7 shows simulated electrical potential maps of an example patterned electrically conductive layer.

FIG. 8 is a schematic of a patterned electrically conductive layer 301 with a transparent conducting material with a number of sets of scribed lines 302, which are patterned into the transparent conducting material.

FIG. 9 is a plot of resistance between the bus bar and a line parallel to the bus bar is (where the bus bar is at x=0, and the parallel line is at a position x) versus position (x), for uniform and a varying electrically conductive layer embodiments.

FIGS. 10A-10E are a series of contour maps of the sheet resistance, Rₛ, in the first and/or second electrically conductive layer as a function of position (two-dimensional) within the first and/or second electrically conductive layer showing isoresistance lines (also sometimes referred to as contour lines) and resistance gradient lines (lines perpendicular to the isoresistance lines) resulting from various alternative arrangements of bus bars for devices having square and circular perimeters.

FIGS. 11A-11D are a series of schematics of a patterned electrically conductive layer 3201 with a transparent conducting material with a number of sets of scribed lines 3202, which are patterned into the transparent conducting material. The dark areas forming the patterns of lines in the magnified regions in FIGS. 11A-11D represent gaps in the electrically conductive layer.

FIGS. 12A-12S include non-rectangular electrochromic device structures, and details and results of modeling the device structures, in accordance with some embodiments.

FIGS. 13A and 13B show schematic examples of electrochromic devices with scribed lines that form resistance gradients in electrically conductive layers, in accordance with some embodiments.

FIGS. 14A-14G show examples of non-rectangular electrochromic devices with bus bars and sense voltage pads, in accordance with some embodiments.

FIG. 15 is an exploded view of the multi-layer device of FIG. 1.

FIG. 16A is a plot of the sheet resistance profile along a resistance gradient line for a single rectangular electrically conductive layer with a geometry similar that shown in FIGS. 2, 3A and 3B.

FIG. 16B is a plot of the resistance of sets of scribed lines that will approximate the sheet resistance profile shown in FIG. 13A.

FIG. 17A is a plot of the sheet resistance profile along resistance gradient lines for both substrates in the simple geometry described in FIG. 3A.

FIG. 17B is a plot of the resistance of sets of scribed lines that will approximate the sheet resistance profiles shown in FIG. 14A.

FIG. 18 is a plot of the transmission over time of an electrochromic device incorporating a patterned electrically conductive layer while switching from a bleached to a darkened state. The transmission of the device is shown at two different locations, one close to the center of the device and one approximately 2 cm from the edge of the device near one of the bus bars.

FIG. 19 is a plot of the difference in transmission near the edge of the device subtracted from the transmission near the center of the device for uniform and the patterned electrochromic devices.

FIG. 20A shows sheet resistance profiles.

FIG. 20B shows the resistance of sets of scribed lines used to simulate the sheet resistance profiles in FIG. 20A.

FIG. 21 shows differences in transmission at different positions on a device.

FIG. 22A shows an image (optical photograph) of a device during bleaching and FIG. 22B shows an image of the same device during darkening.

FIG. 22C shows an image (optical photograph) of a device during bleaching, with the contrast increased to accentuate the pattern. FIG. 22D is a zoomed in area of FIG. 22C.

FIG. 23 shows an example of a non-rectangular electrochromic device 120 s after it has started switching from bleached to dark, in accordance with some embodiments.

FIGS. 24A and 24B show examples of electrochromic devices 120 s after they have started switching from bleached to dark, in accordance with some embodiments.

FIGS. 25A and 25B show examples of electrochromic devices 120 s after they have started switching from bleached to dark, in accordance with some embodiments.

FIGS. 25C and 25D show examples of regions of the scribe patterns that show how they were varied in the x- and y-directions to form resistance gradients of the respective devices shown in FIGS. 25A and 25B, in accordance with some embodiments.

FIGS. 26A and 26B show top-down schematics of the sense voltage pads and on the anode side of the device and on the cathode side of the device, respectively, in accordance with some embodiments.

FIGS. 27A and 27B each show a time series of an electrochromic window during switching from bleached to dark, in accordance with some embodiments.

Corresponding reference characters indicate corresponding parts throughout the drawings. Additionally, relative thicknesses of the layers in the different figures do not represent the true relationship in dimensions. For example, the substrates are typically much thicker than the other layers. The figures are drawn only for the purpose to illustrate connection principles, not to give any dimensional information.

### ABBREVIATIONS AND DEFINITIONS

The following definitions and methods are provided to better define the present disclosure and to guide those of ordinary skill in the art in the practice of the present disclosure. Unless otherwise noted, terms are to be understood according to conventional usage by those of ordinary skill in the relevant art.

The term “anodic electrochromic layer” refers to an electrode layer that changes from a more transmissive state to a less transmissive state upon the removal of ions.

The term “cathodic electrochromic layer” refers to an electrode layer that changes from a more transmissive state to a less transmissive state upon the insertion of ions.

The terms “conductive” and “resistive” refer to the electrical conductivity and electrical resistivity of a material.

The term “convex polygon” refers to a simple polygon in which every internal angle is less than or equal to 180 degrees, and every line segment between two vertices remains inside or on the boundary of the polygon. Some examples of convex polygons include triangles, rectangles, pentagons, hexagons, etc., in which every internal angle is less than or equal to 180 degrees and every line segment between two vertices remains inside or on the boundary of the polygon.

The term “cross-layer resistance” as used in connection with a layer (or an elongate structure) is the resistance to current flow substantially normal to a major surface of the layer (or the elongate structure).

The term “electrically conductive layer” refers to a layer capable of conducting electrons. Electrically conductive layers can also transport ions, in some cases. Some examples of electrically conductive layers include transparent conductive oxide layers, conductive nanowires embedded in a conductive or non-conductive matrix, and thin (e.g., less than 100 nm, or less than 10 nm) layers of metal.

The term “electrochromic layer” refers to a layer comprising an electrochromic material.

The term “electrochromic material” refers to materials that are able to change their optical properties, reversibly, as a result of the insertion or extraction of ions and electrons. For example, an electrochromic material may change between a colored, translucent state and a transparent state.

The term “electrode layer” refers to a layer capable of conducting ions as well as electrons. The electrode layer contains a species that can be oxidized when ions are inserted into the material and contains a species that can be reduced when ions are extracted from the layer. This change in oxidation state of a species in the electrode layer is responsible for the change in optical properties in the device.

The term “electrical potential,” or simply “potential,” refers to the voltage occurring across a device comprising an electrode/ion conductor/electrode stack.

The term “overdriven” refers to the application of an electrical potential (i.e., a voltage) to an electrochromic device or a local region of an electrochromic device that is above a predetermined threshold. For example, a region of a device can be overdriven if a voltage is applied to bus bars of the device that causes the local cell potential of the region of the device to exceed a threshold (e.g., greater than 1.5 V, or greater than 1.6 V). The threshold can be determined (e.g., experimentally) to be a limit above which the device is more likely to be damaged or accelerated degradation is more likely to occur.

The term “sheet resistance” as used in connection with a layer (or an elongate structure) is the resistance to current flow substantially parallel to a major surface of the layer (or the elongate structure). In patterned layers, the sheet resistance refers to the current flow substantially parallel to a major surface of the layer (or the elongate structure) when measured at a length scale larger than that of the patterned features, such that the measured sheet resistance includes the effect of the patterned features.

The term “transmissive” is used to denote transmission of electromagnetic radiation through a material.

The term “transparent” is used to denote substantial transmission of electromagnetic radiation through a material such that, for example, bodies situated beyond or behind the material can be distinctly seen or imaged using appropriate image sensing technology.

### DETAILED DESCRIPTION

This disclosure describes electrochromic devices including electrically conductive layers with gradients in electrical resistance (or variation in electrical resistance, or gradients in sheet resistance). The gradients in electrical resistance can be configured to form a region of maximum local cell potential (or voltage drop across the electrochromic device). The position of a sense voltage pad is aligned with the region of maximum local cell potential. The sense voltage pad can be formed, for example, by isolating (e.g., by scribing or etching) an area of the electrically conductive layer. Devices with gradients in electrical resistance that intentionally produce such non-uniform local cell potentials across the device can be beneficial.

Such configurations are advantageous because measurements from the sense voltage pad can be used by a driver during device switching, for example by measuring a sense voltage and applying a variable voltage and current such that the sense voltage is maintained at or below a predetermined threshold. Configuring the gradients in electrical resistance of the electrically conductive layers to form the region of maximum local cell potential (or voltage drop) at the position of the sense voltage pad can therefore serve to prevent any unmonitored areas from being overdriven (i.e., experiencing a local cell potential above a threshold wherein damage or accelerated degradation can (or is more likely to) occur).

The gradients in electrical resistance can be configured in other ways alternatively or in addition to being configured to form a region of maximum local cell potential. For example, the gradients in electrical resistance can be configured to improve the switching uniformity and/or speed of an electrochromic device, for example, in a device that is either rectangular or non-rectangular. Some examples of non-rectangular electrochromic devices are those that have shapes that are trapezoidal (e.g., right trapezoidal), triangular, pentagonal, circular, ovular, semicircular, or compound rectilinear.

In some cases, electrochromic devices with uniform electrically conductive layers (i.e., without gradients in electrical resistance) will switch non-uniformly (e.g., with an iris, or faster near one bus bar than another). The electrochromic devices with gradients in electrical resistance described herein are enabled to have more spatially uniform optical properties during switching between different light transmission levels than devices with no gradients in electrical resistance. In other words, the electrochromic devices will more uniformly tint or lighten in color across the entire device during a transition between tint levels. This “uniform switching” (or more uniform switching, or improved switching uniformity) can be enabled by creating a gradient transparent conductive layer in contact with the electrodes of the electrochromic device. This gradient transparent conductive layer has the effect of mitigating the drop in effective voltage across a substrate. This is most noticeable in large scale electrochromic devices with enough distance between the bus bars that there is a significant drop in effective voltage.

Gradients in electrical resistance used to provide improved switching uniformity can additionally be modified such that a region of maximum local cell potential (or voltage drop) is formed, which is aligned to a sense voltage pad. Intentionally including this type of non-uniformity in the gradient in electrical resistance can be advantageous, since it can help prevent other regions of the device (i.e., those that are not aligned with the sense voltage pad) from being overdriven. In some cases, the region of maximum local cell potential is configured to align with a predetermined position of the sense voltage pad (e.g., due to manufacturing or practical considerations, such as manufacturing equipment setups or limitations, or a requirement that all electrical connections be near certain edges or corners of a device). In other cases, a position of a sense voltage pad can be aligned with a position of the maximum local cell potential (e.g., in cases where the geometry of the device and bus bars makes it easier to form a region of maximum local cell potential in some regions).

In some cases, the electrochromic devices with gradients in electrical resistance described herein are enabled to have improved spatial uniformity of the optical properties during switching between different light transmission levels, but the switching is non-uniform (e.g., even in models, the switching (or local cell potential across the entire active area of the device) is non-uniform). In such cases with non-uniform switching, the gradients in electrical resistance of the electrically conductive layers can be configured to form a region of maximum local cell potential (or voltage drop) at the position of the sense voltage pad, thereby preventing unmonitored areas of such devices from being overdriven. There can be several reasons for electrochromic devices lacking perfect uniformity in switching (or in local cell potential during switching). For example, electrochromic devices with non-rectangular substrates and/or irregular bus bars can present challenges which make it difficult (or impossible) for the devices to have perfect uniformity during switching. In some cases, manufacturing constraints can limit the types of gradients that can be manufactured, thereby preventing a device from switching uniformly across the entire active area. Additionally, real-world manufacturing variations can cause regions of substantially uniform devices to experience higher local cell potentials, and therefore it can be advantageous to configure the gradients in resistance of the electrically conductive layers to intentionally form a region of slightly higher local cell potential that is aligned with a sense voltage pad. In other words, it can be advantageous to configure the devices to be non-uniform (or more non-uniform), by having a region of higher local cell potential aligned with the sense voltage pad.

Gradients in the electrical resistance in electrically conductive layers are described that can provide uniform switching (or improved uniformity during switching) in electrochromic devices, and can form a region of maximum local cell potential aligned with a sense voltage pad. For example, gradients in the electrical resistance can be formed using patterns in a transparent conductive layer having a uniform thickness across the substrate of the electrochromic device. Methods of forming the patterns using etching, and in particular laser etching or scribing, are described herein. In some embodiments, a patterned transparent conducting layer having a number of sets of scribed lines and an electrochromic device incorporating such a gradient patterned transparent conducting layer is described. In other cases, the gradients in the electrical resistance can be formed using thickness variation or electrical property variation of transparent conductive layers.

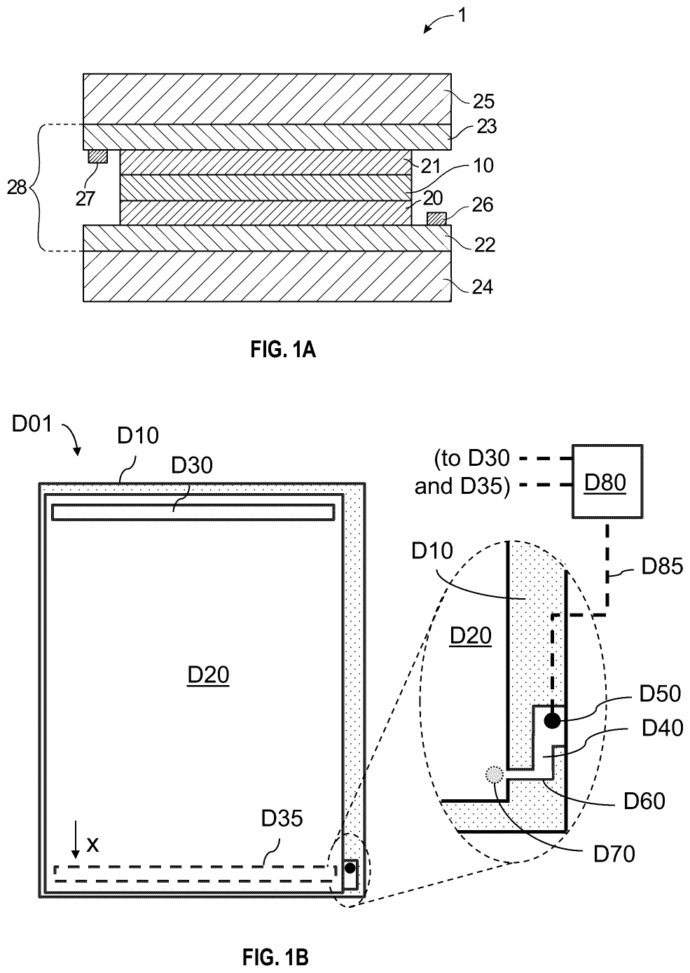

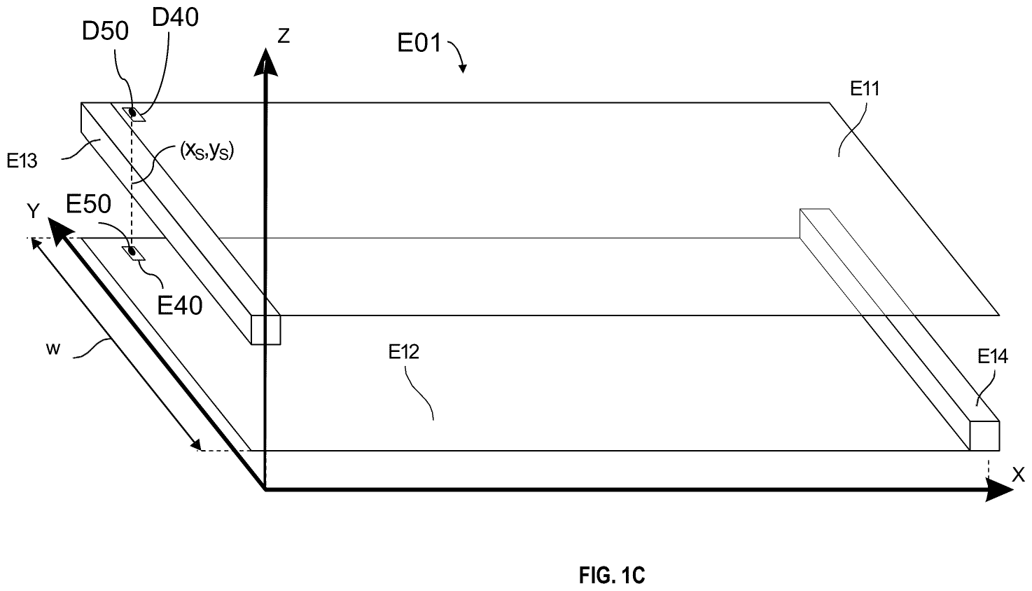

FIG. 1A depicts a cross-sectional structural diagram of electrochromic device 1 according to some embodiments. Moving outward from the center, electrochromic device 1 comprises an ion conductor layer 10. First electrode layer 20 is on one side of and in contact with a first surface of ion conductor layer 10, and second electrode layer 21 is on the other side of and in contact with a second surface of ion conductor layer 10. In addition, at least one of first and second electrode layers 20, 21 comprises electrochromic material; in one embodiment, first and second electrode layers 20, 21 each comprise electrochromic material. The central structure, that is, layers 20, 10, 21, is positioned between first and second electrically conductive layers 22 and 23 that are formed of gradient transparent conductive layers. These electrically conductive layers are arranged against outer substrates 24, 25. Elements 22, 20, 10, 21, and 23 are collectively referred to as an electrochromic stack 28.

Electrically conductive layer 22 is in electrical contact with one terminal of a power supply (not shown) via bus bar 26 and electrically conductive layer 23 is in electrical contact with the other terminal of a power supply (not shown) via bus bar 27 whereby the transmissivity of electrochromic device 10 may be changed by applying a voltage that causes electrons and ions to move between first and second electrode layers 20 and 21 and, as a result, electrochromic material in the first and/or second electrode layer(s) change(s) optical states, thereby switching electrochromic device 1 from a more transmissive state to a less transmissive state, or from a less transmissive state to a more transmissive state. In one embodiment, electrochromic device 1 is transparent before the voltage pulse and less transmissive (e.g., more reflective or colored) after the voltage pulse or vice versa.

It should be understood that the reference to a transition between a less transmissive and a more transmissive state is non-limiting and is intended to describe the entire range of transitions attainable by electrochromic materials to the transmissivity of electromagnetic radiation. For example, the change in transmissivity may be a change from a first optical state to a second optical state that is (i) relatively more absorptive (i.e., less transmissive) than the first state, (ii) relatively less absorptive (i.e., more transmissive) than the first state, (iii) relatively more reflective (i.e., less transmissive) than the first state, (iv) relatively less reflective (i.e., more transmissive) than the first state, (v) relatively more reflective and more absorptive (i.e., less transmissive) than the first state or (vi) relatively less reflective and less absorptive (i.e., more transmissive) than the first state. Additionally, the change may be between the two extreme optical states attainable by an electrochromic device, e.g., between a first transparent state and a second state, the second state being opaque or reflective (mirror). Alternatively, the change may be between two optical states, at least one of which is intermediate along the spectrum between the two extreme states (e.g., transparent and opaque or transparent and mirror) attainable for a specific electrochromic device. Unless otherwise specified herein, whenever reference is made to a less transmissive and a more transmissive, or even a bleached-colored transition, the corresponding device or process encompasses other optical state transitions such as non-reflective-reflective, transparent-opaque, etc. Further, the term “bleached” refers to an optically neutral state, e.g., uncolored, transparent or translucent. Still further, unless specified otherwise herein, the “color” of an electrochromic transition is not limited to any particular wavelength or range of wavelengths. As understood by those of skill in the art, the choice of appropriate electrochromic and counter electrode materials governs the relevant optical transition.

In general, the change in transmissivity preferably comprises a change in transmissivity to electromagnetic radiation having a wavelength in the range of infrared to ultraviolet radiation. For example, in one embodiment the change in transmissivity is predominately a change in transmissivity to electromagnetic radiation in the infrared spectrum. In a second embodiment, the change in transmissivity is to electromagnetic radiation having wavelengths predominately in the visible spectrum. In a third embodiment, the change in transmissivity is to electromagnetic radiation having wavelengths predominately in the ultraviolet spectrum. In a fourth embodiment, the change in transmissivity is to electromagnetic radiation having wavelengths predominately in the ultraviolet and visible spectra. In a fifth embodiment, the change in transmissivity is to electromagnetic radiation having wavelengths predominately in the infrared and visible spectra. In a sixth embodiment, the change in transmissivity is to electromagnetic radiation having wavelengths predominately in the ultraviolet, visible and infrared spectra.

The materials making up electrochromic stack 28 may comprise organic or inorganic materials, and they may be solid or liquid. For example, in certain embodiments the electrochromic stack 28 comprises materials that are inorganic, solid (i.e., in the solid state), or both inorganic and solid. Inorganic materials have shown better reliability in architectural applications. Materials in the solid state can also offer the advantage of not having containment and leakage issues, as materials in the liquid state often do. It should be understood that any one or more of the layers in the stack may contain some amount of organic material, but in many implementations one or more of the layers contains little or no organic matter. The same can be said for liquids that may be present in one or more layers in small amounts. In certain other embodiments some or all of the materials making up electrochromic stack 28 are organic. Organic ion conductors can offer higher mobilities and thus potentially better device switching performance. Organic electrochromic layers can provide higher contrast ratios and more diverse color options. Each of the layers in the electrochromic device is discussed in detail, below. It should also be understood that solid state material may be deposited or otherwise formed by processes employing liquid components such as certain processes employing sol-gels or chemical vapor deposition.

Referring again to FIG. 1A, the power supply (not shown) connected to bus bars 26, 27 is typically a voltage source with optional current limits or current control features and may be configured to operate in conjunction with local thermal, photosensitive or other environmental sensors. The voltage source may also be configured to interface with an energy management system, such as a computer system that controls the electrochromic device according to factors such as the time of year, time of day, and measured environmental conditions. Such an energy management system, in conjunction with large area electrochromic devices (e.g., an electrochromic architectural window), can dramatically lower the energy consumption of a building.

In some embodiments, an electrochromic device includes: two electrically conductive layers, wherein one or more of the electrically conductive layers has a gradient in electrical resistance (or sheet resistance); at least two bus bars; and a sense voltage pad that is configured to measure a local cell potential at a sense voltage measurement position within the electrochromic device. In some cases, the electrochromic device can include two sense voltage pads (on opposite substrates of the electrochromic device), and the sense voltage can be measured between the two sense voltage pads. In some cases, the electrochromic device can include one sense voltage pad, and the sense voltage can be measured between the sense voltage pad and a bus bar. Additionally, the gradient(s) in electrical resistance (or sheet resistance) of the one or more electrically conductive layers can be configured (or optimized, or tailored, or designed) for use with the sense voltage. For example, the gradient of the electrical resistance of the one or more electrically conductive layers can be configured to approximately align the sense voltage pad with a region that experiences a maximum voltage drop between the electrically conductive layers during switching. This can be beneficial since it can help avoid the application of a voltage that could cause a region of the electrochromic device to experience a voltage drop that exceeds a threshold voltage that could damage the electrochromic device (e.g., cause immediate damage, an acceleration of degradation, or a reduction of durability of the device). It can also be beneficial to apply as much voltage to the device as possible, to switch the device as quickly as possible, while avoiding damage (or accelerating degradation of the device). The gradients in electrical resistance in the one or more electrically conductive layers can be formed using any methods, for example, patterning a transparent conductive material (e.g., a transparent conducting oxide), varying the thickness of a transparent conductive material, varying the concentration of defects of a transparent conductive material, or varying the properties of a transparent conductive material (e.g., varying the concentration of conductive nanowires embedded in a matrix), as described further herein.

FIG. 1B shows a schematic example of an electrochromic device D01 including a sense voltage pad D40 that is defined by isolation scribes D60. The substrate D10 is shown with an electrically conductive layer D20 coupled to the substrate D10. Bus bar D30 is coupled to electrically conductive layer D20, and bus bar D35 is coupled to an electrically conductive layer on the opposite substrate (not visible in FIG. 1B). Sense voltage pad D40, in this example, is formed by removing the electrically conductive layer D20 along edges D60 (e.g., using laser scribing, or chemical etching). In FIG. 1B, the electrically conductive layer D20 does not extend to the edge of the substrate D10. However, in other examples, the electrically conductive layer D20 extends to the edge of the substrate D10, and edges D60 can be lines scribed in the electrically conductive layer D20 such that edges D60 define the shape of the sense voltage pad D40. A sense voltage terminal D50 is also shown, which is a region wherein the sense voltage pad D40 can be coupled to a driver D80 using a circuit D85. Circuit D85 can contain one or more of a connector, a flex circuit, a wire, a ribbon, and other means to electrically couple the sense voltage terminal D50 to the driver D80. Bus bars D30 and D35 can also be separately coupled to driver D80 to control the electrochromic device such that driver D80 can separately address the first bus bar D30, the second bus bar D35, and the sense voltage terminal D50.

In the example shown in FIG. 1B, sense voltage pad D40 is coupled to the electrically conductive layer D20 and configured to measure a sense voltage (or a local cell potential) at sense voltage measurement position D70, which is within the active area of the device D01. Scribed lines D60 form sense voltage pad D40 to include a thin region (or TCO wire, in some examples) coupling sense voltage terminal D50 to the sense voltage measurement position D70. A sense voltage measurement can be made using the driver D80 with very little current flowing through the sense voltage pad D40, and the voltage drop between sense voltage measurement position D70 and sense voltage terminal D50 can be small. Sense voltage pad D40 can therefore be used to measure a local cell potential in device D01 at the sense voltage measurement position D70. In this example, sense voltage pad D40 is proximate to, or adjacent to, sense voltage measurement position D70. In this example, sense voltage terminal D50 is proximate to, or adjacent to, sense voltage measurement position D70. In other examples, sense voltage terminal D50 can be physically spaced apart from sense voltage measurement position D70, and coupled to sense voltage measurement position D70 such that there is a small voltage drop (e.g., less than 100 mV, or less than 50 mV) between sense voltage terminal D50 and sense voltage measurement position D70. In some cases, sense voltage pad D40 is proximate to sense voltage measurement position D70 such that a sense voltage measured at the sense voltage pad D40 and the sense voltage terminal D50 is approximately equal to the local cell potential at sense voltage measurement position D70.

FIG. 1C shows a schematic example of an electrochromic device E01 including two sense voltage pads D40 and E40 that are coupled to substrates E11 ands E12, respectively. Sense voltage pads D40 and E40 can be configured similarly to sense voltage pad D40 in FIG. 1B, and the corresponding sense voltage measurement positions (e.g., D70 in FIG. 1B) can be vertically aligned along position (xₛ,yₛ). For example, electrically conductive layers on substrates E11 and E12 can be scribed or etched to form sense voltage pads D40 and E40. A sense voltage measured between sense voltage pads D40 and E40 would provide a measure of the local cell potential (or voltage drop) between the electrically conductive layer on substrate E11 and the electrically conductive layer on substrate E12 at position (xₛ,yₛ). Sense voltage pads D40 and E40 and bus bars E13 and E14 can provide a 4-terminal measurement of the local cell potential at position (xₛ,yₛ), since the system can be configured such that no (or very little) current flows between voltage pads D40 and E40. For example, a potential can be applied to bus bars E13 and E14 causing current to flow between them during switching, while measurement circuitry (e.g., in the driver) can be configured such that no (or very little) current flows between sense voltage pads D40 and E40.

Since the sense voltage pad D40 is close to the bus bar E13 the voltage difference between sense voltage pad D40 and bus bar E13 can be small, and in such cases, the sense voltage at position (xₛ,yₛ) can also be measured between sense voltage pad E40 and bus bar E13. However, such a measurement of the sense voltage at position (xₛ,yₛ) can be less accurate than a measurement using sense voltage pads D40 and E40. On the other hand, bus bar E14 is far away from sense voltage pad E40 (and from position (xₛ,yₛ)), and therefore bus bar E14 cannot be used to measure the sense voltage at the position (xₛ,yₛ) in the electrochromic device E01.

Although the examples shown in FIGS. 1B and 1C include rectangular substrates, electrochromic devices D01 and E01 can have non-rectangular substrates in some embodiments. Sense voltage pad(s) can be particularly useful for non-rectangular substrates since they can have non-uniform (or non-monotonic) variations in the voltage drops across the devices. The gradient(s) of the electrical resistance of the one or more electrically conductive layers can be configured to form a region of the device that experiences the maximum voltage drop between the non-rectangular electrically conductive layers, and approximately align that region with the sense voltage pad, which can therefore help prevent damaging the device (or accelerating degradation of the device) by overdriving a region during switching.

In some embodiments, an electronic driver for the above electrochromic device (e.g., D01 in FIG. 1B, or E01 in FIG. 1C) is provided. The driver includes a power supply and a power supply control module configured to perform actions. The actions include supplying a constant current from the power supply to the electrochromic device (using the at least two bus bars) and stopping the supplying the constant current when one of a sense voltage (measured using the sense voltage pad) of the electrochromic device attains a sense voltage limit or an amount of charge transferred to the electrochromic device attains a target amount of charge. The actions can include controlling one of a variable voltage or a variable current from the power supply to the electrochromic device (using the at least two bus bars) to maintain the sense voltage at (or below) the sense voltage limit while the amount of charge transferred to the electrochromic device is less than the target amount of charge. In other cases, the variable voltage or variable current can be stopped in response to a time limit being reached, or the current flow dropping below a predetermined threshold. The sense voltage can provide a measurement of a local cell potential (or voltage drop) in the vicinity of the sense voltage pad, as described above.

In some embodiments, an electronic driver for the above electrochromic device (e.g., D01 in FIG. 1B, or E01 in FIG. 1C) is provided. The driver includes a voltage detecting circuit configured to measure a sense voltage of sense voltage terminals (wherein one or both of the terminals are coupled to one or more sense voltage pads) of the electrochromic device. The driver includes a reversible constant current supply configured to supply a constant current to the electrochromic device (using the bus bars) until the sense voltage achieves a sense voltage limit, or until an amount of charge transferred to the electrochromic device achieves a target amount of charge. The driver includes a reversible variable voltage supply configured to supply a variable voltage to the electrochromic device to keep the sense voltage at (or below) the sense voltage limit, responsive to the sense voltage achieving the sense voltage limit, until the amount of charge transferred to the electrochromic device achieves the target amount of charge. In other cases, the variable voltage or variable current can be stopped in response to a time limit being reached, or the current flow dropping below a predetermined threshold. The sense voltage can provide a measurement of a local cell potential (or voltage drop) in the vicinity of the sense voltage pad, as described above.

In some embodiments, a method is provided for controlling the above electrochromic device (e.g., D01 in FIG. 1B, or E01 in FIG. 1C). The method includes applying a constant supply current (using the at least two bus bars) to the electrochromic device and determining an amount of charge transferred to the electrochromic device, as a function of time and current supplied to the electrochromic device. The method includes ceasing the applying the constant supply current, responsive to a sense voltage (measured using the sense voltage pad) reaching a sense voltage limit and applying one of a variable voltage or a variable current to the electrochromic device (using the at least two bus bars) to maintain the sense voltage at (or below) the sense voltage limit, responsive to the sense voltage reaching the sense voltage limit. The method can also include terminating the applying the variable voltage or the variable current to the electrochromic device, responsive to the determined amount of charge reaching a target amount of charge. In other cases, the variable voltage or variable current can be stopped in response to a time limit being reached, a current limit being reached, or the current flow dropping below a predetermined threshold. The sense voltage can provide a measurement of a local cell potential (or voltage drop) in the vicinity of the sense voltage pad, as described above.

At least one of the substrates 24, 25 is preferably transparent, in order to reveal the electrochromic properties of the stack 28 to the surroundings. Any material having suitable optical, electrical, thermal, and mechanical properties may be used as first substrate 24 or second substrate 25. Such substrates include, for example, glass, plastic, metal, and metal coated glass or plastic. Non-exclusive examples of possible plastic substrates are polycarbonates, polyacrylics, polyurethanes, urethane carbonate copolymers, polysulfones, polyimides, polyacrylates, polyethers, polyester, polyethylenes, polyalkenes, polyimides, polysulfides, polyvinylacetates and cellulose-based polymers. If a plastic substrate is used, it may be barrier protected and abrasion protected using a hard coat of, for example, a diamond-like protection coating, a silica/silicone anti-abrasion coating, or the like, such as is well known in the plastic glazing art. Suitable glasses include either clear or tinted soda lime glass, including soda lime float glass. The glass may be tempered or untempered. In some embodiments of electrochromic device 1 with glass, e.g. soda lime glass, used as first substrate 24 and/or second substrate 25, there is a sodium diffusion barrier layer (not shown) between first substrate 24 and first electrically conductive layer 22 and/or between second substrate 25 and second electrically conductive layer 23 to prevent the diffusion of sodium ions from the glass into first and/or second electrically conductive layer 23. In some embodiments, second substrate 25 is omitted.

In some embodiments, first substrate 24 and second substrate 25 are each float glass. In certain embodiments for architectural applications, this glass is at least 0.5 meters by 0.5 meters, and can be much larger, e.g., as large as about 3 meters by 4 meters. In such applications, this glass is typically at least about 2 mm thick and more commonly 4-6 mm thick.

Independent of application, the electrochromic devices of the present disclosure may have a wide range of sizes. In general, it is preferred that the electrochromic device comprise a substrate having a surface with a surface area of at least 0.01 meter². For example, in certain embodiments, the electrochromic device comprises a substrate having a surface with a surface area of at least 0.1 meter². By way of further example, in certain embodiments, the electrochromic device comprises a substrate having a surface with a surface area of at least 1 meter². By way of further example, in certain embodiments, the electrochromic device comprises a substrate having a surface with a surface area of at least 5 meter². By way of further example, in certain embodiments, the electrochromic device comprises a substrate having a surface with a surface area of at least 10 meter².

At least one of the two electrically conductive layers 22, 23 is also preferably a transparent conductive layer in order to reveal the electrochromic properties of the stack 28 to the surroundings. In one embodiment, electrically conductive layer 23 is transparent. In another embodiment, electrically conductive layer 22 is transparent. In another embodiment, electrically conductive layers 22, 23 are each transparent. In certain embodiments, one or both of the electrically conductive layers 22, 23 is inorganic and/or solid. Electrically conductive layers 22 and 23 may be made from a number of different transparent materials, including transparent conductive oxides, thin metallic coatings, networks of conductive nano particles (e.g., electrically conductive rods, tubes, or dots embedded in a matrix that is composed of an electrically conductive or insulating material), conductive metal nitrides, and composite conductors. Transparent conductive oxides include metal oxides and metal oxides doped with one or more metals. Examples of such metal oxides and doped metal oxides include indium oxide, indium tin oxide, doped indium oxide, tin oxide, doped tin oxide, zinc oxide, aluminum zinc oxide, doped zinc oxide, ruthenium oxide, doped ruthenium oxide and the like. Transparent conductive oxides (TCOs) are sometimes referred to as TCO layers. Thin metallic coatings that are substantially transparent may also be used. Examples of metals used for such thin metallic coatings include gold, platinum, silver, aluminum, nickel, and alloys of these. Examples of transparent conductive nitrides include titanium nitrides, tantalum nitrides, titanium oxynitrides, and tantalum oxynitrides. Electrically conducting layers 22 and 23 may also be transparent composite conductors. Such composite conductors may be fabricated by placing highly conductive ceramic and metal wires or conductive layer patterns on one of the faces of the substrate and then over-coating with transparent conductive materials such as doped tin oxides or indium tin oxide. Ideally, such wires should be thin enough as to be invisible to the naked eye (e.g., about 100 μm or thinner). Non-exclusive examples of electron conductors 22 and 23 transparent to visible light are thin films of indium tin oxide (ITO), tin oxide, zinc oxide, titanium oxide, n- or p-doped zinc oxide and zinc oxyfluoride. Metal-based layers, such as ZnS/Ag/ZnS and carbon nanotube layers have been recently explored as well. Depending on the particular application, one or both electrically conductive layers 22 and 23 may be made of or include a metal grid. In some cases, the transparent conductive layers 22 and/or 23 can include networks of conductive nano particles made from electrically conductive rods, tubes, or dots embedded in a matrix that is composed of an electrically conductive or insulating material (e.g., an insulating or electrically conductive polymer, or an insulating or electrically conductive solution coated inorganic material).

The thickness of the electrically conductive layer may be influenced by the composition of the material comprised within the layer and its transparent character. In some embodiments, electrically conductive layers 22 and 23 are composed of a material (e.g., TCO, or networks of conductive nano particles) that are substantially transparent and each have a thickness that is between about 1000 nm and about 50 nm. In some embodiments, the thickness of electrically conductive layers 22 and 23 is between about 500 nm and about 100 nm. In other embodiments, the electrically conductive layers 22 and 23 each have a thickness that is between about 400 nm and about 200 nm, or between about 300 nm and about 150 nm. In general, thicker or thinner layers may be employed so long as they provide the necessary electrical properties (e.g., conductivity) and optical properties (e.g., transmittance). For certain applications it will generally be preferred that electrically conductive layers 22 and 23 be as thin as possible to increase transparency and to reduce cost.

Referring again to FIG. 1A, the function of the electrically conductive layers is to apply the electric potential provided by a power supply over the entire surface of the electrochromic stack 28 to interior regions of the stack. The electric potential is transferred to the conductive layers though electrical connections to the conductive layers. In some embodiments, bus bars, one in contact with first electrically conductive layer 22 and one in contact with second electrically conductive layer 23 provide the electric connection between the voltage source and the electrically conductive layers 22 and 23.

The sheet resistance, Rₛ, of the first and second electrically conductive layers 22 and 23 (without gradients, e.g., of a constant thickness TCO before patterning) can vary from about 500Ω/□ to 1Ω/□, or from about 100Ω/□ to 5Ω/□, or from about 50Ω/□ to 5Ω/□, or from about 25 to 5Ω/□, or from about 20Ω/□ to 5Ω/□, or from about 10Ω/□ to 5Ω/□, or from about 30Ω/□ to 10 Ω/□, or from about 20Ω/□ to 10Ω/□.

The multi-layer devices of the present disclosure may have a rectangular shape, or a shape other than rectangular, may have two bus bars, or may have more than two bus bars, may have the bus bars on the opposite sides of the device, and/or may not have the bus bars on opposite sides of the device. For example, the multi-layer device may have a perimeter that is more generally a quadrilateral (e.g., a trapezoid, a right trapezoid, or a rhombus), or a shape with greater or fewer sides than four for example, the multi-layer device may be triangular, pentagonal, hexagonal, etc., in shape. By way of further example, the multi-layer device may have a perimeter that is curved but lacks vertices, e.g., circular, semicircular, ovular, etc. In such non-rectangular devices, two bus bars of the device can be parallel or non-parallel with each other. By way of further example, the multi-layer device may comprise three, four or more bus bars connecting the multi-layer device to one or more power supplies, or the bus bars, independent of number may be located on non-opposing sides. In each of such instances, the preferred resistance profile in the electrically conductive layer(s) may vary from that which is described for the rectangular, two bus bar configuration.

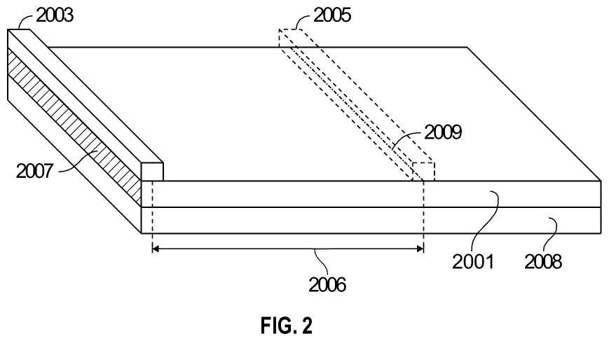

In some examples, a substrate of an electrochromic device contains an electrically conductive layer, and the substrate and electrically conductive layer are substantially rectangular, and there is one or more electrical connections (e.g., bus bars) applied on the electrically conductive layer. FIG. 2 shows such an electrochromic device with a substrate 2008, an electrically conductive layer 2001 on top of the substrate, and a bus bar applied to one edge 2003. The resistance between the bus bar, and a substantially parallel line in the first electrically conductive layer (shown as a dot-dash line in the FIG. 2009 may be defined. In this disclosure, the resistance between a bus bar and a substantially parallel line in an electrically conductive layer is equivalent to the resistance that would be measured if an ohmic test contact 2005 (with zero contact resistance) was connected, or temporarily applied, to the electrically conductive layer along the line and the resistance was measured between the bus bar and the test contact. If the electrically conductive layer is uniform, then the resistance between a bus bar and a substantially parallel line would increase linearly as the distance between the bus bar and the parallel line increased, and can be described by the equation r=ρ *l/A, where r is the resistance between the bus bar and a substantially parallel line on the electrically conductive layer, ρ is the bulk resistivity of the top electrically conductive layer, l is the distance between the bus bar and the line 2006, and A is the cross-sectional area of the electrically conductive layer 2007.

Alternatively, if the electrically conductive layer is non-uniform as a function of position perpendicular to the bus bar, then the resistance between the bus bar and a substantially parallel line will increase non-linearly as the distance between the bus bar and the line increases. In some cases, the bulk resistivity of the electrically conductive layer is non-uniform. In some cases, the cross-sectional area of the electrically conductive layer is non-uniform (e.g., the thickness varies across the substrate). In some cases, the electrically conductive layer may be patterned, so that the resistance from the bus bar to a substantially parallel line varies non-linearly, as is described more completely below.

There are different ways to create gradients in the transparent conductive layers. The gradients may be accomplished by any technique that creates a non-linearly varying resistance between the bus bar and a line on the layer, such as by changing the sheet resistance of the electrically conductive layer or by patterning the electrically conductive layer. The sheet resistance of the electrically conductive layer may be changed by changing the layer thickness or the electrical properties of the materials of the electrically conductive layer. For example, the electrical properties of the electrically conductive layer materials can change by changing the resistivity of thin film materials (e.g., by changing the composition, dopant/impurity concentrations, or crystallinity of the materials), changing the morphology of a nanostructured conductive layer (e.g., the spacing between conductive nanowires), or changing the electrical properties of a nanostructured conductive layer (e.g., the inter-wire resistance of a nanowire mesh). The gradients in thickness or electrical properties of the electrically conductive layer(s) can be smoothly varying, or discretely varying. In some cases, discrete patterns are formed on one or both electrically conductive layers, which cause the resistance between the bus bar and a line within one or both electrically conductive layers to vary non-linearly. In some embodiments, the sheet resistance of one or more electrically conductive layer(s) is changed and discrete patterns are formed on one or both electrically conductive layers, which cause the resistance between the bus bar and a line within one or both electrically conductive layers to vary non-linearly.

Electrochromic devices with resistance gradients in electrically conductive layers are further described in U.S. Pat. Nos. 8,717,658, 9,091,868, 9,091,895, 9,507,233, 10,386,688 and 11,187,955, the entire contents of which are hereby incorporated by reference.

As will be described in more depth below, a non-linear change in the resistance between the bus bar and a line on one or both electrically conductive layers is advantageous in electrochromic devices, because it enables the local potential between the two electrically conductive layers of the device to be more uniform over the area of a device, and therefore the electrochromic device is enabled to have more spatially uniform optical properties (e.g., transmission) during switching. An electrochromic device with varying sheet resistance of one or more electrically conductive layer(s), may have improved uniformity during switching. An electrochromic device with discrete patterns formed on one or both electrically conductive layers, may have improved uniformity during switching. An electrochromic device with varying sheet resistance of one or more electrically conductive layer(s), and discrete patterns on one or both electrically conductive layers, may also have improved uniformity during switching.

Isoresistance lines and resistance gradient lines can be plotted to describe a non-uniform sheet resistance of an electrically conductive layer. Isoresistance lines join points of equal sheet resistance, and resistance gradient lines are perpendicular to isoresistance lines. Referring to FIG. 1A, in general, and independent of whether the multi-layer device has a shape other than rectangular, there are more than two electrical connections (e.g., bus bars), and/or the electrical connections (e.g., bus bars) are on opposite sides of the device, the sheet resistance, Rₛ, in the first electrically conductive layer 22, in the second electrically conductive layer 23, or in the first electrically conductive layer 22 and the second electrically conductive layer 23 may be plotted to join points of equal sheet resistance (i.e., isoresistance lines) as a function of (two-dimensional) position within the first and/or second electrically conductive layer. Plots of this general nature, sometimes referred to as contour maps, are routinely used in cartography to join points of equal elevation. In the context of the present disclosure, a contour map of the sheet resistance, Rₛ, in the first and/or second electrically conductive layer as a function of (two-dimensional) position within the first and/or second electrically conductive layer preferably contains a series of isoresistance lines (also sometimes referred to as contour lines) and resistance gradient lines (lines perpendicular to the isoresistance lines). The sheet resistance along a gradient line in the first and/or second electrically conductive layer(s) may be constant, or generally increase(s), or generally decrease(s), or generally increase(s) until it reaches a maximum and then generally decrease(s), or generally decrease(s) until it reaches a minimum and then generally increase(s).

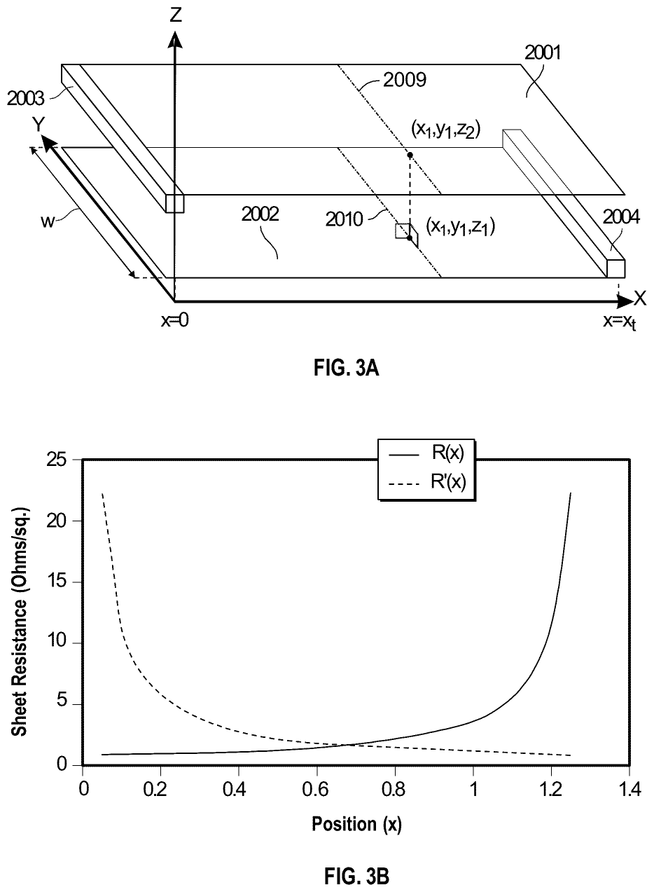

FIGS. 3A and 3B show an example of an electrochromic device and a corresponding example of electrical resistance gradients in the electrically conductive layers on the device. FIG. 3A is schematic of a top electrically conductive layer 2001, a bottom electrically conductive layer 2002, a contact (bus bar 2003) to the top electrically conductive layer is made at x=0, and a contact (bus bar 2004) to the bottom electrically conductive layer is made at x=xₜ, FIG. 3B includes a plot of R(x), the sheet resistance of the top electrically conductive layer 2001 in FIG. 3A as a function of position (x), and R′(x), and the sheet resistance of the bottom electrically conductive layer 2002 in FIG. 3A as a function of position (x), in an embodiment.

Without wishing to be bound by any particular theory, and based upon certain experimental evidence obtained to-date, the local potential (i.e., voltage) between the electrically conductive layers in an electrochromic stack can be made substantially constant as a function of position by varying the sheet resistance in the two electrically conductive layers of the device. The local potential between the electrically conductive layers can also be referred to as the local device potential, or local cell potential. There are particular relationships between the sheet resistance of the first and second electrically conductive layers which will provide a substantially uniform local cell potential across the area of an electrochromic device. For the geometry shown in FIG. 3A, with a rectangular top electrically conductive layer 2001, and a rectangular bottom electrically conductive layer 2002, a contact (bus bar 2003) to the top electrically conductive layer is made at x=0, and a contact (bus bar 2004) to the bottom electrically conductive layer is made at x=xₜ, the relationship to provide a substantially uniform local cell potential is

$${R}^{′} ( x ) = R ( x ) * ( {x}_{t} / x - 1 ) ,$$

where R(x) is the sheet resistance of the top electrically conductive layer as a function of position and R′(x) is the sheet resistance of the bottom electrically conductive layer as a function of position, and where the sheet resistance of the top and bottom electrically conductive layers are substantially constant in the y-direction for a given value of x. In this embodiment, the resistance gradient lines are oriented substantially along the x direction and the isoresistance lines are oriented substantially along the y-direction, for both the top and bottom electrically conductive layers. In this embodiment, with the geometry shown in FIG. 3A, the top and bottom electrically conductive layers are substantially parallel, and a point on the bottom electrically conductive layer (x₁, y₁, z₁) can be projected onto a point on the top electrically conductive layer (x₁, y₁, z₁), as shown in the figure. An example of a solution of sheet resistance profiles that satisfy this relationship is a linear change in the sheet resistance of the top electrode, R(x)=a*x, and the sheet resistance of the bottom electrode R′(x)=a*(xₜ−x), where the sheet resistance of the top and bottom electrically conductive layers are substantially constant in the y-direction for a given value of x. Another example solution is R(x)=1/[a*(xₜ−x)] and R′(x)=1/(a*x), where the sheet resistance of the top and bottom electrically conductive layers are substantially constant in the y-direction for a given value of x.

r(x) is defined as the resistance between the bus bar 2003 and a line 2009 parallel to the bus bar in the top electrically conductive layer, where the line 2009 is at a position x (shown in the figure at position x₁). r′(x) is defined as the resistance between the bus bar 2004 and a line 2010 parallel to the bus bar in the bottom electrically conductive layer, where the line 2010 is at a position x (shown in the figure at position x₁). The equation that describes r(x) is the integral of the sheet resistance R(x) of the top electrically conductive layer divided by the top electrically conductive layer width W,

$$r ( x ) = \int [ R ( x ) / W ] dx ,$$

evaluated in the interval from x=0 to x=x. The equation that describes r′(x) is the integral of the sheet resistance R′(x) of the bottom electrically conductive layer divided by the bottom electrically conductive layer width W,

$$r ’ ( x ) = \int [ R ’ ( x ) / W ] dx ,$$

evaluated in the interval from x=x to x=xₜ.

As a practical matter, devices do not need to precisely adhere to these relationships to realize the benefits described in this disclosure. For example, in the case above where R′(x)=1/(a*x), R′(0)=infinity. While one can practically create resistances of very large magnitude, a film with a R′(x)=1/(a*x+b) where b is small relative to a can exhibit significantly improved switching uniformity over a device with electrodes of uniform sheet resistance.

In rectangular electrochromic devices, patterns in the electrically conductive layers can be utilized to vary the resistance between the bus bar and a line parallel to the bus bar in the electrically conductive layers. In this case, the above relationships can be used to determine the specifications for the pattern that will improve the uniformity of the local cell potential across the area of the device. The integrals described above (that determine the resistance between the bus bar and a line parallel to the bus bar in an electrically conductive layer for a given desired sheet resistance profile) can be evaluated in different intervals, and the resulting values can be used to determine the patterns required to vary the resistance along gradient lines. The improved uniformity of the local cell potential will enable the electrochromic device to switch more uniformly.

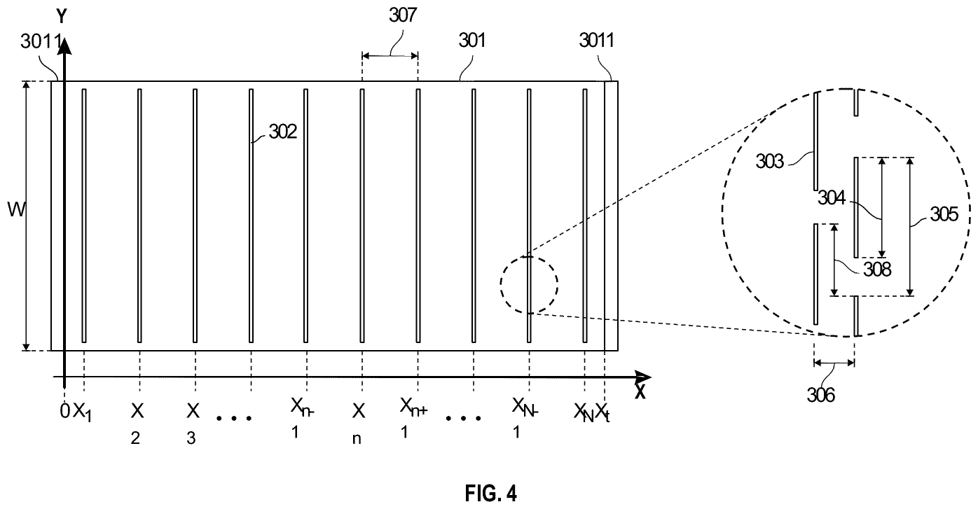

For example, FIG. 4 shows a patterned electrically conductive layer 301 with a transparent conducting material with a number of sets of scribed lines 302, which are patterned into the transparent conducting material. The dimensions of the geometrical parameters of the patterns are chosen to create the required resistance profiles according to the above relationships in order to improve the uniformity of the potential between the electrically conductive layers of the electrochromic stack (i.e., the local cell potential).

The dark areas in the magnified region in FIG. 4 are a pattern of lines that represent gaps in the electrically conductive layer. For instance, the electrically conductive layer can be a transparent conductive material (e.g., a transparent conductive oxide such as indium tin oxide, fluorine-doped tin oxide, or aluminum-doped zinc oxide), and the dark lines of the pattern represent areas where the transparent conductive material has been removed. In some cases, the pattern of gaps in the electrically conductive material are formed by laser ablation. In some cases, the pattern of gaps in the electrically conductive material are formed by chemical etching using a mask (e.g., where the mask is patterned by photolithography). In some cases, the gaps extend through the entire thickness of the electrically conductive material. In some cases, the gaps are formed by a patterned mask used during selective deposition of the electrically conductive layer, such as a shadow mask during physical vapor deposition.

In cases where the electrically conductive layer is composed of a transparent conducting material, the sheet resistance of the transparent conducting material is defined as R_{TC}(x). R_{TC}(x) can be constant in some cases (e.g. if the transparent conducting material is a transparent conducting oxide with uniform thickness). While in some cases, R_{TC}(x) varies with position (e.g. if the transparent conducting material is a transparent conducting oxide with varying thickness).

In the example shown in FIG. 4, each set of scribed lines 302 contains a number of scribed lines. Each scribed line is made up of a series of collinear segments 303, which are gaps in the electrically conductive layer. The length of the collinear segments 304, the period 305, the valve width 306 and the offset 308 between segments in adjacent scribed lines determines the resistance to the flow of electrons traversing a set of scribed lines in the x direction. FIG. 4 shows that there are N sets of scribed lines 302 in the electrically conductive layer. The bus bar 3011 in this example is either at x=0 (i.e., on one electrically conductive layer, such as 27 in FIG. 1A, and 2003 in FIG. 3A), or at x=xₜ (i.e., on the opposing electrically conductive layer (i.e., 26 in FIG. 1A, and 2004 in FIG. 3A). In general, the x-positions of the sets of scribed lines are described as [x₁, x₂, x₃ . . . xₙ₋₁, xₙ, xₙ₊₁, . . . , x_{N-1}, x_{N}].

In the rectangular electrochromic device shown in FIG. 4 the set of scribed lines xₙ can correspond to the scribed lines in the top or bottom electrically conductive layer. The resistance across a set of scribed lines (e.g., in the direction perpendicular to the width) can be defined similarly to the resistance between a bus bar and a line in the electrically conductive layer. In this case, two lines can be defined, one on either side of the set of scribed lines, where the lines and the set of scribed lines are parallel to each other, and an edge of the substrate, and have a length equal to W. The resistance between the two lines will, in general, be equal to the sum of the resistance caused by the sheet resistance of the transparent electrically conducting layer material, and the resistance added by the set of scribed lines. In is defined as the resistance added by the set of scribed lines. In other words, if two test contacts were connected to the electrically conductive layer along two lines on either side of the set of scribed lines, then they would measure a resistance equal to the sum of the resistance of the electrically conductive layer (roughly equal to ρ*l/A, where ρ is the bulk resistivity of the electrically conductive layer, l is distance between the test contacts, and A is W*t, there t is the thickness of the electrically conductive layer) and rₙ (the resistance from the pattern of scribed lines).

In the rectangular electrochromic device shown in FIG. 4, for a given desired sheet resistance in the top electrically conductive layer, R(x), and the top electrically conductive layer bus bar located at x=0, the parameters of the segments (303, 304, 305, 306 and 308) are chosen such that the resistance rₙ to the flow of electrons traversing the set of scribed lines xₙ in the x direction in the top electrically conductive layer is the value of the integral

$${r}_{n} = \int \{ [ R ( x ) - {R}_{TC} ( x ) ] / W \} dx ,$$

evaluated in the interval from [xₙ₋₁, xₙ]. It is also possible to evaluate the integral in the interval [xₙ, xₙ₊₁] to evaluate rₙ. Similarly, for a given desired sheet resistance in the bottom electrically conductive layer, R′(x), and the bottom electrically conductive layer bus bar located at x=xₜ, the parameters of the segments (303, 304, 305, 306 and 308) are chosen such that the resistance r′ₙ to the flow of electrons traversing the set of scribed lines xₙ in the x direction in the bottom electrically conductive layer is the value of the integral

$${r ’}_{n} = \int \{ [ R ’ ( x ) - {R}_{TC} ( x ) ] / W \} dx ,$$

evaluated in the interval from [xₙ₊₁, xₙ]. It is also possible to evaluate the integral in the interval [xₙ, xₙ₋₁] to evaluate r′ₙ.

Note that in some cases, the sets of scribed lines on the top electrically conductive layer do not need to coincide with the positions of the sets of scribed lines on the bottom electrically conductive layer. In such cases, there would be a set of positions of sets of scribed lines in the top electrically conductive layer xₙ, and a set of positions of sets of scribed lines in the bottom electrically conductive layer x′ₙ, and the relationships above would otherwise remain unchanged. In any case, the relative distances of the sets of scribed lines from the bus bar on each layer can either be the same or different.

In order to approximate sheet resistances adhering to the above relationships between R(x) and R′(x), different sets of scribed lines will have different resistances to the flow of electrons in the x direction, and therefore the parameters of the segments (e.g., 303, 304, 305, 306 and/or 308) will vary between sets of scribed lines. FIG. 5 shows an example where the sets of scribed lines all contain 2 scribed lines. In this example, the period 305, the valve width 306 and the offset 308 between segments in adjacent scribed lines are all constant for every set of scribed lines xₙ. However, the length of the scribed segments 304a, 304b and 304c are different for different sets of scribed lines. Therefore, the resistance to the flow of electrons traversing the set of scribed lines xₙ in the x direction will be different for different sets of scribed lines.

In general, the total resistance between the bus bar and a line in the electrically conductive layer is the sum of the resistance of the patterned features (e.g., sets of scribed lines in the example above), and the resistance of the transparent conductive material itself.

The resistance contribution of the patterned features (i.e., In) varies along the length of the substrate non-linearly with the non-uniform electrical properties. The resistance contribution from the patterned features per unit width of the device can be from about 0 to about 30 Ohm-cm, or from about 0 to about 300 Ohm-cm, or from about 0 to about 500 Ohm-cm, or from about 0 to about 750 Ohm-cm, or from about 0 to about 1000 Ohm-cm, or from about 0 to about 3000 Ohm-cm, or from about 0 to about 10000 Ohm-cm. In other words, for a substrate width of 100 cm, then the resistance contribution from the patterned features (rₙ) would be from about 0 to about 0.3 Ohm, or from about 0 to about 3 Ohm, or from about 0 to about 5 Ohm, or from about 0 to about 7.5 Ohm, or from about 0 to about 10 Ohm, or from about 0 to about 30 Ohm, or from about 0 to about 100 Ohm.

The resistance contribution from the transparent conductive material per unit width of the device can be from about 0 to about 100 Ohm-cm, or from about 0 to about 300 Ohm-cm, or from about 0 to about 600 Ohm-cm, or from about 0 to about 1200 Ohm-cm, or from about 0 to about 1500 Ohm-cm, or from about 0 to about 1800 Ohm-cm, or from about 0 to about 2400 Ohm-cm, or from about 0 to about 3600 Ohm-cm, or from about 0 to about 4800 Ohm-cm, or from about 0 to about 12000 Ohm-cm. The resistance contribution per unit width from the transparent conductive material is driven by the distance to the bus bar, the thickness of the material and the sheet resistance of the material.

The dimensions of the patterned features drive the resistance contribution of the patterned lines. The length of the scribe lines (e.g., 304 in FIG. 4) can be from about 0.1 mm to about 100 mm, or from about 0.1 mm to about 20 mm, or from about 0.1 mm to about 10 mm, or from about 1 mm to about 10 mm, or from about 1 mm to about 20 mm, or from about 1 mm to about 100 mm, or from about 5 mm to about 10 mm, or from about 5 mm to about 15 mm, or from about 5 mm to about 20 mm, or from about 5 mm to about 25 mm, or from about 5 mm to about 30 mm. The period (e.g. 305 in FIG. 4) can be from about 2 mm to about 10 mm, or from about 2 mm to about 20 mm, or from about 2 mm to about 100 mm, or from about 5 mm to about 10 mm, or from about 5 mm to about 15 mm, or from about 5 mm to about 20 mm, or from about 5 mm to about 25 mm, or from about 5 mm to about 30 mm. The gap between scribed segments within a scribed line (e.g. the difference between 305 and 304 in FIG. 4) can be about 0.5 mm, or from about 0.1 to about 100 mm, or from about 0.5 to about 200 mm, or from about 0.1 to about 50 mm, or from about 0.1 to about 20 mm, or from about 0.1 to about 10 mm, or from about 0.1 to about 5 mm, or from about 0.1 to about 1 mm, or from about 0.1 to about 0.5 mm, or from about 0.2 to about 0.8 mm, or from about 0.4 to about 0.6 mm. The valve width (e.g. 306 in FIG. 4) can be from about 10 to about 1000 microns, or from about 10 to about 500 microns, or from about 10 to about 200 microns, or from about 50 to about 500 microns, or from about 50 to about 400 microns, or from about 50 to about 300 microns.

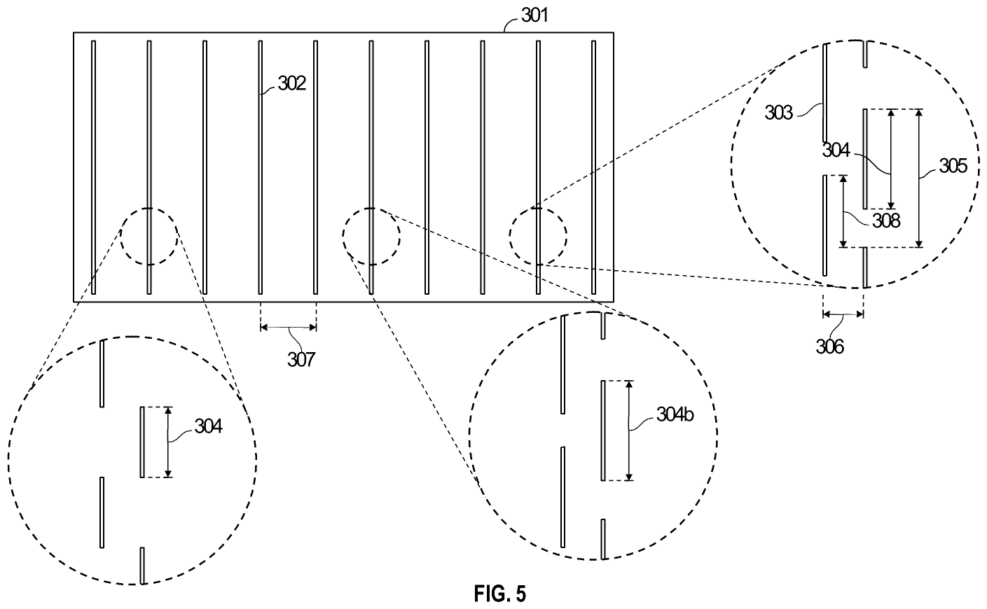

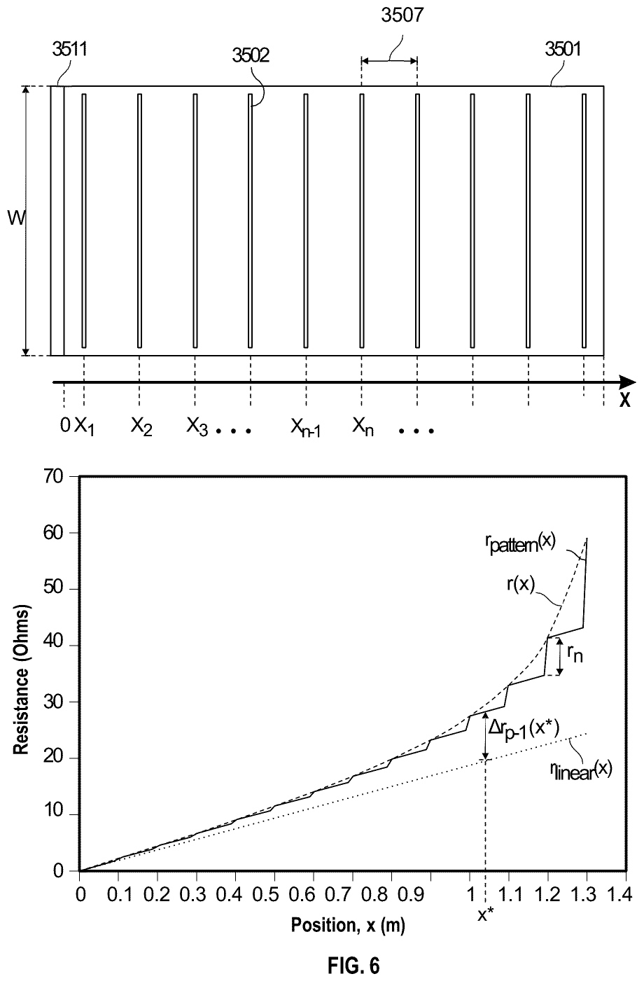

Given a substantially rectangular electrically conductive layer with a transparent conducting material of constant thickness and constant resistivity (and no patterning), the resistance between the bus bar and a line parallel to the bus bar is rₗᵢₙₑₐᵣ(x) (where the bus bar is at x=0, and the parallel line is at a position x). rₗᵢₙₑₐᵣ(x) increases linearly as x increases. Given a patterned electrically conductive layer of the geometry shown in FIG. 4, composed of a transparent conducting material of constant thickness and constant resistivity, and a pattern of sets of scribed lines, the resistance between the bus bar and a line parallel to the bus bar is rₚₐₜₜₑᵣₙ(x) (where the bus bar is at x=0, and the parallel line is at a position x). rₚₐₜₜₑᵣₙ(x) will equal rₗᵢₙₑₐᵣ(x) with approximately step-wise increases in resistance (equal to rₙ as described above) at approximately the x-positions of the sets of scribed lines (xₙ as described above). FIG. 6 illustrates examples of rₗᵢₙₑₐᵣ(x) and rₚₐₜₜₑᵣₙ(x) vs. position x for the simple rectangular geometry described. An example of r(x), the resistance between the bus bar and a line parallel to the bus bar in the electrically conductive layer, calculated from a smoothly varying sheet resistance (e.g., R(x)) is also shown in FIG. 6 for reference. In some cases rₚₐₜₜₑᵣₙ(x) will be similar to r(x) near the position of a set of scribed lines, or in between sets of scribed lines, depending on the intervals chosen for evaluating rₙ. In some cases rₚₐₜₜₑᵣₙ(x) at a given x position will always be higher or always be lower than r(x), depending on the intervals chosen for evaluating rₙ.

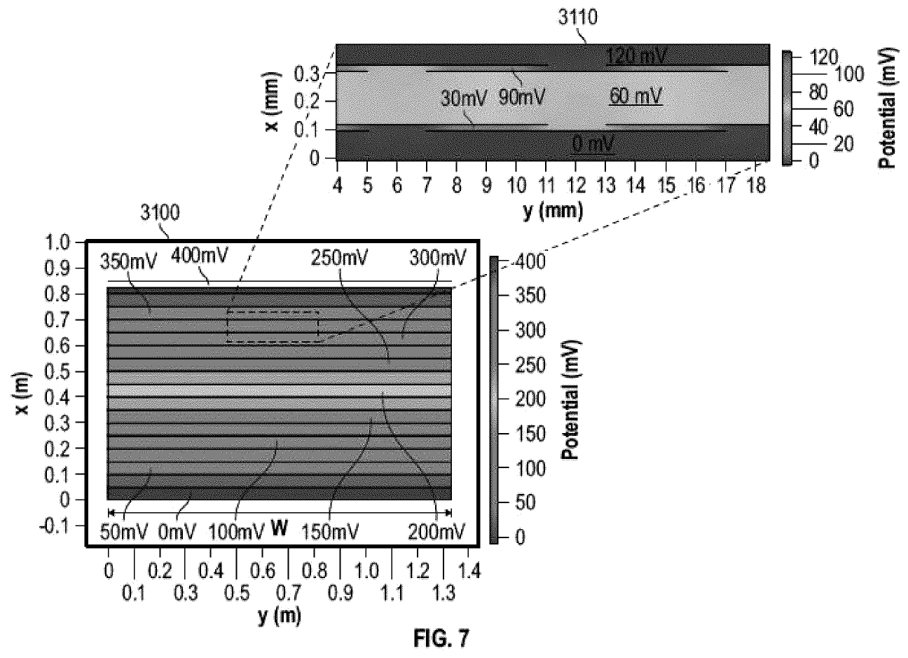

The resistance between the bus bar and (x,y) positions very close to sets of scribed lines, and in between individual scribed lines in a given set, is not only a function of x, but also can have a y-dependence. FIG. 7 shows simulated electrical potential maps of an example patterned electrically conductive layer. The substrate in this example is approximately 800 cm long (in the x-direction), and 1300 cm wide (W=1300 cm, in the y-direction). There are approximately 16 sets of scribed lines in this example, and for simplicity, the dimensions of the patterned features are the same for all sets of scribed lines. The plot encompassing the whole device substrate 3100 illustrates that in some cases the potential is approximately constant in the y-direction for a given value of x. The potential for plot 3100 is shown in the color scale, and is the potential difference between the bus bar (in this example located at x approximately equal to 0 m) and an (x,y) location on the substrate, for an applied current per unit width equal to about 1 A-m (applied between a bus bar at x=0 and a second bus bar at x approximately equal to 800 cm), and varies between about 0 mV and approximately 400 m V.

The zoomed in plot 3110 illustrates that in some cases there are electrical potential gradients in the y-direction for locations close to the sets of scribed lines. The potential for plot 3110 is shown in the color scale, and is the potential difference between the bus bar (in this example located at x approximately equal to 0 m) and an (x,y) location on the substrate, for a given applied current per unit width equal to about 1 A-m (applied between a bus bar at x=0 and a second bus bar at x approximately equal to 0.38 cm), and varies between 0 mV and approximately 120 mV. Note that the distance between the sets of scribed lines in plot 3110 is smaller than that in plot 3100 in order to minimize computation time, however, the general features and conclusions remain valid. The zoomed in plot 3110 shows that the largest gradients in the y-direction occur in between each of the scribed lines within a set of scribed lines. In some cases the fraction of the device area where there are significant gradients in the y-direction is small, and therefore it is justified to neglect these gradients in the y-direction, and simplify the analysis to consider only gradients in the x-direction (as illustrated in the plot of the whole device substrate 3100). However, one skilled in the art will appreciate that all of the concepts described herein also apply to devices with significant potential gradients in both the x- and y-directions (e.g., in devices with sets of scribed lines that are non-linear, substrates that are non-rectangular, sets of scribed lines that are spaced very closely together, electrically conductive layers with spatially diminutive thickness non-uniformities, electrically conductive layers with spatially diminutive non-uniformities in electrical properties, etc.).

In some embodiments, care may be taken to design the sets of scribed lines to minimize the potential gradients in the y-direction. For patterns with sets of scribed lines such as those shown in FIG. 4, one or more of the ratios between segment length, period, valve width and pitch can be tuned to minimize the potential gradients in the y-direction.

In some embodiments, potential gradients in the y-direction can be controlled by varying the scribe patterns to establish visually perceptible patterns in the device (i.e., differences in the transmission at different locations in the device) during switching from a more transmissive state to a less transmissive state, or from a less transmissive state to a more transmissive state.

When the resistance gradients in the electrically conductive layers of the device are caused by scribe patterns, the resistance gradients can approximate a smoothly varying resistance profile, and the local cell potential can vary somewhat across the device. The geometry of the cell potential across the device can be tailored by changing the specific dimensions of the scribe patterns across the device. Since the local cell potential is the potential difference between the top and bottom electrically conductive layers, the alignment of the scribe patterns between the top and bottom electrically conductive layers will also affect the cell potential across the device. Furthermore, since the magnitude of the cell potential impacts the switching speed of the device, the alignment of the scribe patterns between the top and bottom electrically conductive layers can be tuned to create visually perceptible patterns as the device switches.

Referring back to FIG. 4, in some embodiments, the length of the collinear segments 304, the period 305, the valve width 306 and the offset 308 between segments in adjacent scribed lines that determine the resistance to the flow of electrons traversing a set of scribed lines in the x direction, can vary along the length of a set of scribed lines in the y-direction. By varying the resistance (to the flow of electrons in the x-direction) of the sets of scribed lines along the y-direction, the cell potential can be made non-uniform in the y-direction. The magnitude of the cell potential impacts the switching speed of the device, and therefore varying the scribe dimensions along the length of a set of scribed lines along the y-direction can create visually perceptible patterns in the device as it switches. Similarly, varying the resistance (to the flow of electrons in the x-direction) of the sets of scribed lines along the x-direction, the cell potential can be made non-uniform in the x-direction, and create visually perceptible patterns in the device as it switches. And similarly, varying the resistance (to the flow of electrons in the x-direction) of the sets of scribed lines along the x-direction and the y-direction, the cell potential can be made non-uniform in both the x-direction and y-direction, and create visually perceptible patterns in the device as it switches.

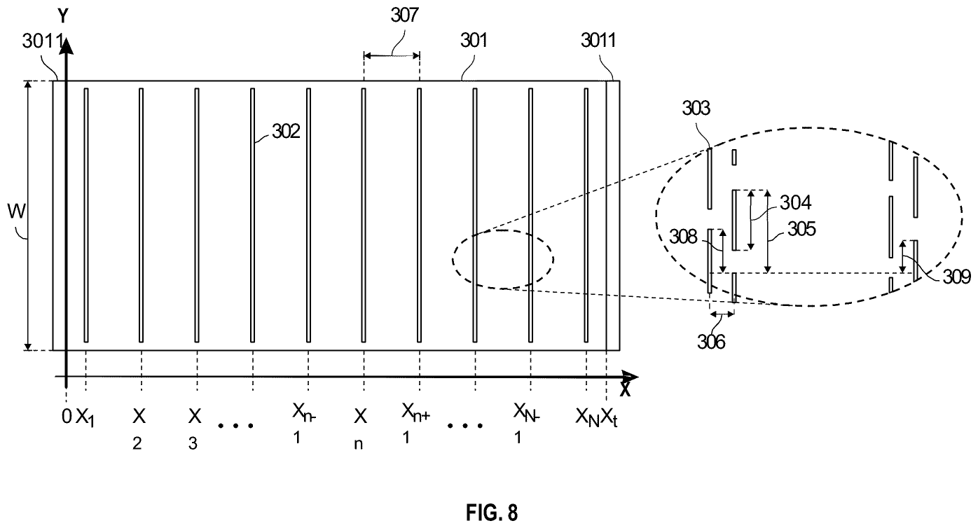

FIG. 8 illustrates another aspect of the scribe patterns that will create potential gradients in the x-direction and/or y-direction that cause visually perceptible patterns (i.e., differences in the transmission at different locations) in the device during switching from a more transmissive state to a less transmissive state, or from a less transmissive state to a more transmissive state. The period offset 309 will affect the uniformity of the transmission across different locations in the device. In some embodiments, as the period offset approaches zero, there will be smaller potential gradients in the x-direction and/or y-direction in the device, and as the period offset approaches half of the period 305, then there will be larger potential gradients in the x-direction and/or y-direction in the device. Consequently, in some embodiments, as the period offset approaches zero, there will be more uniform transmission across the device during switching, and as the period offset approaches half of the period 305, then there will be less uniform transmission across the device during switching.

The scribe patterns on the top and bottom electrically conductive layers can interact to create visually perceptible patterns in the device as it switches, and those patterns can vary across the area of the device. The patterns are the result of differences in transmission from one point to another. These transmission differences can be larger in one area of the device, and smaller in another area of the device. For example, the region of the device farther from the bus bars can have larger transmission differences and a more pronounced pattern than the regions nearer the bus bars.

Referring back to FIG. 4, in some embodiments, the visually perceptible patterns in the device as it switches are more pronounced in regions where the scribed segments do not overlap within the sets of scribed lines. The segments can be described as overlapping within the sets of scribed lines if their length 304 is greater than about half of the length of the period 305.

In some embodiments, the magnitude of the cell potential impacting the switching speed of the device can be varied by varying the scribe dimensions (i.e., the length of the collinear segments 304, the period 305, the valve width 306, the offset 308 between segments in adjacent scribed lines, or the period offset 309) along the length of the sets of scribed lines in the y-direction and/or x-direction in the top electrically conductive layer, or the bottom electrically conductive layer, or both the top and bottom electrically conductive layer.

Many different patterns can be created while the device is switching by changing the resistance of the sets of scribed lines in the x-direction and/or y-direction, and/or by changing the alignment of the sets of scribed lines in the top and bottom electrically conductive layers. Some examples of patterns that can be created while the device is switching are checkerboard patterns (i.e., squares or rectangles of higher/lower transmission), honeycomb patterns (i.e., hexagons, or other polygons, of higher/lower transmission), vertical stripes, horizontal stripes, concentric rings, and other non-repeating patterns (e.g., company logos, words, or other shapes distributed across the area of the device). In some embodiments, the patterns are visible while the device is switching, but are not visible, or nearly invisible when the device is not switching.

The patterns are implemented to change the resistance profiles within the electrically conductive layers. Δrₚ₋₁(x) is the difference between the patterned electrically conductive layer resistance profile rₚₐₜₜₑᵣₙ(x) and the linear uniform transparent conducting material resistance profile rₗᵢₙₑₐᵣ(x). Another way to compare the resistance of a uniform and a patterned electrically conductive layer is by a ratio. The ratio of φ(x)=rₚₐₜₜₑᵣₙ(x)/rₗᵢₙₑₐᵣ(x) will in general be a number equal to or greater than 1 for all values of x. In some cases the difference in resistance Δrₚ₋₁ (x) will increase as the distance from the bus bar increases, and the ratio of the resistances φ(x)=rₚₐₜₜₑᵣₙ(x)/rₗᵢₙₑₐᵣ(x) will increase as the distance from the bus bar increases.

FIG. 6 shows an example of rₗᵢₙₑₐᵣ(x) for an electrically conductive layer with a uniform transparent conducting material, and rₚₐₜₜₑᵣₙ(x) for a patterned electrically conductive layer with a uniform transparent conducting material and a pattern. FIG. 6 also shows the resistance r(x), resulting from a smoothly varying sheet resistance (as described above). The inset to FIG. 6 shows the patterned electrically conductive layer 3501 geometry for this example. The bus bar 3511 on the electrically conductive layer is at x=0, and the substrate is 1.3 m long and 0.8 m wide. The distance between the patterned features 3507 (e.g., the pitch between sets of scribed lines) is 0.1 m. The pattern in this example is chosen to approximate a hyperbolic increase in sheet resistance as the distance from the bus bar increases (e.g., wherein the scribe segment lengths in the sets of scribed lines close to x=0 are different than the scribe segment lengths in the sets of scribed lines close to x=xₜ). Due to the discrete nature of the pattern, rₚₐₜₜₑᵣₙ(x) has approximately step-wise increases in resistance due to the resistance from each pattern feature rₙ. The difference between the patterned electrically conductive layer resistance rₚₐₜₜₑᵣₙ(x) and the linear uniform transparent conducting material resistance rₗᵢₙₑₐᵣ(x) at a particular value of x=x*, is shown in FIG. 6 as Δrₚ₋₁(x*). Due to the approximately hyperbolic rₙ resistances in this example, Δrₚ₋₁ (x) increases with increasing distance from the bus bar. Due to the nature of the rₙ resistances in this example, the ratio φ(x)=rₚₐₜₜₑᵣₙ(x)/rₗᵢₙₑₐᵣ(x) will also increase with increasing distance from the bus bar.

As shown in FIG. 6, rₚₐₜₜₑᵣₙ(x) is an approximation of r(x), as shown in FIG. 6. In some embodiments, a shorter pitch will decrease the difference between rₚₐₜₜₑᵣₙ(x) and r(x). However, as previously noted, the resistance profile need not perfectly adhere to the R′(x)=R(x)*(xₜ/x−1) relationship to enable improved switching uniformity compared to devices with electrically conductive layers with constant sheet resistances. A discrete pattern (e.g., sets of scribed lines) is readily manufacturable, for instance using a scanning laser to ablate the electrically conductive material. The high speed and low cost of such a process are also benefits for high volume manufacturing. The patterns created by scanning laser ablation processes are also easy to modify for different sized devices, and the added flexibility is a benefit for the manufacturing of electrochromic windows and mirrors, which typically are manufactured in many different sizes. In some cases, the pitch can be chosen to be large to reduce the number of scribed lines, and increase manufacturability. In some cases, the pitch is adjusted to provide an acceptable difference between rₚₐₜₜₑᵣₙ(x) and r(x) with minimal number of scribes required during manufacturing. For example, the pitch can be from 1 mm to 10 mm, or 2.5 mm, or 5 mm.

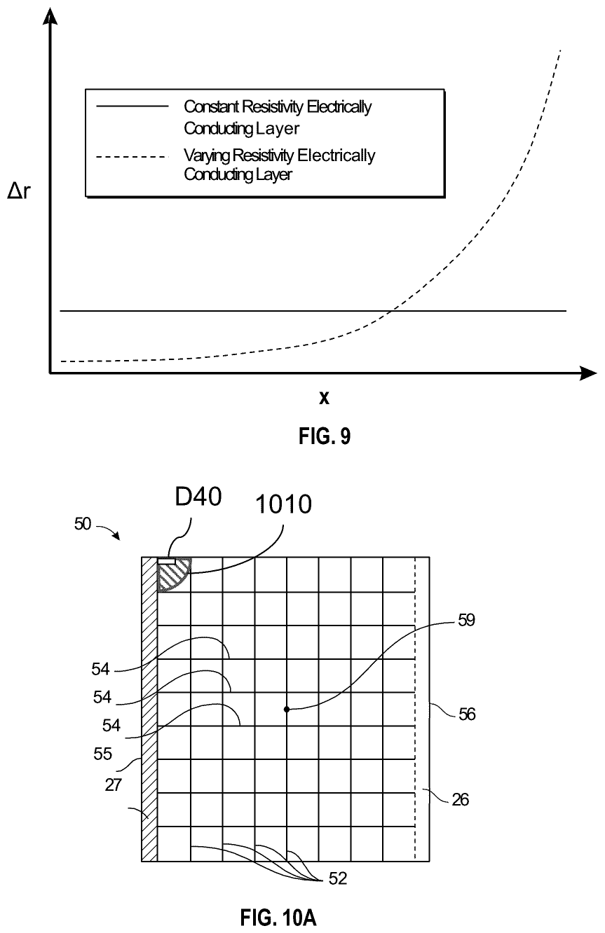

In the case of an electrically conductive layer with constant resistivity (e.g. with a uniform transparent conducting material and no patterns), the resistance between the bus bar and a line parallel to the bus bar will be linear with the distance between the bus bar and the line (as described above). In this case, a fixed length interval between the bus bar and the parallel line can be defined (Δx). In this instance, the change in resistance, Δr(x), over any interval Δx will be constant. In the case of an electrically conductive layer with varying resistance (e.g. with patterned transparent conducting material) the change in resistance Δr(x) over a fixed length interval Δx will be not be constant. FIG. 9 illustrates that the change in resistance Δr over a fixed interval Δx will be constant at all values of x for a uniform electrically conducting layer, and Δr over a fixed interval Δx varies with position (x) for a manufactured varying electrically conducting layer.

FIGS. 4 and 5 depict that each set of scribed lines 302 contains 2 scribed lines. Each set of scribed lines can have 2 or 3 or 4 or 5 or more scribed lines. The number of scribed lines in each set can also vary. In some cases, the spacing between the sets of scribed lines (i.e., the pitch) 307 can be constant, or varying.

### Non-Uniform Thickness

The electrically conductive layer thickness and/or bulk resistivity can also be constant or varying. In this case, the relationship between the bulk resistivity and thickness of the top electrically conductive layer, and the bottom electrically conductive layer, is

$$( L - x ) * ρ ( x ) / {t}_{f} ( x ) = x * ρ ’ ( x ) / {t}_{f} ’ ( x ) ,$$

where x=0 is the position of the bus bar on the top electrically conducting layer, x=L is position of the bus bar on the bottom electrically conducting layer, ρ(x) is the bulk resistivity of the top electrically conductive layer, ρ′(x) is the bulk resistivity of the bottom electrically conductive layer, t_{f}(x) is the thickness of the transparent conducting material of the top electrically conductive layer and t_{f}′(x) is the transparent conducting material of the bottom electrically conductive layer. In this case ρ(x), ρ′(x), t_{f}(x), and t_{f}′(x) can all vary with position.

In this case the resistance between the bus bar 2003 and a line 2009 at position x for the top electrically conductive layer 2001 in FIG. 3A is the integral

$$r ( x ) = \int [ ( ρ ( x ) / {t}_{f} ( x ) ) / W ] dx ,$$

evaluated in the interval from x=0 to x=x. The resistance between the bus bar 2004 and a line 2010 at position x for the bottom electrically conductive layer 2002 in FIG. 3A is the integral

$$r ’ ( x ) = \int [ ( ρ ’ ( x ) / {t}_{f} ‘ ( x ) ) / W ] dx ,$$

evaluated in the interval from x=xₜ to x=x.

### Non-Rectangular Substrates

The above relationships to calculate resistances for rectangular geometries can be extended to calculate resistances for non-rectangular geometries. The sheet resistance of the top and bottom electrically conductive layers can be generalized to any electrode sheet resistance distribution that smoothly varies and any substrate geometry and contact configuration by the following relationship between the sheet resistance from one contact (g=0) to another (g=L) along gradient curves that are perpendicular to isoresistance lines, R(g), and the corresponding opposing electrode sheet resistance distribution R′(g), R′(g)=R(g)*(L/g−1). The resistance between a bus bar and a line (substantially along an isoresistance line) at position ‘g’ in this case is found from an integral of the sheet resistance divided by a dimension along the line (substantially along an isoresistance line) in the interval from the bus bar to the position of the line along the resistance gradient lines (that are perpendicular to isoresistance lines). In such embodiments, relationships similar to the ones developed above for the simple rectangular geometry also can be derived to define how to pattern an electrically conductive layer so that the resistance profile approximates that of a resistance profile of an electrically conductive layer with a smoothly varying sheet resistance. The advantage to following the relationships are that electrochromic devices with more uniform local cell potential will result, which will also have more uniform optical properties (e.g. transmission) during switching.

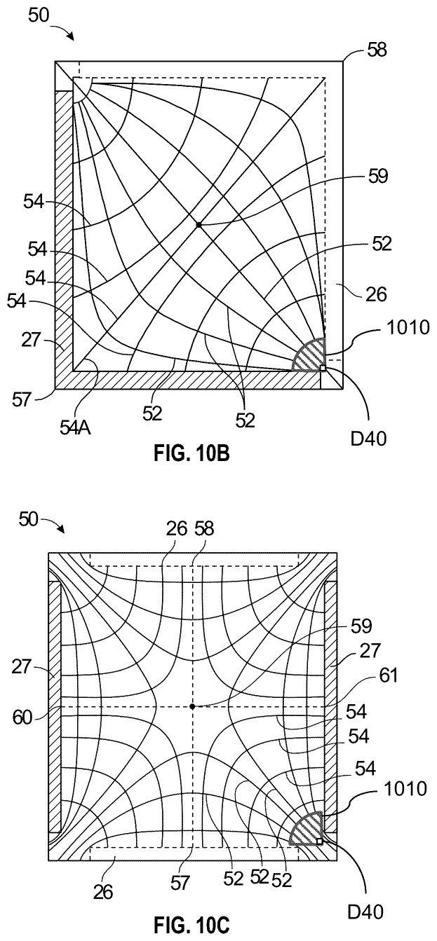

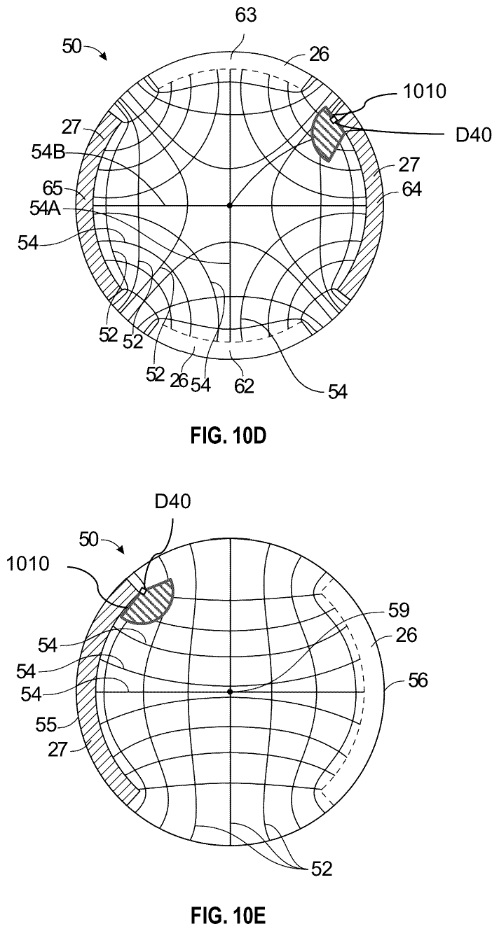

FIGS. 10A-10E depict contour maps of the sheet resistance, Rₛ, in an electrically conductive layer (i.e., the first electrically conductive layer, the second electrically conductive layer, or each of the first and second electrically conductive layers) as a function of (two-dimensional) position within the electrically conductive layer for several example embodiments of an electrochromic stack in accordance with some embodiments.

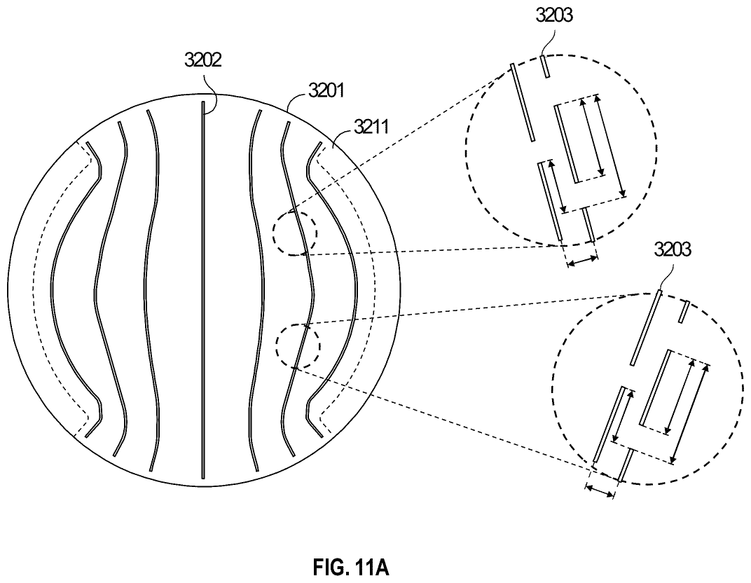

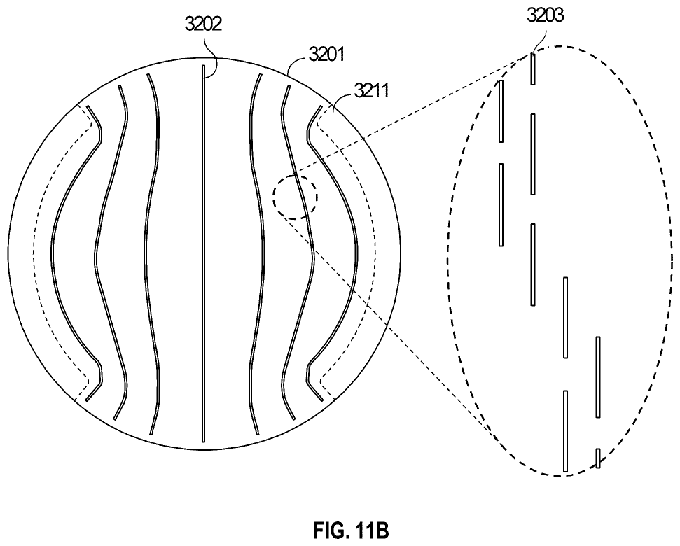

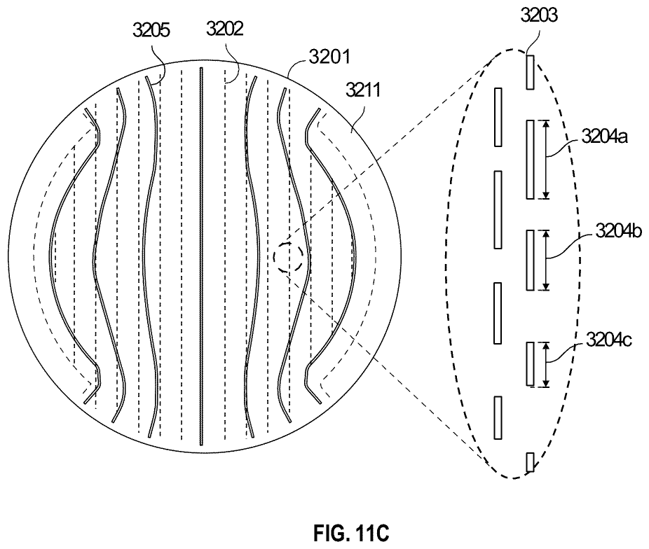

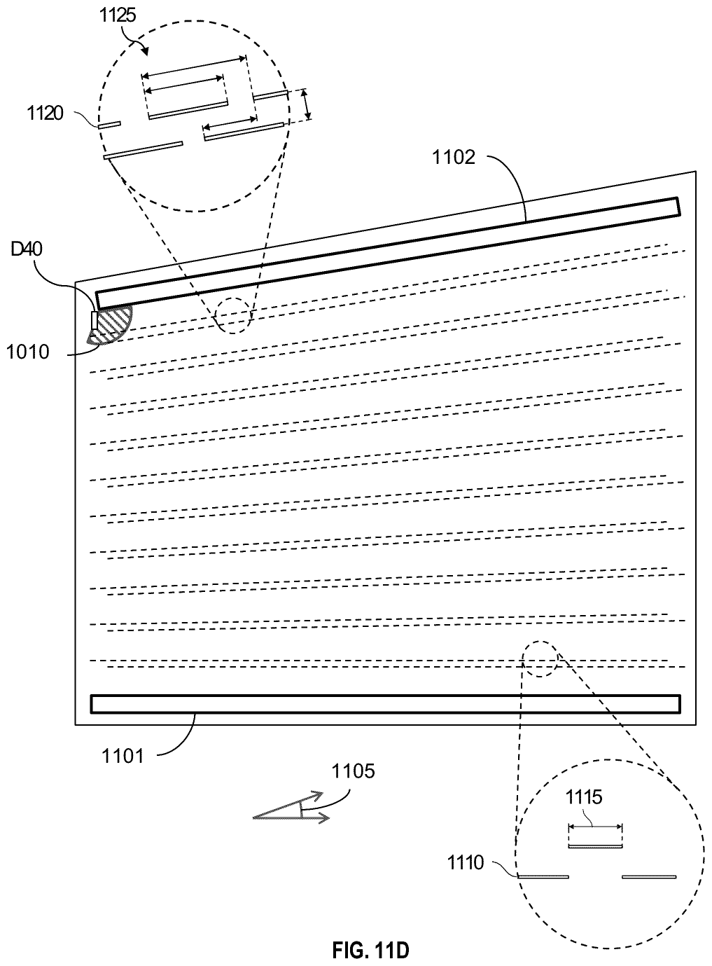

An example of a substrate of a non-rectangular shape is shown in FIG. 10E. The bus bars 26 and 27 in FIG. 10E are at either side of the circular substrate. The resistance gradient can be created in this case by sets of scribed lines 3202 along the isoresistance lines as shown in FIG. 11A. In this example, the scribed lines are at different angles that follow the contours of the isoresistance lines. The dimensions of the segments and other parameters in the sets of scribed lines are chosen to create the resistance gradients according to the relationships above in order to create a more uniform local cell potential. The more uniform local cell potential will enable the electrochromic device to switch more uniformly.

Another example of sets of scribed lines that can create the resistance gradients of the substrate in FIG. 10E are the sets of scribed lines 3202 along the isoresistance lines as shown in FIG. 11B. In this example, the scribed lines are all parallel but follow the contours of the isoresistance lines by using more than 2 scribed lines per set of scribed lines in a given isoresistance line. Again, the dimensions of the segments and other parameters in the sets of scribed lines are chosen to create the resistance gradients according to the relationships above in order to create a more uniform local cell potential, which will enable the electrochromic device to switch more uniformly.

One example of a substrate of a non-rectangular shape is shown in FIG. 10E. The bus bars 26 and 27 in FIG. 10E are at either side of the circular substrate. The resistance gradient can be created in this case by sets of scribed lines 3202 as shown in FIG. 11C. In this example, the scribed lines are parallel (i.e., do not follow the isoresistance lines 3205) but the length of the segments in the scribed lines (e.g. 3204a, 3204b and 3204c) vary along a set of scribed lines to create the resistance gradients required. The dimensions of the segments and other parameters in the sets of scribed lines are chosen to create the resistance gradients according to the relationships above in order to create a more uniform local cell potential. The more uniform local cell potential will enable the electrochromic device to switch more uniformly.

FIG. 11D shows an example of a non-rectangular (right trapezoidal) electrochromic device with scribed lines used to form a gradient in the resistance (or sheet resistance) of the electrically conductive layers. Bus bars 1101 and 1102 are referred to as irregular in this example because they are non-parallel. The sets of scribed lines in this example change angle 1105 as well as changing length 1115 and 1125 to form the gradient in the resistance (or sheet resistance) of the electrically conductive layers. In other examples, other features of the scribe geometry can change along with angle 1105 to form a gradient in the resistance (or sheet resistance) of the electrically conductive layers with non-rectangular substrates (and/or irregular bus bars).

In each of FIGS. 10A-10E, contour map 50 depicts a set of sheet isoresistance curves 52 (i.e., curves along which the sheet resistance, Rₛ, has a constant value) and a set of resistance gradient curves 54 that are perpendicular to isoresistance curves 52 resulting from an electrochromic stack having a perimeter that is square (FIGS. 10A, 10B, and 10C) or circular (FIGS. 10D and 10E) and varying numbers and locations of bus bars 26 and 27 in contact with the first and second electrically conductive layers (not labeled) of the electrochromic stack. In FIG. 10A, the direction of the set of gradients 54 indicates that the sheet resistance, Rₛ, within the electrically conductive layer progressively increases along the set of gradients 54 and between west side 55 and east side 56 of the electrically conductive layer in contact with bus bar 27. In FIG. 10B, the direction of gradient 54A indicates that the sheet resistance, Rₛ, within the electrically conductive layer in contact with bus bar 27 progressively decreases from southwest corner 57 to centroid 59 and then decreases from centroid 59 to northeast corner 58. In FIG. 10C, the direction of the set of gradients 54 indicate that the sheet resistance, Rₛ, within the electrically conductive layer in contact with bus bar 27 progressively decreases from the west side 60 and east side 61 to centroid 59 and progressively increases from the top side 58 and bottom side 57 to centroid 59; stated differently, sheet resistance, Rₛ, forms a saddle like form centered around centroid 59. In FIG. 10D, the direction of gradients 54a and 54b indicates that the sheet resistance, Rₛ, within the electrically conductive layer in contact with bus bar 27 progressively decreases from each of positions 64 and 65 to centroid 59 and progressively increases from each of positions 63 and 62 to centroid 59; stated differently, sheet resistance, Rₛ, forms a saddle like form centered around centroid 59. In FIG. 10E, the direction of the set of gradients 54 indicates that the sheet resistance, Rₛ, within the electrically conductive layer in contact with bus bar 27 progressively decreases from the west side 55 to the east side 56.

FIGS. 10A-10E and 11D also show possible locations of sense voltage pad D40 (as shown in FIGS. 1B and 1C) in these electrochromic devices with irregular bus bars (e.g., L-shaped bus bars) or non-rectangular substrates. Sense voltage pad D40 can be aligned with another sense voltage pad (e.g., in the z-direction as shown in FIG. 1C). In some embodiments, each of the sheet resistance profiles (shown by the contour maps including the isoresistance and gradients lines/curves) can be configured (or optimized, tailored, or designed) to form a region of maximum voltage drop (i.e., a region of maximum local cell potential) within the device (i.e., across the opposing electrically conductive layers, as shown in FIG. 1C), wherein that region 1010 of maximum voltage approximately aligns with sense voltage pad D40. In some embodiments, region 1010 is a region comprising the sense voltage pad, that also includes the maximum local cell potential. In other embodiments, sense voltage pad D40 can be in other locations within an active region of the electrochromic devices in FIGS. 10A-10E and 11D. For example, sense voltage pads (e.g., D40) can be near a bus bar, or near an end of a bus bar. In general, the sense voltage pads can be located anywhere in the active region where electrical contacts can be made to the sense voltage pad (e.g., along an edge in a position that does not coincide with a bus bar). In cases where the sense voltage pad is scribed from the electrically conductive layer (e.g., TCO material) then it can be advantageous to form the sense voltage pad near an edge of the device.

For example, the gradients in the sheet resistance of the electrically conductive layers of the devices depicted in FIGS. 10A-10E can be formed using patterning (e.g., using laser etching or chemical etching), thickness variations, electrical property variations, or variations in concentrations of nanostructures (e.g., particles or wires embedded in a conductive or insulating matrix), as described herein. For example, the scribed patterns in FIGS. 5, and/or 11A-11C can be used to vary the sheet resistance of the electrically conductive layers (or vary the resistance to flow of electrons parallel to a major surface of the layers) such that a region of high voltage drop (or high local cell potential) is formed approximately where the sense voltage pad is positioned.

In general, electrical circuit modeling may be used to determine the sheet resistance distribution providing desired switching performance, taking into account the type of electrochromic device, the device shape and dimensions, electrode characteristics, and the placement of electrical connections (e.g., bus bars) to the voltage source. The resistance distribution to approximate the desired sheet resistance distribution, in turn, can be controlled, at least in part, by patterning the first and/or second electrically conductive layer(s), and optionally grading the thickness of the first and/or second electrically conductive layer(s), grading the composition of the first and/or second electrically conductive layer(s), or some combination of these.

### First and Second Electrically Conductive Layer Variations

In some examples, to facilitate more rapid switching and/or more uniform switching of electrochromic device 1 from a state of relatively greater transmittance to a state of relatively lesser transmittance, or vice versa, at least one of electrically conductive layers 22, 23 has a patterned layer. By way of further example, one of first and second electrically conductive layers 22, 23 can be a patterned layer and the other can be a layer with a graded thickness or graded composition as described herein. Alternatively, the first electrically conductive layer 22 and second electrically conductive layer 23 can both be patterned.

In another example, the electrochromic device is an electrochromic window, where (referring to FIG. 1A) the first substrate 24 and second substrate 25 are panes of glass or other transparent substrate and electrochromic device 1 has two bus bars 26, 27 located on opposite sides of first electrode layer 20 and second electrode layer 21, respectively. Additionally, the first electrically conductive layer is patterned such that the resistance to the flow of electrons in the first electrically conductive layer 22 that generally increases non-linearly (e.g., approximating a hyperbolically varying sheet resistance) with increasing distance from bus bar 26, and/or the second electrically conductive layer is patterned such that the resistance to the flow of electrons in the second electrically conductive layer 23 generally increases non-linearly (e.g., approximating a hyperbolically varying sheet resistance) with increasing distance from bus bar 27.

Electrochromic Device with Electrically Conductive Layer Configured for Use with Sense Voltage

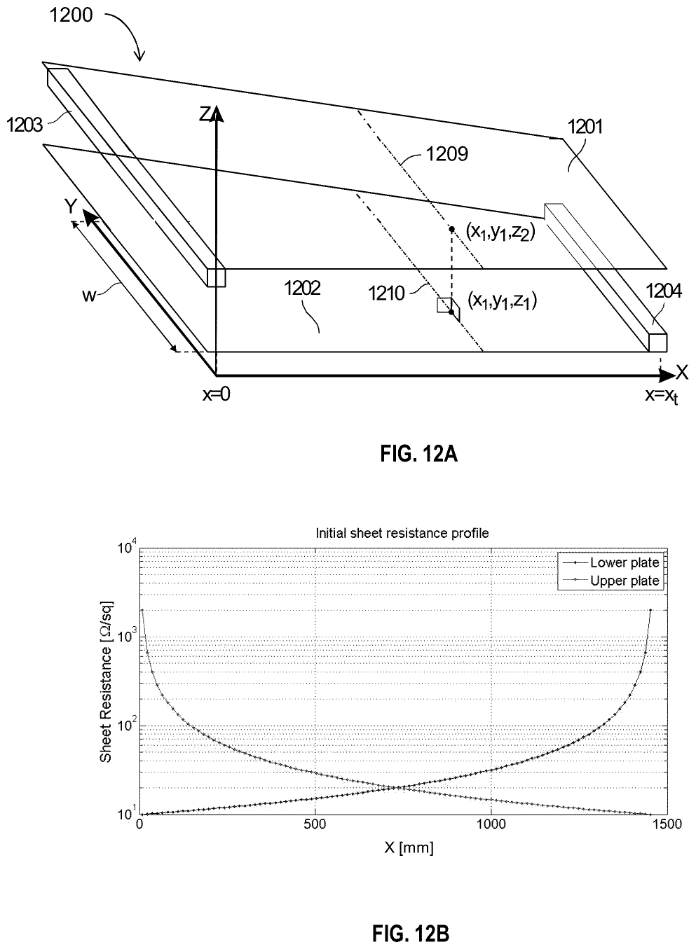

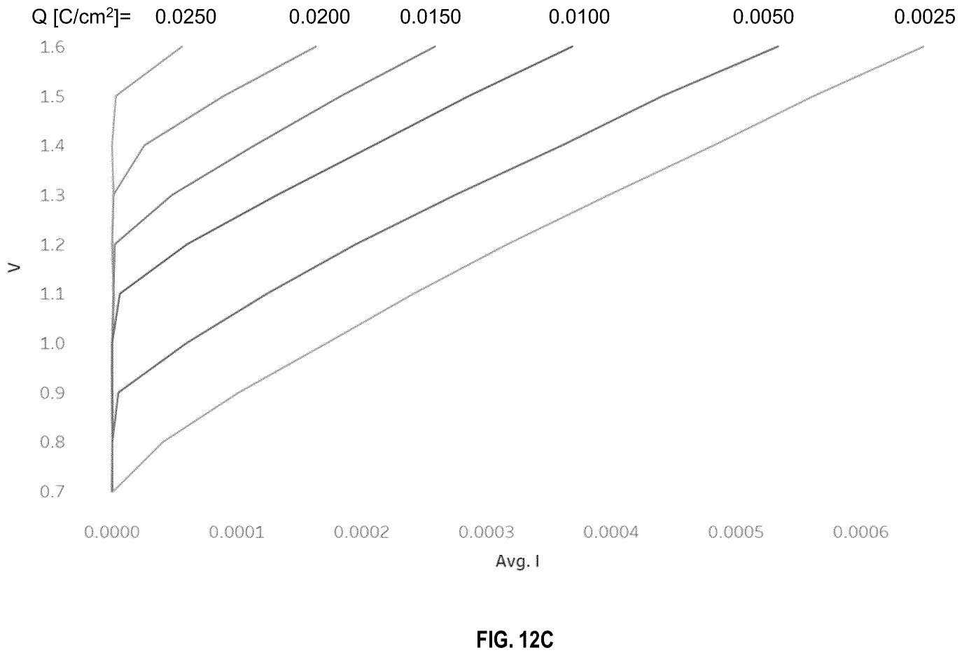

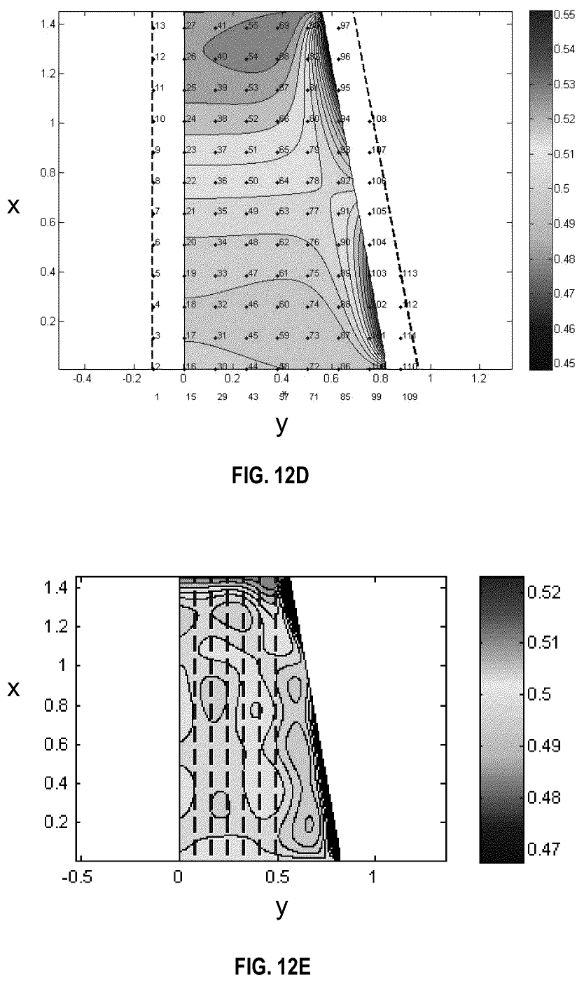

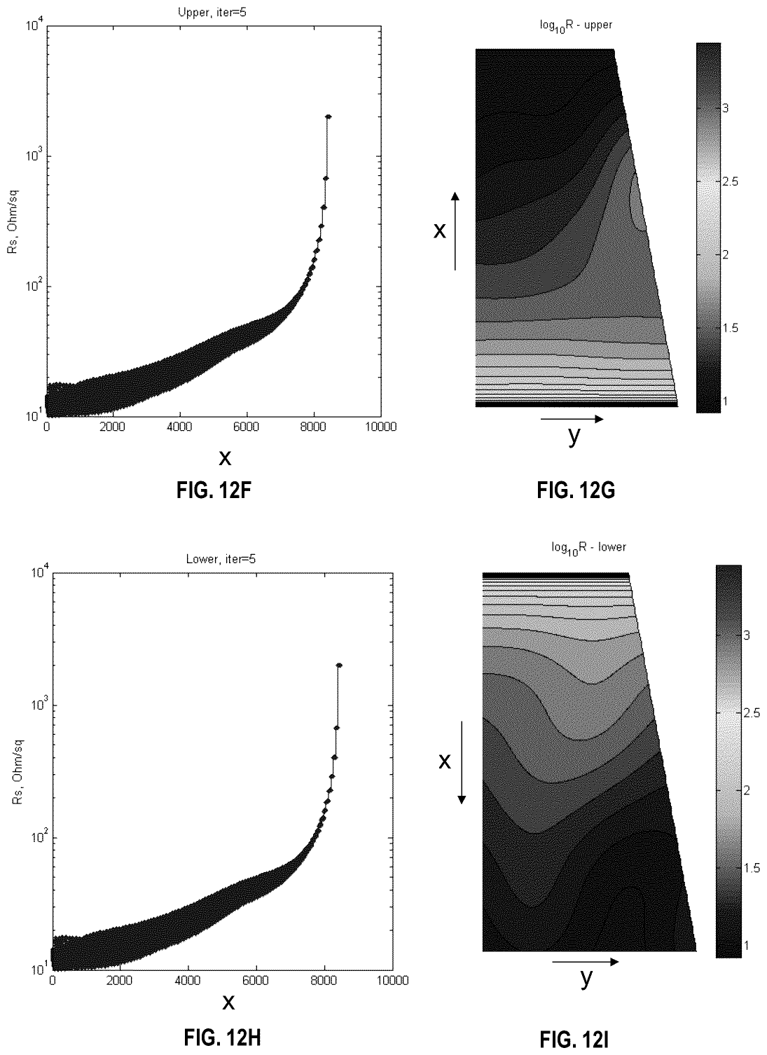

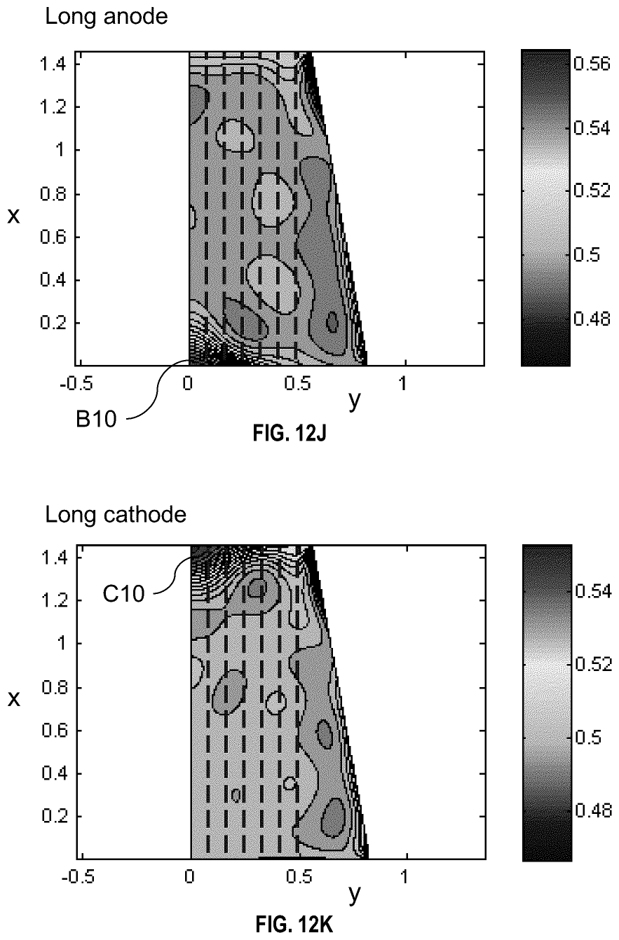

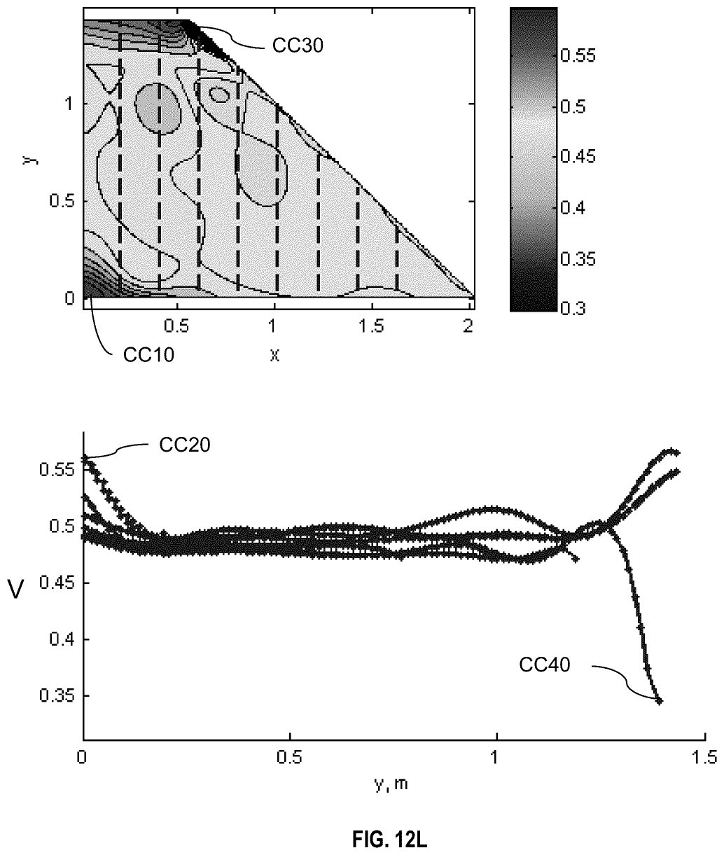

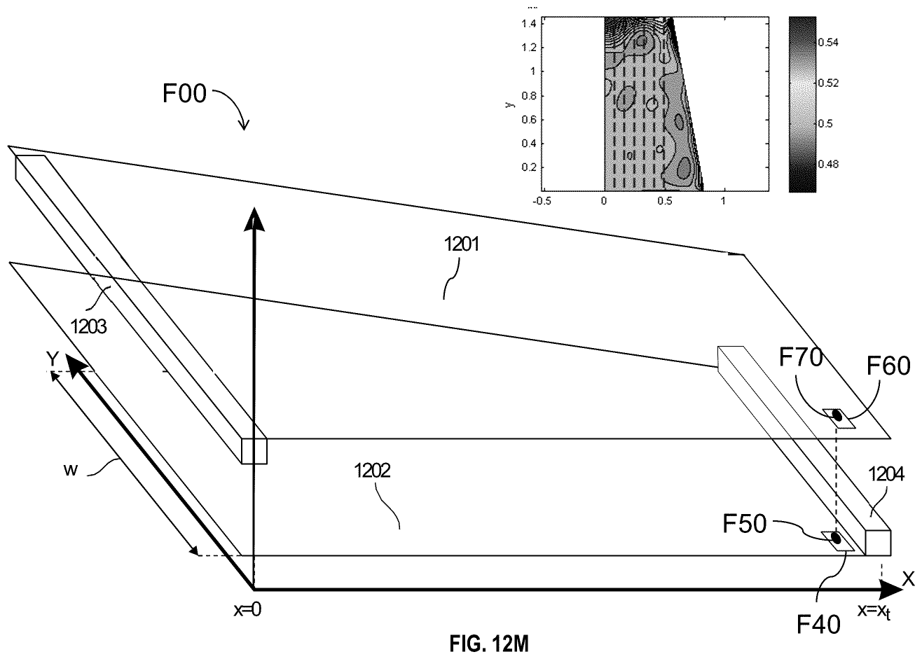

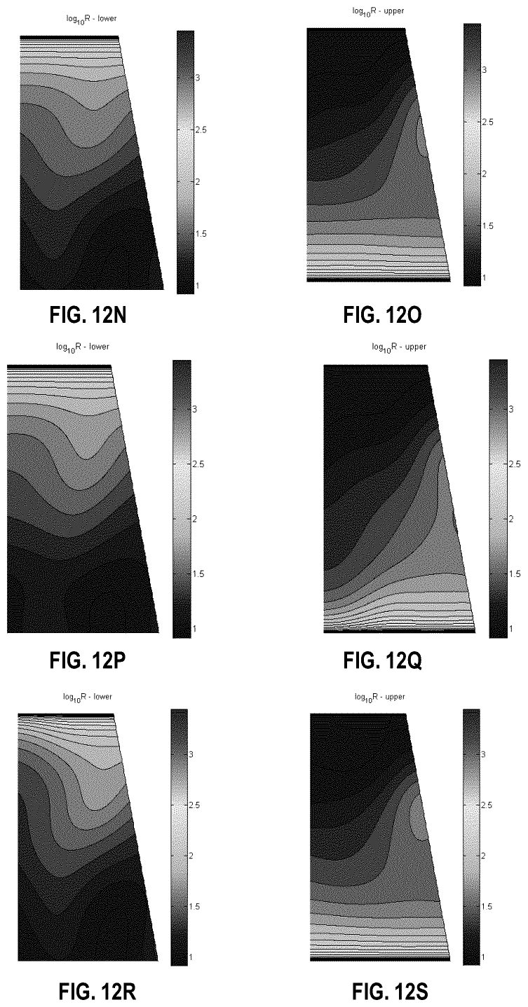

FIG. 12A shows an example of an electrochromic device 1200 with non-rectangular substrates. In this example, the substrates, electrically conductive layers, electrode layers (electrochromic layers), and other device layers (e.g., an ion conductor layer between two electrode layers) are all approximately right trapezoids. The bus bars in device 1200 are parallel to each other and are different lengths. For example, the upper substrate 1201 can have an electrically conductive layer and a cathodic electrochromic layer formed on it, the lower substrate 1202 can have an electrically conductive layer and a anodic electrochromic layer formed on it, and the cathode bus bar 1203 can be longer than the anode bus bar 1204, as shown in FIG. 12A.

FIG. 12B shows an example of a gradient profile of the sheet resistance that can be used for the upper and lower electrically conductive layers of device 1200 in FIG. 12A including non-rectangular substrates. The resistance profiles shown in FIG. 12B can be formed in the upper and lower electrically conductive layers of device 1200 such that the resistance profiles vary as shown in the x-direction and are substantially constant (do not vary) along the y-direction (for all x-positions).

FIGS. 12C-12S include non-rectangular electrochromic device structures and details and results of modeling the devices, in accordance with some embodiments. In general, similar models can be used to simulate other shapes of non-rectangular electrochromic devices, or electrochromic devices with irregular bus bars (e.g., non-parallel bus bars, or one or more of L-shaped bus bars, angled bus bars, bent bus bars, curved bus bars, etc.). For the results shown herein, finite element models were used that simulated the electrical potential drops between bus bars and positions in the electrically conductive layers, and then a lookup table was used to simulate the current voltage characteristics of the electrochromic cell stack between the electrically conductive layers (e.g., as shown in FIG. 1A). The lookup table serves to model the vertical component (e.g., in the z-direction in FIG. 12A) of fundamental electrochromic device electrical characteristics (e.g., an effective resistance). FIG. 12C shows an example of a lookup table that can be used in the models. The lookup table in FIG. 12C was determined experimentally using a small (e.g., about 6″×6″) test electrochromic device, wherein the device was initial bleached, the voltage was set to a particular value, and the current was recorded. The transferred charge (“Q [C/cm²]”) was determined by integrating the recorded current over time. This procedure was then repeated over a range of voltages. The data in FIG. 12C has been rearranged and shows that the current-voltage relationship may not be linear. The vertical component of the electrical properties of the device will generally be affected by the electrochromic and ion conducting materials used, and using such a lookup table enables the model to calculate local cell potential in a device with resistance gradients. For example, the portion of each node in a finite element model that is between the two electrically conductive layers can be modeled as a local electrochromic device element that behaves according to the lookup table. In such a case, the model can use an amount of accumulated charge built up at the node (e.g., for a particular voltage applied to the bus bars, or for a particular target tint state) and then use the amount of accumulated charge at the node to determine which of the curves (or transfer functions) in FIG. 12C to use to model the current-voltage properties of the node. The accumulated charge can be an offset from a nominal or zero value. During a minimization procedure, the finite element model can use the lookup table for each local resistance map iteration until a final local cell potential map is produced that meets the target requirements. In other embodiments, the vertical component of the electrical properties of the device can be modeled using an equivalent circuit to determine the effective resistance of the electrochromic layer stack instead of a lookup table.

FIG. 12D shows a simulated voltage distribution of an electrochromic device with right trapezoid substrates, wherein the electrically conductive layers of the device have gradients of electrical resistance (or sheet resistance gradients) similar to those shown in FIG. 12B along the x-direction and is substantially constant along the y-direction for all x-positions. The device has two parallel bus bars that are different lengths, positioned similar to those in the device 1200 in FIG. 12A. The voltage distribution plotted in FIG. 12D is the local cell potential (or, voltage drop between the upper and lower electrically conductive layers, in a device similar to the device shown in FIG. 12A), wherein a cathodic electrochromic layer, an ion conducting layer, and an anodic electrochromic layer are disposed between the upper and lower electrically conductive layers (e.g., as shown in FIGS. 1A and 12A), which are formed on upper and lower substrates. The modeling results in FIG. 12D show that there is significantly non-uniform local cell potential (or, voltage drop across the device), when a bias is applied across the bus bars, and such a gradient in resistance is used.

FIG. 12E shows a simulated voltage distribution of an electrochromic device with right trapezoid substrates, wherein the electrically conductive layers of the device have gradients of electrical resistance (or sheet resistance gradients) that vary along the x-direction and that also vary along the y-direction (or are allowed to vary along the y-direction at all x-positions). An algorithm was used to configure (or optimize, or design, or tailor) the resistance gradients (or gradients in electrical resistance, or sheet resistance gradients), using the initial (e.g., analytically or numerically produced) resistance gradients shown in FIG. 12B (and simulated in the device in FIG. 12D) as a starting point. The algorithm varies the gradient resistance profiles and determines an output local cell potential map for the device based on the gradient resistance profiles. The output local cell potential map is then compared with a target local cell potential map, and a difference between the two maps is calculated. The algorithm then attempts to minimize the difference between the output and the target local cell potential maps. In the examples shown in FIGS. 12D and 12E, the target local cell potential map was uniform across the active area of the device. The voltage distribution shown in FIG. 12E is an example of an improved (i.e., more uniform) distribution compared to the voltage distribution shown in FIG. 12D. However, there are still regions of high voltage in the device simulated in FIG. 12E, for example, that occur near the short edge of the device. Such regions of high voltage will switch more quickly when a bias is applied (and electrical current flows) between the bus bars, and will appear as visual non-uniformities during device switching.

FIGS. 12F-12I show the gradients in sheet resistance (or the resistance gradient profiles, or the resistances to the flow of electrical current as a function of position) that are simulated in the device in FIG. 12E. FIGS. 12F and 12H show plots of the sheet resistance of the upper and lower electrically conductive layers, respectively, at all (x,y) positions overlayed. FIGS. 12G and 12I show corresponding contour maps of the sheet resistance of the upper and lower electrically conductive layers, respectively, in logarithmic scale.

FIGS. 12J and 12K show simulated voltage distributions of electrochromic devices with right trapezoid substrates, where the electrically conductive layers of the devices have gradients of electrical resistance (or sheet resistance gradients) that are similar to those of the device simulated in FIG. 12E (wherein the electrically conductive layers have gradients of electrical resistance (or sheet resistance gradients) that vary along the x- and y-directions). In this case, the gradients of electrical resistance have been configured (or optimized, or designed, or tailored) such that a local maximum of local cell potential (or, voltage drop) has been designed into the device. In the examples shown in FIGS. 12D and 12E, the target local cell potential map was non-uniform across the active area of the device, and included an area of maximum local cell potential aligned with a known sense voltage pad position. The devices simulated in FIGS. 12J and 12K have parallel bus bars with different lengths (similar to those shown in FIG. 12A). The device simulated in FIG. 12J has a longer bus bar coupled to the substrate with the anodic electrochromic layer (i.e., a “long anode bus bar”), and the device simulated in FIG. 12K is a mirror image of the device in FIG. 12J (i.e., it is shown from the opposite side, with the positions of the anode and the cathode substrates switched) has a longer bus bar coupled to the substrate with the cathodic electrochromic layer (i.e., a “long cathode bus bar”). In both cases, the regions of high voltage are formed near the anode bus bar to align with the position of the sense voltage pads. Aligning the region (B10 and C10) of maximum local cell potential with the sense voltage pads can help avoid damage during switching in these devices while switching more uniformly and more quickly than devices with no gradients in electrical resistance in the electrically conductive layers. In such cases, regions B10 and C10 are regions that include the sense voltage pad, in addition to the maximum local cell potential. In other words, intentionally forming a non-uniform local cell potential to include a region (B10 and C10) of maximum local cell potential aligned with sense voltage pads can be beneficial for electrochromic devices.

FIG. 12L shows a simulated voltage distribution of an electrochromic device with right trapezoid substrates, where the electrically conductive layers of the devices have gradients of electrical resistance (or sheet resistance gradients) that are similar to those of the device simulated in FIG. 12E (wherein the electrically conductive layers have gradients of electrical resistance (or sheet resistance gradients) that vary along the x- and y-directions). The device simulated in FIG. 12L has parallel bus bars with different lengths similar to those shown in FIG. 12A, however, the device simulated in FIG. 12L has a different shape with a larger difference in the lengths of the bus bars). In this case, the gradients of electrical resistance have been configured (or optimized, or designed, or tailored) such that a region of local maximum of local cell potential CC10 (or, voltage drop) has been designed into the device. In this case, the device has a long anode bus bar and the region of maximum local cell potential is formed near the anode bus bar to align with the position of the sense voltage pad. Aligning the region of maximum local cell potential with the sense voltage pad can help avoid damage during switching in these devices while switching more uniformly and more quickly than devices with no gradients in electrical resistance in the electrically conductive layers.

The lower plot in FIG. 12L shows values of voltage along the dashed lines in the upper plot in FIG. 12L. In this case, the gradients in the electrical resistance have been configured to provide a more uniform potential drop across the device, and most of the central region of the device simulated in FIG. 12L has local cell potential (or, voltage drop across the device) about 0.5 V, or between 0.47 V and 0.52 V. However, near the bus bars (at y-positions 0 and about 1.5), the voltage drops can be significantly higher (e.g., above 0.55 V) or lower (e.g., below (0.4 V) compared to the average of about 0.5 V. (Note there is no curve in the lower plot that shows the data for the maximum cell potential CC10 position.) The region of maximum local cell potential CC10 has a local cell potential CC20. The regions of lower voltage will switch more slowly and will appear as non-uniform areas during device switching. The regions of higher voltage will switch more quickly and will also be visually non-uniform, and more problematically, can degrade more quickly than areas with lower voltage drops. For example, durability and damage problems could occur in high voltage drop regions of devices that have one or more sense voltage pads (used to control the switching of the device, e.g., to prevent damage) located at a region of average, or below average voltage drop, since the high voltage regions will tend to be overdriven during switching. Referring to FIG. 12L, if a sense voltage electrode were placed near region CC10 with a significantly lower voltage drop CC20 compared to the rest of the device, then much of the device could be damaged during switching. Therefore, it can be advantageous to configure the resistance gradients in the electrically conductive layers to form a region of maximum voltage drop that is aligned with a position of a sense voltage pad.

The results of experimentation (the results of which are described in the Examples section herein) and the results of the modeling in FIGS. 12D-12L are not easy to predict without performing the physical experiments or detailed modeling. For example, it was discovered that non-rectangular devices suffer from non-uniformity issues, even when gradients were used that were configured for the non-rectangular devices. It was found through the experimentation and detailed modeling that devices with fairly uniform local cell potentials (or voltage drops) across most of the device can suffer from local hot spots. It was further realized that the location of the sense voltage pad with respect to the hot spots is important, when drivers and drive methods are used that rely on measurements from the sense voltage pad. This led to discovery that non-rectangular devices could benefit from configuring the gradients to form a region of maximum local cell potential aligned with the sense voltage pad position. It was only through experimentation and detailed modeling that these concepts became apparent. They were not apparent before the detailed modeling and experimentation was done.

Additionally, it should be noted that several manufacturing constraints lead to the discovery of the concepts described above and the devices and methods described herein. For example, it is challenging to form a gradient to provide a uniform local cell potential across the entire active area of a right trapezoid device where the bus bars are constrained to be parallel (forcing them to be different lengths). The modeling and experiments described herein, performed to overcome these practical constraints imposed by manufacturing equipment limitations, lead to the realization of the concepts described above and the devices and methods described herein.

FIG. 12M shows a schematic of an example of an electrochromic device F00 similar to device 1200 shown in FIG. 12A (and described above). In this example, device F00 includes sense voltage pads F40 and F60 and sense voltage terminals F50 and F70, where there is sense a voltage pad and terminal on each substrate. Sense voltage pads F40 and F60 and sense voltage terminals F50 and F70 in this example can be configured to measure a local cell potential at a sense voltage measurement position within the electrochromic device, for example as shown by sense voltage pads D40 and E40 in FIGS. 1B and 1C. For example, sense voltage pad F40 (and F60) can be formed by etching (or otherwise isolating) a region of the transparent conductive layer on that substrate. The sense voltage pads F40 and F60 can be located near a region of high potential (e.g., as shown in the plot in FIG. 12K, and in the inset of FIG. 12M). During switching, the driver can use an input from the sense voltage to limit the bias applied to the bus bars, which can help prevent damage (due to a local potential exceeding a threshold potential for damage in the device).

In some embodiments, the resistance gradients can be configured (or optimized, or designed, or tailored) for use with sense voltage pads. For example, the resistance gradients of one or both electrically conductive layers can be formed such that the highest local cell potential (or, voltage drop across the layers of the device) occurs at (or near, or approximately at) the position of the sense voltage pads.

FIGS. 12N-12S show examples of resistance gradients for upper and lower electrochromic layers of electrochromic devices with right trapezoid substrates.

FIGS. 12N-12O show examples of resistance gradients (or sheet resistance gradients) that are similar to those of the device simulated in FIG. 12D (wherein the electrically conductive layers have gradients of electrical resistance (or sheet resistance gradients) that vary along the x- and y-directions), but where no local maximum of local cell potential (or, voltage drop) has been designed into the devices.

FIGS. 12P-12Q show examples of resistance gradients (or sheet resistance gradients) for an electrochromic device with a long anode bus bar, where the resistance gradients vary along the x- and y-directions, and where a local maximum of local cell potential (or, voltage drop) has been designed into the device near the right-angle corner of the long anode bus bar.

FIGS. 12R-12S show examples of resistance gradients (or sheet resistance gradients) for an electrochromic device with a long cathode bus bar, where the resistance gradients vary along the x- and y-directions, and where a local maximum of local cell potential (or, voltage drop) has been designed into the device near the right-angle corner of the short anode bus bar.

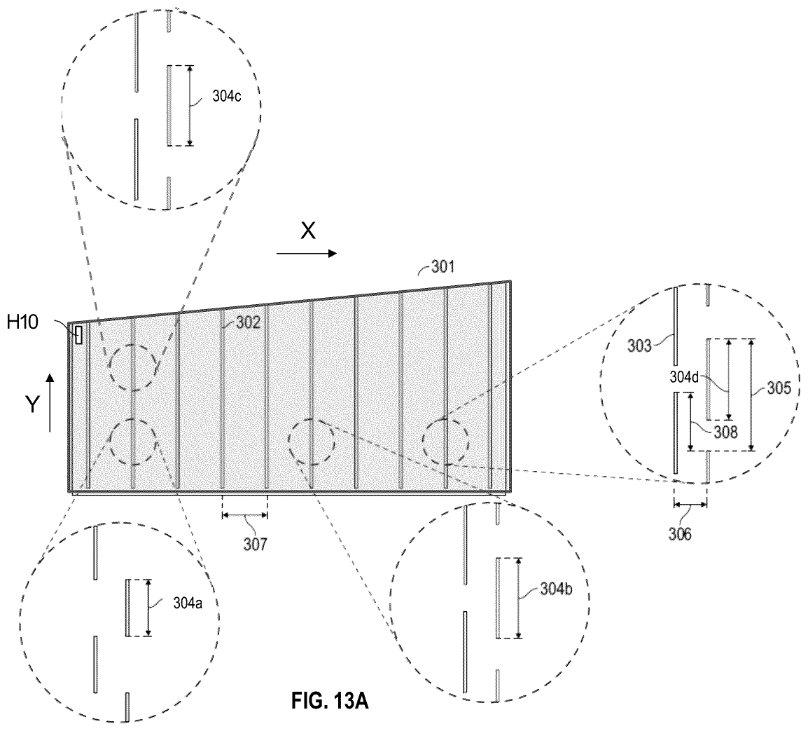

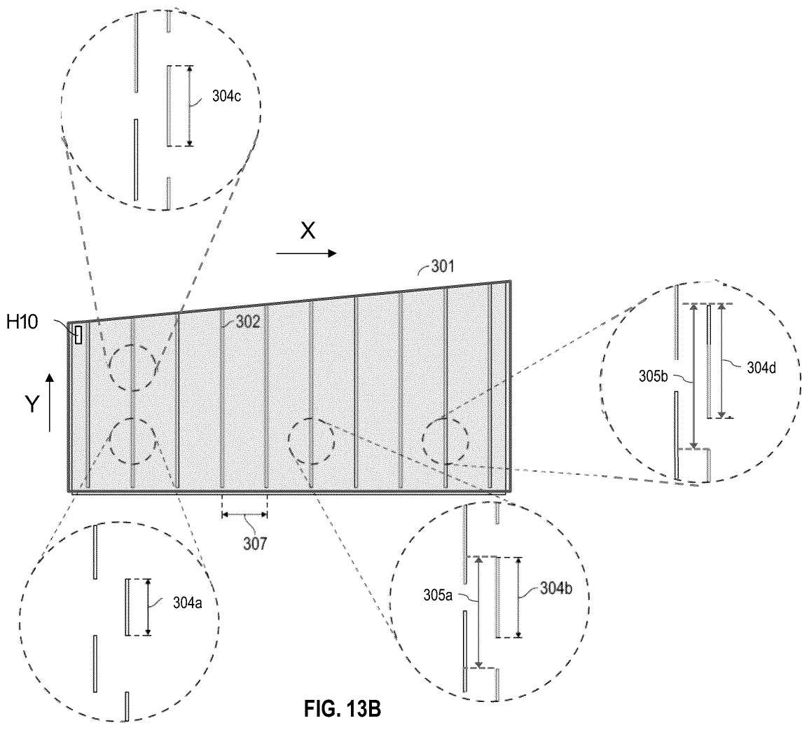

FIG. 13A shows a schematic example of an electrochromic device with scribed lines that form a resistance gradient in an electrically conductive layer. The device shown in FIG. 13A is similar to that shown in FIG. 5, however, the device in FIG. 13A is non-rectangular. The scribe patterns in the device shown in FIG. 13A have sets of scribed lines that are approximately parallel with the parallel bus bars. The sets of scribed lines in this example have segment lengths (304a, 304b, 304c and 304d) that vary along the two orthogonal directions (both x- and y-directions) to configure the resistance gradient in the electrically conductive layer to form a more uniform local cell potential (or, voltage drop) and/or to form a region with a maximum local cell potential (that can be approximately aligned with a sense voltage pad H10).

Other variations in scribe geometries can also provide the resistance gradients for non-rectangular substrates (e.g., right trapezoidal substrates as shown in FIGS. 12G, 12I, 12J, 12K, 12L, 12O, 12Q and 12S, or other non-rectangular substrate shapes). For example, the length of the segments 304a-d, the period 305, the valve width 306, the offset 308 between the segments in the adjacent sets of scribed lines, or the period offset (e.g., 309 shown in FIG. 8) can be varied (independently or in combination) to provide resistance gradients for non-rectangular substrates. Any of these geometries can be varied in the x-direction, the y-direction, or in both the x- and y-directions to achieve a resistance gradient in a non-rectangular device.

FIG. 13B shows a schematic example of an electrochromic device with scribed lines that form a resistance gradient in an electrically conductive layer. In this example, scribe length 304d is longer than the period 305a (associated with scribe length 304b) and the period 305b has been increased to accommodate the longer scribe length 305d.

Additionally, the gradients described herein can be formed without using scribe patterns, for example, using thickness variation and/or electrical property variation in a transparent conductive material. For example, the gradients in FIGS. 12G, 12I, and 12N-12S can be formed using variable thickness TCO layers, TCO layers with variable electrical properties (e.g., variation in concentrations of defects and/or dopants), or using variation in concentration of nano particles embedded in a matrix.

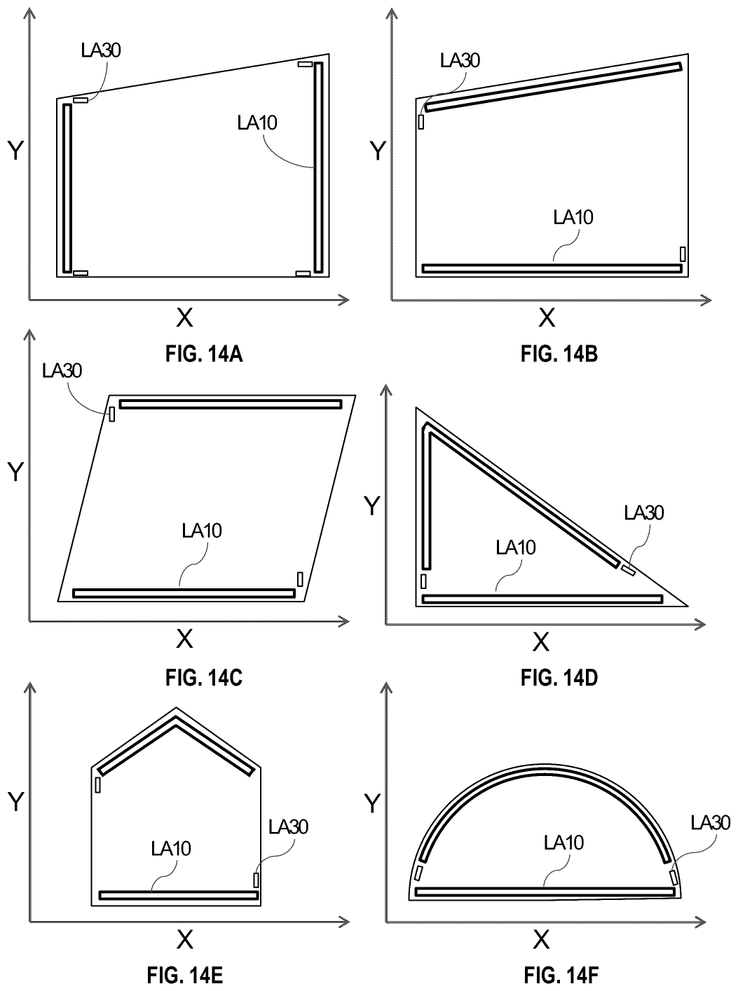

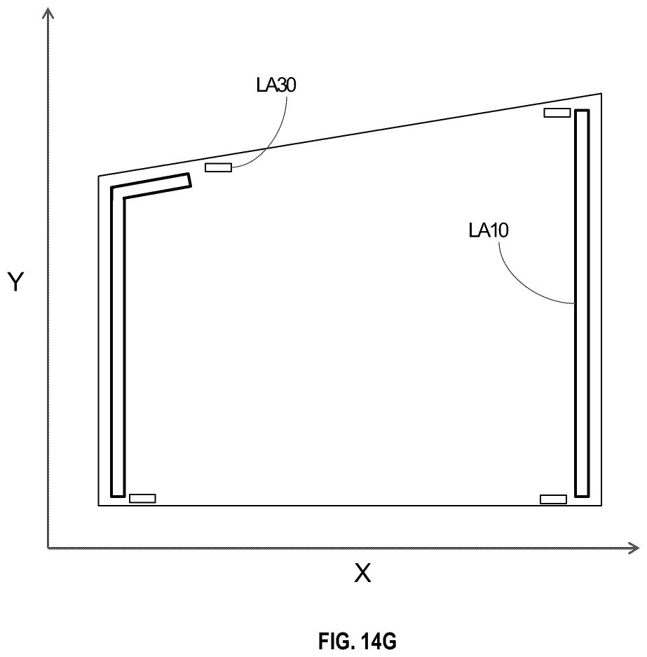

FIGS. 14A-14G shows examples of non-rectangular electrochromic devices with bus bars LA10. Each device also shows possible positions for sense voltage pads LA30, wherein the gradients can be configured to form a region of maximum local cell potential aligned with a sense voltage pad. Sense voltage pads LA30 in this example can be configured to measure a local cell potential at a sense voltage measurement position within the electrochromic device, for example as shown in sense voltage pads D40 and E40 in FIGS. 1B and 1C. Some embodiments show more than one sense voltage pad LA30 location, which can depict devices with multiple sense voltage pad locations, or possible locations for a single sense voltage pad (or single set of sense voltage pads aligned in a z-direction, which is out of the page). For example, FIGS. 14D-14G show examples with irregular bus bars that are either angled or curved. The example in FIG. 14G shows a device with a right trapezoidal shape, wherein one of the bus bars is bent near the obtuse corner such that the two bus bars have approximately the same lengths. The devices in FIGS. 14A-14G all show two opposing bus bars, but in other cases, more than two bus bars can also be used.

In some cases, manufacturing equipment can place practical constraints on the shapes of devices and the types of patterns that can be achieved in production (e.g., in a mass manufacturing environment). For example, manufacturing equipment may only be capable of forming parallel bus bars. In another example, manufacturing equipment may be limited to producing certain types of scribe patterns such as those with straight scribed lines and parallel scribe segments. In another example, manufacturing equipment may cause certain types of scribe patterns to be undesirable (or unfeasible) due to throughput requirements, and in such cases it can be advantageous to minimize the number of sets of scribed lines, or limit the type or number of movements (e.g., in a certain direction, e.g., x- or y- as described herein) of a laser stage that is used to form of sets of scribed lines. In some cases, the width of a scribed line in an electrically conductive layer of a device is constrained to be below a certain value to minimize its visual appearance (e.g., be invisible to a user, or to be substantially invisible to a user positioned beyond a certain distance from the device). In some cases, manufacturing constraints (or other real-world issues, such as manufacturing variability) may make it impossible (or undesirable, e.g., due to throughput issues) to form electrochromic devices with gradients in electrical resistance that have perfectly uniform switching. The devices and methods described herein can be used to configure (or optimize, or tailor, or design) the gradients in electrical resistance to form electrochromic devices that have a more uniform switch, a faster switch, and/or are better protected against damage or degradation (e.g., due to overdriving certain areas of the device). For example, the devices and methods described herein can be used to configure (or optimize, or tailor, or design) the gradients in electrical resistance to form electrochromic devices with a region of maximum local cell potential (or voltage drop) aligned with a sense voltage pad (e.g., to improve the device durability). The gradients in electrical resistance can also simultaneously be configured to improve the switching uniformity and speed compared to devices with no gradients (or less optimized gradients).

The gradients in electrical resistance of the electrically conductive layers described herein can be beneficial for both rectangular and non-rectangular devices. For example, real-world design constraints can be incorporated into target local cell potential maps and into resistance gradients for electrically conductive layers of a rectangular device with parallel bus bars (or a non-rectangular device).

For example, in some cases, an optimal sheet resistance profile would include an infinite (or very large) sheet resistance near one or both bus bars of the device. However, such infinite (or large) resistances are impossible (or not practical) to achieve (e.g., using patterns of scribed lines). In such cases, the gradients electrical resistance of the electrically conductive layers can be configured (or optimized, or tailored, or designed), with constraints in the maximum achievable sheet resistances, to form rectangular electrochromic devices that have a more uniform switch, a faster switch, and/or are better protected against damage or degradation (e.g., due to overdriving certain areas of the device), compared to devices that do not use the improved gradients described herein.

In another example, regions close to an edge or bus bar of a rectangular (or non-rectangular) device can have different resistance gradients than regions that are away from an edge, corner, or end of a bus bar. For example, some potential can be dropped along a bus bar (particularly if the bus bars are long, and/or are made from relatively high resistivity materials), and the resistance gradients can be configured to account for such potential drops along the bus bars.

In another example, the resistance gradients in a rectangular (or non-rectangular) device can be configured to form a region of maximum local cell potential (or voltage drop) aligned with a sense voltage pad. Additionally, the resistance gradients in a rectangular (or non-rectangular) device can be configured to compensate for any potential lost between the sense voltage pad and the sense voltage terminal (e.g., a connector), which can be advantageous since it can relax some constraints on the position of the sense voltage pad (e.g., it can be moved farther away from the terminal).

In real-world devices, small variations in resistance (e.g., due to manufacturing variability) can cause the sense voltage pad to be aligned with a region of low or average local cell potential, in some cases, and therefore such devices would also benefit from configuring the gradients to form a region of maximum local cell potential aligned with a sense voltage pad.

In real-world cases, such as those with manufacturing constraints described above, it can be difficult to determine an analytical solution for the resistance gradients, and the devices and methods described herein can be used to overcome real-world challenges, for both rectangular and non-rectangular devices. For example, the devices and methods described herein can include varying the resistance gradients in two orthogonal directions (e.g., x- and y-directions in FIGS. 1C, 3A and 12A) to improve the properties of real-world devices. In some cases, this is achieved by such rectangular or non-rectangular devices having intentionally non-uniform local cell potential maps, for example, to form a region of maximum local cell potential aligned with a sense voltage pad.

Methods for Electrochromic Devices with Resistance Gradients

In some embodiments, a method for controlling an electrochromic device described herein includes the following: applying a constant supply current to the electrochromic device using at least two bus bars of the electrochromic device; determining an amount of charge transferred to the electrochromic device, as a function of time and current supplied to the electrochromic device; measuring a sense voltage using a first sense voltage pad of the electrochromic device; ceasing the applying the constant supply current, responsive to the sense voltage reaching a sense voltage limit; applying one of a variable voltage or a variable current to the electrochromic device using the bus bars to maintain the sense voltage at the sense voltage limit, responsive to the sense voltage reaching the sense voltage limit; and terminating the applying the variable voltage or the variable current to the electrochromic device, responsive to the determined amount of charge reaching a target amount of charge. For example, the electrochromic device can include two electrically conductive layers each comprising a gradient in electrical resistance, wherein the gradients in electrical resistance are configured to align the first sense voltage pad and a region comprising a maximum local cell potential across the first electrically conductive layer and the second the first electrically conductive layer when an external bias is applied to first and the second bus bars of the electrochromic device.

In some embodiments, a method related to an electrochromic device described herein includes the following: applying a constant supply current to the electrochromic device using a first bus bar and a second bus bar; determining an amount of charge transferred to the electrochromic device, as a function of time and current supplied to the electrochromic device; measuring a sense voltage using the first sense voltage pad of the electrochromic device; ceasing the applying the constant supply current, responsive to the sense voltage reaching a sense voltage limit; applying one of a variable voltage or a variable current to the electrochromic device using the bus bars to maintain the sense voltage at the sense voltage limit, responsive to the sense voltage reaching the sense voltage limit; and terminating the applying the variable voltage or the variable current to the electrochromic device, responsive to the determined amount of charge reaching a target amount of charge. For example the electrochromic device can include: a first electrically conductive layer arranged on an inner surface of a first transparent substrate, wherein the first electrically conductive layer comprises a first gradient in resistance to the flow of electrical current through the first electrically conductive layer that varies as a function of position; a second electrically conductive layer arranged on an inner surface of a second transparent substrate, wherein the second electrically conductive layer comprises a second gradient in resistance to the flow of electrical current through the second electrically conductive layer that varies as a function of position; a first bus bar in contact with the first electrically conductive layer; a second bus bar in contact with the second electrically conductive layer; and a first sense voltage pad in contact with the first electrically conductive layer. The first and second gradients in resistance can be configured to align the first sense voltage pad and a region comprising a maximum local cell potential across the first electrically conductive layer and the second the first electrically conductive layer when an external bias is applied to first and the second bus bars of the electrochromic device.

In some embodiments, a method related to an electrochromic device described herein includes the following: determining an amount of charge transferred to the electrochromic device, as a function of time and current supplied to the electrochromic device; applying one of a variable voltage or a variable current to the electrochromic device to maintain a sense voltage, measured at one or more sense voltage pads of the electrochromic device, at a sense voltage limit, responsive to the sense voltage reaching the sense voltage limit, wherein the one or more sense voltage pads are distinct from voltage source bus bars of the electrochromic device; terminating the applying the variable voltage or the variable current to the electrochromic device, responsive to the determined amount of charge reaching a target amount of charge; reversing a polarity of a reversible constant current supply, wherein the reversible constant current supply applies a constant supply current with the reversed polarity to the electrochromic device; reversing a polarity of a reversible variable voltage supply, wherein the reversible variable voltage supply applies the variable voltage with the reversed polarity to the electrochromic device, and wherein the sense voltage limit is zero volts; and delaying the terminating for a predetermined amount of time during which the sense voltage is held at zero volts. For example, the electrochromic device can include two electrically conductive layers each comprising a gradient in electrical resistance, wherein the gradients in electrical resistance are configured to align the sense voltage pads and a region comprising a maximum local cell potential across the first electrically conductive layer and the second the first electrically conductive layer when an external bias is applied to first and the second bus bars of the electrochromic device.

In some embodiments, a method related to an electrochromic device described herein includes the following: determining an amount of charge transferred to the electrochromic device, as a function of time and current supplied to the electrochromic device; applying one of a variable voltage or a variable current to the electrochromic device to maintain a sense voltage at a sense voltage limit, responsive to the sense voltage reaching the sense voltage limit; and terminating the applying the variable voltage or the variable current to the electrochromic device, responsive to the determined amount of charge reaching a target amount of charge. For example, the electrochromic device can include two electrically conductive layers each comprising a gradient in electrical resistance, wherein the gradients in electrical resistance are configured to align sense voltage pads (used to measure the sense voltage) and a region comprising a maximum local cell potential across the first electrically conductive layer and the second the first electrically conductive layer when an external bias is applied to first and the second bus bars of the electrochromic device.

In some embodiments, a method related to an electrochromic device described herein includes the following: forming an electrochromic device with resistance gradients; applying a constant supply current to the electrochromic device using the first and second bus bars of the electrochromic device; determining an amount of charge transferred to the electrochromic device, as a function of time and current supplied to the electrochromic device; measuring a sense voltage using a first sense voltage pad of the electrochromic device; ceasing the applying the constant supply current, responsive to the sense voltage reaching a sense voltage limit; applying one of a variable voltage or a variable current to the electrochromic device using the bus bars to maintain the sense voltage at the sense voltage limit, responsive to the sense voltage reaching the sense voltage limit; and terminating the applying the variable voltage or the variable current to the electrochromic device, responsive to the determined amount of charge reaching a target amount of charge. The forming the electrochromic device can include: forming a first electrically conductive layer arranged on an inner surface of a first transparent substrate, wherein the first electrically conductive layer comprises a first gradient in resistance to the flow of electrical current through the first electrically conductive layer that varies as a function of position; forming a second electrically conductive layer arranged on an inner surface of a second transparent substrate, wherein the second electrically conductive layer comprises a second gradient in resistance to the flow of electrical current through the second electrically conductive layer that varies as a function of position; forming a first bus bar in contact with the first electrically conductive layer; forming a second bus bar in contact with the second electrically conductive layer; and forming a first sense voltage pad in contact with the first electrically conductive layer, wherein the first and second gradients in resistance are configured to align the first sense voltage pad and a region comprising a maximum local cell potential across the first electrically conductive layer and the second the first electrically conductive layer when an external bias is applied to first and the second bus bars of the electrochromic device.

In some embodiments, a method related to an electrochromic device described herein includes modeling resistance gradients of electrically conductive layers of the electrochromic device using a finite element model. The electrochromic device can include two bus bars, which can be parallel bus bars or other configurations of bus bars. The modeling can include: starting with initial resistance gradients of the electrically conductive layers comprising a gradient in an x-direction that is approximately perpendicular to the bus bars of the electrochromic device and no gradients in a y-direction that is perpendicular to the x-direction; defining a first region comprising a sense voltage pad; providing a target local cell potential map comprising a first local cell potential value across the active area of the electrochromic device, and a maximum local cell potential within the first region; using the finite element model to produce final resistance gradients of the electrically conductive layers to form a final local cell potential map, wherein the difference between the final local cell potential map and the target local cell potential map is minimized by the finite element model, and wherein the final resistance gradients comprise gradients in the x-direction and in the y-direction. The initial resistance gradients can be guesses that are analytically produced or produced using discrete numerical methods. For example, the initial resistance gradients can be based on a similar geometry that can be analytically calculated, such as using initial resistance gradients for a rectangular device to model a trapezoidal one. In some cases, the target local cell potential map can have a predetermined difference (or delta) in local cell potential between the target local cell potential value and the maximum local cell potential. Defining the first region in the above method can include defining a region of the device wherein a sense voltage pad will be positioned, for example, due to manufacturing, or other practical constraints.

In some cases, the above method can also include forming the resistance gradients of the electrically conductive layers of the electrochromic device. The electrically conductive layers of the above method can comprise a transparent conductive oxide material, and the forming the resistance gradients can comprise forming a scribe pattern using a laser. The electrically conductive layers of the above method can comprise a transparent conductive oxide material, and the forming the resistance gradients can comprise forming the electrically conductive layers with varying thicknesses. The electrically conductive layers of the above method can comprise a transparent conductive oxide material, and the forming the resistance gradients can comprise forming the electrically conductive layers with varying electrical properties. In some cases, the above method can include: forming the electrically conductive layers on two substrates; forming a first electrochromic layer on one of the electrically conductive layers; and coupling the two substrates together using an ion conducting layer such that the electrically conductive layers are facing one another and the two substrates are on the outside. In some cases, the above method can include forming a second electrochromic layer on the other electrically conductive layer before coupling the substrates together.

In some embodiments, the modeling described in the method above can include: starting with initial resistance gradients of the electrically conductive layers, for example, that are analytically produced, or are produced using discrete numerical methods, or that are provided as a lookup table. The initial resistance gradients can further include a gradient in an x-direction that is approximately perpendicular to the bus bars of the electrochromic device and no gradients in a y-direction that is perpendicular to the x-direction, or the initial resistance gradients can comprise gradients in both the x-direction and in the y-direction. The first region comprising the sense voltage pad can be a region wherein a maximum local cell potential can be formed. The target local cell potential map can include a range of local cell potentials across the active area of the electrochromic device, wherein the maximum local cell potential of the device is located within the first region. The difference between the final local cell potential map and the target local cell potential map can be minimized by the finite element model using conventional algorithms, such as those that seek to minimize a root mean square error (RMSE). The final resistance gradients comprise gradients in the x-direction and in the y-direction such that the first region comprises the maximum local cell potential.

### Electrochromic Device With Patterned Electrically Conductive Layer and Redox Elements

In some embodiments, an electrochromic (EC) device has one or more non-uniform electrically conductive layers, and a redox element, where the redox element sequesters charge from one or more layers comprising the electrochromic device. In some cases, the redox element sequesters charge to mitigate or prevent performance degradation of the electrochromic device resulting from faradaic losses. In some cases, the redox element sequesters charge to mitigate or prevent a decrease in the photopic ratio of the electrochromic device.

In some embodiments, the redox element is an active redox element, wherein the active redox element is electrically connected to one or more auxiliary electrodes, and sequesters charge from the other layers of the electrochromic device in response to a potential applied through the auxiliary electrode(s) coupled to auxiliary control circuitry. The auxiliary electrode(s) are electrically isolated from the electrically conductive layers, which apply potential to the anode(s) and cathode(s) of the EC device to switch the EC device from a more transmissive state to a less transmissive state, thereby allowing a sequestration potential to be applied independently from the potential between the anode and cathode of the EC device.

In different cases, the redox element can be located laterally adjacent to (i) the first electrically conductive layer, (ii) the first electrode layer, (iii) the ion conductor layer, (iv) the second electrode layer, and/or (v) the second electrically conductive layer.

In some cases, an electrochromic device has a redox element, and a first and second electrically conductive layer, and the device area is approximately quadrilateral, and one bus bar is connected to each of the two electrically conductive layers in such a way that they are oriented along two opposing edges of the quadrilateral device. The redox elements can also be positioned along one side of one or both substrates, on the opposite side from, or adjacent side to, or on the same side as the bus bars on one or both substrates. The redox elements can also be located on more than one edge of one or both substrates, and are located on sides opposite from, adjacent to, or the same side as bus bars on one or both substrates. There can also be more than 2 redox elements, which are located on 1, 2, 3 or 4 sides of the quadrilateral, and on one or both substrates. The redox elements can also form an “L” shape, and span 2 adjacent sides of the quadrilateral. There can also be 1, 2, or more than 2 redox elements configured in different combinations described herein. For example, there may be 2 redox elements in “L” shapes, where each spans 2 adjacent sides of the quadrilateral, and are located on different substrates, plus 2 redox elements located along a single side, each one sharing the substrate with an “L” shaped redox element.

The four sides of the quadrilateral of the first substrate can be designated sides A, B, C and D, where sides A and B meet at a vertex, sides B and C meet at a vertex, sides C and D meet at a vertex, and sides D and A meet at a vertex of the first substrate, and the four sides of the quadrilateral of the second substrate are designated sides A′, B′, C′ and D′, wherein sides A′ and B′ meet at a vertex, sides B′ and C′ meet at a vertex, sides C′ and D′ meet at a vertex, and sides D′ and A′ meet at a vertex of the second substrate. The two substrates can be joined to form an electrochromic device, and the two substrates rotated such that sides A and A′ are parallel and nearest to one another, sides B and B′ are parallel and nearest to one another, sides C and C′ are parallel and nearest to one another, and sides D and D′ are parallel and nearest to one another. In other words, one roughly rectangular substrate of the EC device ABCD has edges A, B, C and D, and a second roughly rectangular substrate of the EC device A′B′C′D′ has edges A′, B′, C′ and D′, and edges A and A′ are parallel and nearest and edges C and C′ are parallel and nearest when the two substrates are assembled into a device. In such cases, the first bus bar may be located along edge A of the first substrate, and the second bus bar may be located along edge C′ of the second substrate. There may also be one redox element located on side A, or B, or C, or D of the first substrate, or on side A′, or B′, or C′, or D′ of the second substrate. There may also be more than one redox element located on sides A, and/or B, and/or C, and/or D of the first substrate, and/or on sides A′, and/or B′, and/or C′, and/or D′ of the second substrate. There may also be more than 2 redox elements located on 1, 2, 3 or 4 sides of the quadrilateral, and on sides A, and/or B, and/or C, and/or D of the first substrate, and/or on sides A′, and/or B′, and/or C′, and/or D′ of the second substrate. The redox elements may also form an “L” shape, and span 2 adjacent sides of the quadrilateral, and be located on sides A and B, and/or B and C, and/or C and D, and/or D and A of the first substrate, and/or on sides A′ and B′, and/or B′ and C′, and/or C′ and D′, and/or D′ and A′ of the second substrate. There may also be 1, 2, or more than 2 redox elements configured in different combinations described herein. For example, there may be 2 redox elements in “L” shapes, where each spans 2 adjacent sides of the quadrilateral, and are located on different substrates (e.g., sides A and B, and/or B and C, and/or C and D, and/or D and A of the first substrate, and on sides A′ and B′, and/or B′ and C′, and/or C′ and D′, and/or D′ and A′ of the second substrate), plus 2 redox elements located along a single side, each one sharing the substrate with an “L” shaped redox element (e.g., side A, or B, or C, or D of the first substrate, and side A′, or B′, or C′, or D′ of the second substrate).

As described herein, the electrically conductive layers can be non-uniform to facilitate a more uniform cell potential and more uniform transmission across an electrochromic device as it switches (i.e., a reduced iris effect). In some embodiments, there is a potential drop along the electrically conductive layer as the distance between the bus bar and a point on the electrically conductive layer increases. In order for a potential to be applied to the redox element, it can be electrically isolated from the electrically conductive layer. In some cases, this isolation is achieved by a gap created between the electrically conductive layer and the redox element(s). In some cases, this gap is a laser scribed channel in the transparent conductive material making up the electrically conductive layer. In some embodiments, it can be advantageous for the redox elements to be located along the same edges as the bus bars, because the potential difference between any redox element location and the adjacent electrically conductive layer will be roughly constant along the edges.

Referring to the quadrilateral substrate definitions above, where one roughly rectangular substrate of the EC device ABCD has edges A, B, C and D, and a second roughly rectangular substrate of the EC device A′B′C′D′ has edges A′, B′, C′ and D′, and edges A and A′ are parallel and nearest and edges C and C′ are parallel and nearest when the two substrates are assembled into a device, in some embodiments, the first bus bar is located along edge A of the first substrate, the second bus bar is located along edge C′ of the second substrate, the electrically conductive layers are non-uniform, and the redox elements are located along edges A, C, A′ and/or C′. For example, in some embodiments, if the first bus bar is located along edge A of the first substrate, the second bus bar is located along edge C′ of the second substrate, the electrically conductive layers are non-uniform, and the redox element(s) are located along edges A and C, then the redox element(s) along edge A will have the same potential difference (between the redox element and the adjacent electrically conductive layer) all along edge A, and the redox element(s) along edge C will have the same potential difference (between the redox element and the adjacent electrically conductive layer) all along edge C. This is because in the cases where the electrically conductive layers are non-uniform to facilitate a more uniform cell potential and more uniform transmission across an electrochromic device as it switches, the equipotential lines in the electrically conductive layers are parallel to the bus bars (i.e., parallel to edges A and C). As a counter example, if the redox elements in this example were located along edge B, and a similar potential were applied between each of the redox elements and one of the bus bars, then the potential difference between the redox element(s) and the adjacent electrically conductive layer would be larger close to the bus bar (e.g., on edge B, closer to edge A), and smaller far from the bus bar (e.g., on edge B, nearer edge C).

In some embodiments, one or more portions of the electrode opposite the redox elements is electrically isolated from the bulk of the electrode. For example, one roughly rectangular substrate ABCD has edges A, B, C and D, and a second roughly rectangular substrate A′B′C′D′ has edges A′, B′, C′ and D′, and edges A and A′ are parallel and nearest and edges C and C′ are parallel and nearest when the two substrates are assembled into a device, the first bus bar is located along edge A of the first substrate, the second bus bar is located along edge C′ of the second substrate, the electrically conductive layers are non-uniform, the redox element(s) are located along edges A and C, and portion(s) of the electrode along edge A′(opposite the redox element(s) along edge A) are electrically isolated from the bulk of the electrode on the substrate ABCD, and portion(s) of the electrode along edge C′(opposite the redox element(s) along edge C) are electrically isolated from the bulk of the electrode on the substrate A′B′C′D′. In some cases, one or more portions of the electrode and electrically conductive layer opposite the redox elements is electrically isolated from the bulk of the electrode.

### Values of Resistance Gradients

In some embodiments, the sheet resistance profile on one or both electrically conductive layers varies approximately from 1 Ohms/square to 10000 Ohms/square, or from 10 Ohms/square to 2000 Ohms/square, or from 1 Ohms/square to 5000 Ohms/square, or from 10 Ohms/square to 10000 Ohms/square, or from 10 Ohms/square to 5000 Ohms/square, or from 1 Ohms/square to 1000 Ohms/square, or from 10 Ohms/square to 1000 Ohms/square, or from 8 Ohms/square to 16000 Ohms/square, or from 1 Ohms/square to 20000 Ohms/square.

In some embodiments, the average ratio of rₚₐₜₜₑᵣₙ(x)/rₗᵢₙₑₐᵣ(x) in the first electrically conductive layer is at least about 1.1, or at least about 1.25, or at least about 1.5, or at least about 2, or at least about 3, or at least about 5, or at least about 10, or at least about 50, or at least about 100, or at least about 300, or from about 1.1 to about 1.25, or from about 1.1 to about 2, or from about 1.1 to about 3, or from about 1.1 to about 5, or from about 1.1 to about 10, or from about 1.1 to about 20, or from about 1.1 to about 30, or from about 1.1 to about 50, or from about 1.1 to about 100, or from about 1.1 to about 300.

In some embodiments, the average ratio of rₚₐₜₜₑᵣₙ(x)/rₗᵢₙₑₐᵣ(x) in the second electrically conductive layer is at least about 1.1, or at least about 1.25, or at least about 1.5, or at least about 2, or at least about 3, or at least about 5, or at least about 10, or at least about 50, or at least about 100, or at least about 300, or from about 1.1 to about 1.25, or from about 1.1 to about 2, or from about 1.1 to about 3, or from about 1.1 to about 5, or from about 1.1 to about 10, or from about 1.1 to about 20, or from about 1.1 to about 30, or from about 1.1 to about 50, or from about 1.1 to about 100, or from about 1.1 to about 300.

In some embodiments, the average ratio of rₚₐₜₜₑᵣₙ(x)/rₗᵢₙₑₐᵣ(x) in the first electrically conductive layer is at least about 1.1 or at least about 1.25, or at least about 1.5, or at least about 2, or at least about 3, or at least about 5, or at least about 10, or at least about 50, or at least about 100, or at least about 300, or from about 1.1 to about 1.25, or from about 1.1 to about 2, or from about 1.1 to about 3, or from about 1.1 to about 5, or from about 1.1 to about 10, or from about 1.1 to about 20, or from about 1.1 to about 30, or from about 1.1 to about 50, or from about 1.1 to about 100, or from about 1.1 to about 300, and the average ratio of rₚₐₜₜₑᵣₙ(x)/rₗᵢₙₑₐᵣ(x) in the second electrically conductive layer is at least about 1.1, or at least about 1.25, or at least about 1.5, or at least about 2, or at least about 3, or at least about 5, or at least about 10, or at least about 50, or at least about 100, or at least about 300, or from about 1.1 to about 1.25, or from about 1.1 to about 2, or from about 1.1 to about 3, or from about 1.1 to about 5, or from about 1.1 to about 10, or from about 1.1 to about 20, or from about 1.1 to about 30, or from about 1.1 to about 50, or from about 1.1 to about 100, or from about 1.1 to about 300.

In some embodiments, the average Δrₚ₋₁ (x) in the first and/or second electrically conductive layer per unit width of the device is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m. In some embodiments, Δrₚ₋₁ (x) in the first electrically conductive layer generally increases as the distance from the bus bar increases. In some embodiments, Δrₚ₋₁ (x) in the first electrically conductive layer increases hyperbolically as the distance from the bus bar increases.

In some embodiments, the average rₙ in the first and/or electrically conductive layer per unit width of the device at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m.

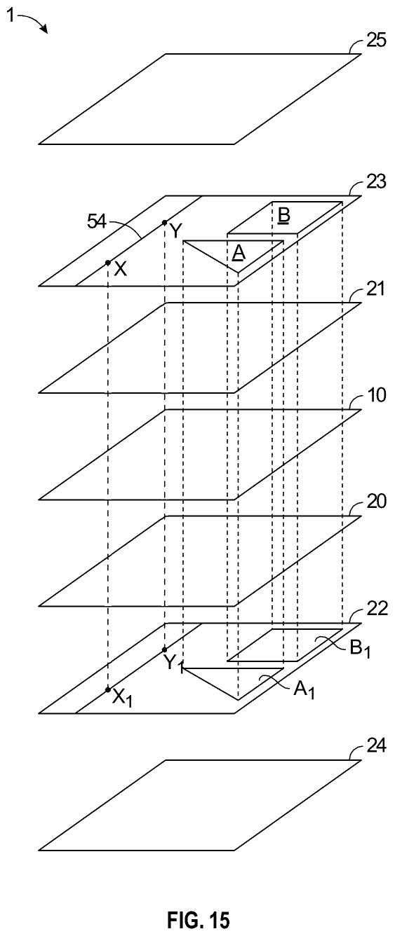

In one embodiment, with the electrochromic device geometry of FIG. 15, the non-linearity in the Δrₚ₋₁ (x) of the first and/or second electrically conductive layer may be observed by comparing the ratio of the average Δrₚ₋₁(x) in two different regions of the first and/or second electrically conductive layer, wherein the first and second regions are each mutually exclusive regions of a single line oriented in the x-direction, and each region comprises at least 25% of the x-dimensional length of the first and/or second electrically conductive layer. For example, in one such embodiment, the ratio of the average Δrₚ₋₁ (x) in a first region of the first and/or second electrically conductive layer, Δr^{avg1}ₚ₋₁, to the average Δrₚ₋₁ (x) in a second region of the first and/or second electrically conductive layer, Δr^{avg2}ₚ₋₁, is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m, wherein the first and second region are each mutually exclusive regions of a single line oriented in the x-direction, and each region comprises at least 25% of the x-dimensional length of the first and/or second electrically conductive layer.

In one embodiment, the non-linearity in the resistance of the first and/or second electrically conductive layer may be observed by comparing the average ratio φ(x)=rₚₐₜₜₑᵣₙ(x)/rₗᵢₙₑₐᵣ(x) in two mutually exclusive regions of the first and/or second electrically conductive layer wherein the first and second regions are each circumscribed by a convex polygon and each comprises at least 25% of the surface area of the electrically conductive layer. For example, in one such embodiment, the average φ(x) in a first region of the first and/or second electrically conductive layer, φ^{avg1}(x), to the average φ(x) in a second region of the first and/or second electrically conductive layer, φ^{avg2}(x), is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m, wherein each of the first and second regions is circumscribed by a mutually exclusive convex polygon, and each comprises at least 25% of the surface area of the electrically conductive layer. This may be illustrated by reference to FIG. 15. First electrically conductive layer 22 comprises convex polygon A₁ and convex polygon B₁ and each circumscribes a mutually exclusive region comprising at least 25% of the surface area of the electrically conductive layer 22; in one embodiment, the ratio of the average in a first region of the first electrically conductive layer bounded by convex polygon A₁, φ^{avg1}(x), to the average in a second region of the first electrically conductive layer bounded by convex polygon B₁, φ^{avg2}(x), is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m. As illustrated, convex polygon A₁ is a triangle and convex polygon B₁ is a square merely for purposes of exemplification; in practice, the first region may be bounded by any convex polygon and the second region may be bounded by any convex polygon.

In one embodiment, the non-linearity in the resistance of the first and/or second electrically conductive layer may be observed by comparing the average Δrₚ₋₁(x) in two mutually exclusive regions of the first and/or second electrically conductive layer wherein the first and second regions are each circumscribed by a convex polygon and each comprises at least 25% of the surface area of the electrically conductive layer. For example, in one such embodiment, the average Δrₚ₋₁(x) in a first region of the first and/or second electrically conductive layer, Δr^{avg1}ₚ₋₁, to the average Δrₚ₋₁ (x) in a second region of the first and/or second electrically conductive layer, Δr^{avg2}ₚ₋₁, is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m, wherein each of the first and second regions is circumscribed by a mutually exclusive convex polygon, and each comprises at least 25% of the surface area of the electrically conductive layer. This may be illustrated by reference to FIG. 15. First electrically conductive layer 22 comprises convex polygon A₁ and convex polygon B₁ and each circumscribes a mutually exclusive region comprising at least 25% of the surface area of the electrically conductive layer 22; in one embodiment, the ratio of the average in a first region of the first electrically conductive layer bounded by convex polygon A₁, Δr^{avg1}ₚ₋₁(x), to the average in a second region of the first electrically conductive layer bounded by convex polygon B₁, Δr^{avg2}ₚ₋₁(x), is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m. As illustrated, convex polygon A₁ is a triangle and convex polygon B₁ is a square merely for purposes of exemplification; in practice, the first region may be bounded by any convex polygon and the second region may be bounded by any convex polygon.

In one embodiment, the non-linearity in the resistance of the first and/or second electrically conductive layer may be observed by comparing the average rₙ in two mutually exclusive regions of the first and/or second electrically conductive layer wherein the first and second regions are each circumscribed by a convex polygon and each comprises at least 25% of the surface area of the electrically conductive layer. For example, in one such embodiment, the average rₙ in a first region of the first and/or second electrically conductive layer, r^{avg1}ₙ, to the average rₙ in a second region of the first and/or second electrically conductive layer, r^{avg2}ₙ, is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m, wherein each of the first and second regions is circumscribed by a mutually exclusive convex polygon, and each comprises at least 25% of the surface area of the electrically conductive layer. This may be illustrated by reference to FIG. 15. First electrically conductive layer 22 comprises convex polygon A₁ and convex polygon B₁ and each circumscribes a mutually exclusive region comprising at least 25% of the surface area of the electrically conductive layer 22; in one embodiment, the ratio of the average in a first region of the first electrically conductive layer bounded by convex polygon A₁, r^{avg1}ₙ, to the average in a second region of the first electrically conductive layer bounded by convex polygon B₁, r^{avg2}ₙ, is at least 0.1 Ohm-m, or at least 0.3 Ohm-m, or at least 1 Ohm-m, or at least 3 Ohm-m, or at least 10 Ohm-m, or at least 30 Ohm-m, or at least about 100 Ohm-m, or from about 0.1 to about 0.3 Ohm-m, or from about 0.1 to about 1 Ohm-m, or from about 0.1 to about 3 Ohm-m, or from about 0.1 to about 10 Ohm-m, or from about 0.1 to about 30 Ohm-m, or from about 0.1 to about 100 Ohm-m. As illustrated, convex polygon A₁ is a triangle and convex polygon B₁ is a square merely for purposes of exemplification; in practice, the first region may be bounded by any convex polygon and the second region may be bounded by any convex polygon.

Referring again to FIG. 15, the spatial non-uniformity and non-linearity of the resistance of the first and second electrically conductive layer may be correlated in accordance with some embodiments. For example, line segment X₁-Y₁ in first electrically conductive layer 22 may be projected through second electrode layer 21, ion conductor layer 10 and first electrode layer 20 and onto second electrically conductive layer 23, with the projection defining line segment X-Y. In general, if the resistance between the bus bar and a location along line segment X₁-Y₁ is non-linear and generally increases in first electrically conductive layer 22 (i.e., the resistance generally increases non-linearly moving along the resistance gradient curve in the direction from point x₁ to point Y₁), the resistance between the bus bar and a location along segment X-Y generally decreases in second electrically conductive layer 23 (i.e., the resistance generally decreases non-linearly along the resistance gradient curve 54 in the direction from point X to point Y). Line segments X-Y and X₁-Y₁ can have a minimum length of at least 1 cm, or in the case of a rectangular substrate the line segments can be at least 25% of the total length or width of the substrate. For example, line segments X-Y and X₁-Y₁ may have a length of 2.5 cm, 5 cm, 10 cm, or 25 cm. Additionally, line segments X-Y and X₁-Y₁ may be straight or curved. In one embodiment, for example, the resistance gradients in electrically conductive layers 22, 23 are non-zero constants and are of opposite sign (e.g., the resistance generally increases non-linearly in first electrically conductive layer along in the direction from point X₁ to point Y₁ and generally decreases non-linearly along sheet resistance gradient curve 54 in the direction from point X to point Y). By way of further example, in one embodiment, substrates 24, 25 are rectangular and the resistance gradients in electrically conductive layers 22, 23 are non-zero constants and are of opposite sign (e.g., the sheet resistance generally increases non-linearly in second electrically conductive layer 23 along gradient 54 in the direction from point X to point Y and generally decreases non-linearly in first electrically conductive layer 22 along the line containing line segment X₁-Y₁ in the direction from point X₁ to point Y₁).

### EXAMPLES

The following non-limiting examples are provided to further illustrate the present disclosure. It should be appreciated by those of skill in the art that the techniques disclosed in the examples that follow represent approaches the inventors have found function well in the practice of the disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the disclosure.

### Example 1

Patterned Electrically Conductive Layer with a Hyperbolic Resistance Profile

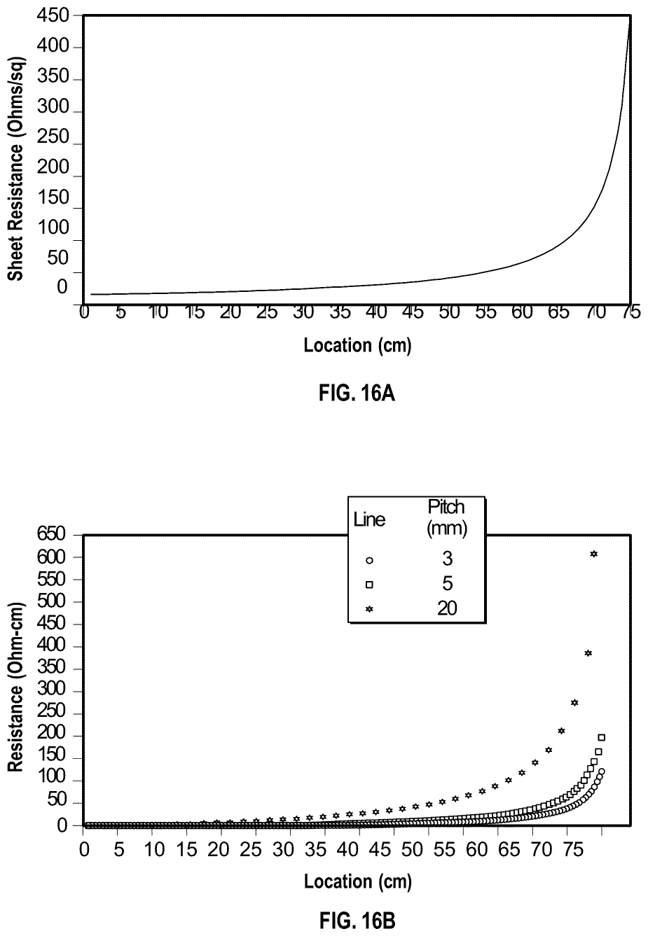

FIG. 16A shows the sheet resistance profile along a resistance gradient line for a rectangular electrically conductive layer with a geometry similar that shown in FIGS. 2, 3A and 3B. The device in this example was approximately 75 cm long, and 130 cm wide. The bus bar was located at x=0, and with width (W) is 130 cm. In this example, the electrically conductive layer was patterned to approximate the sheet resistance profile shown in FIG. 16A. The desired sheet resistance varied from approximately 15 Ohm/sq. near the bus bar to approximately 450 Ohm/sq. at the opposite end of the layer.

FIG. 16B shows the resistance of sets of scribed lines that approximated the sheet resistance profile shown in FIG. 16A. The sets of scribed lines were oriented parallel to the bus bar (i.e., along isoresistance lines perpendicular to the resistance gradient lines) as shown in FIG. 4. In this example the resistance of each set of scribed lines is plotted for three different pitch scenarios (i.e., 307 in FIG. 4) equal to 3, 5 and 20 mm. In other cases, the pitch can be from 1 mm to 10 mm, or 2.5 mm. As described above, rₙ is defined as the resistance added by the set of scribed lines. The discrete points plotted in FIG. 16B indicate the resistance of the sets of scribed lines (i.e., rₙ as described above) to the flow of electrons in the x direction per centimeter (cm) of width (W, as described above). In other words, the discrete points plotted in FIG. 16B indicate the resistance of the sets of scribed lines (i.e., rₙ as described above) to the flow of electrons in the x direction if the substrate were 1 cm wide (i.e., W=1 cm). For the case of the 3 mm pitch, the resistance per cm width of the set of scribed lines in the x direction varied from approximately 0 Ohm-cm to approximately 120 Ohm-cm. For the case of the 5 mm pitch, the resistance per cm width of the set of scribed lines in the x direction varied from 0 Ohm-cm to 200 Ohm-cm. For the case of the 20 mm pitch, the resistance per cm width of the set of scribed lines in the x direction varied from 0 Ohm-cm to 615 Ohm-cm. When the pitch between sets of scribed lines (i.e., 307 in FIG. 4) was smaller there were more scribes total on the substrate, and therefore the resistance of each of the scribes (i.e., In) was smaller because each scribe was required to add less resistance to match the desired profile shown in FIG. 16A. The values plotted in FIG. 16B are the resistances per cm of the width of the layer, and therefore need to be divided by 130 to give the absolute rₙ values (in Ohms) for the 130 cm wide substrate in this example.

### Example 2

Patterned Electrically Conductive Layers with Opposing Hyperbolic Resistance Profiles

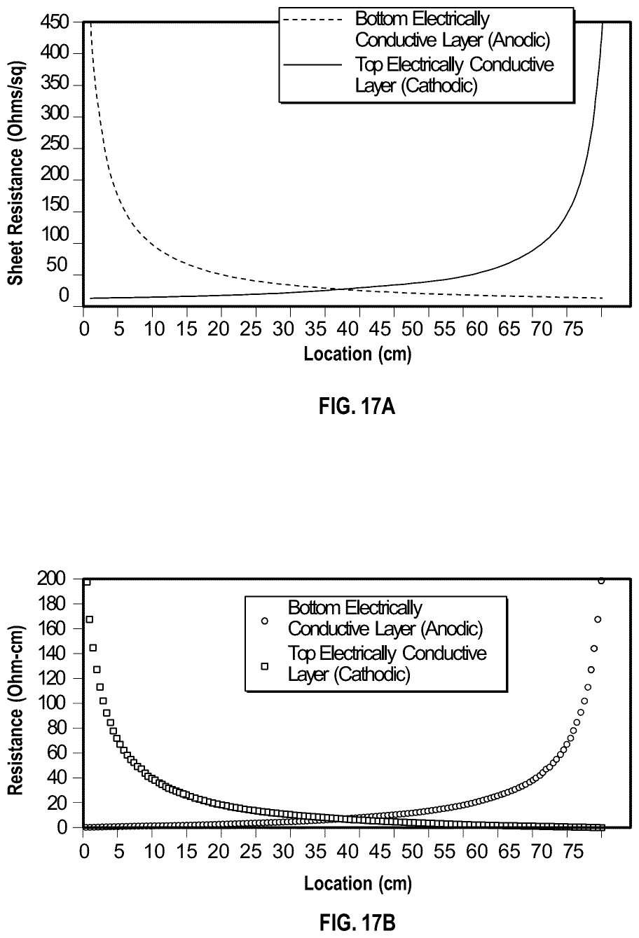

FIG. 17A shows the sheet resistance profile along resistance gradient lines for both substrates in the simple geometry described in FIG. 3A. The device in this example was approximately 75 cm long, and 130 cm wide. The bus bar on the top electrically conductive layer (the cathode in this case) was at x=0 cm, and the bus bar on the bottom electrically conductive layer (the anode in this case) was at approximately x=75 cm. The width (W) of both substrates and electrically conductive layers was 130 cm. In this example, both electrically conductive layers were patterned to approximate the sheet resistance profiles shown in FIG. 17A. The desired sheet resistance varied from approximately 15 Ohm/sq. to approximately 450 Ohm/sq.

The sheet resistance profiles in this example followed the form of R(x)=1/[a*(xₜ−x)] then R′(x)=1/(a*x), in order to satisfy the relationship between the sheet resistance profiles of the two substrates R′(x)=R(x)*(xₜ/x−1) (as discussed herein). As discussed herein, this relationship enables the device to have a more uniform potential between the two electrically conductive layers over the whole area of the device, even though the bus bars are located at the edges.

FIG. 17B shows the resistance of sets of scribed lines that approximated the sheet resistance profiles shown in FIG. 17A. The sets of scribed lines on both substrates were oriented parallel to the bus bar (i.e., along isoresistance lines perpendicular to the resistance gradient lines) as shown in FIG. 4. In this example the pitch (i.e., 307 in FIG. 4) between sets of scribed lines was 5 mm. The discrete points plotted in FIG. 17B indicate the resistance of the sets of scribed lines (i.e., rₙ as described above) to the flow of electrons in the x direction per cm width of the substrate (i.e., the resistance if the substrate were 1 cm wide, W=1 cm). The resistance per cm of width of the set of scribed lines in the x direction varied from approximately 0 Ohm-cm to approximately 200 Ohm-cm. The values plotted in FIG. 17B are the resistances per cm width of the layer, and therefore need to be divided by 130 to give the absolute rₙ values (in Ohms) for the 130 cm wide substrates in this example.

### Example 3

Electrochromic Device with Patterned Electrically Conductive Layers

The transmission of an electrochromic device with uniform electrically conductive layers as a function of time while switching from a bleached state to a dark state will have an iris effect, where the switching rate at the center and the edge of the device will be different. The uniform device in this example was approximately 75 cm long, and 130 cm wide, and the bus bar on the top electrically conductive layer (the cathode in this case) is at x=0 cm, and the bus bar on the bottom electrically conductive layer (the anode in this case) was at approximately x=75 cm. The width (W) of both substrates and electrically conductive layers was 130 cm.

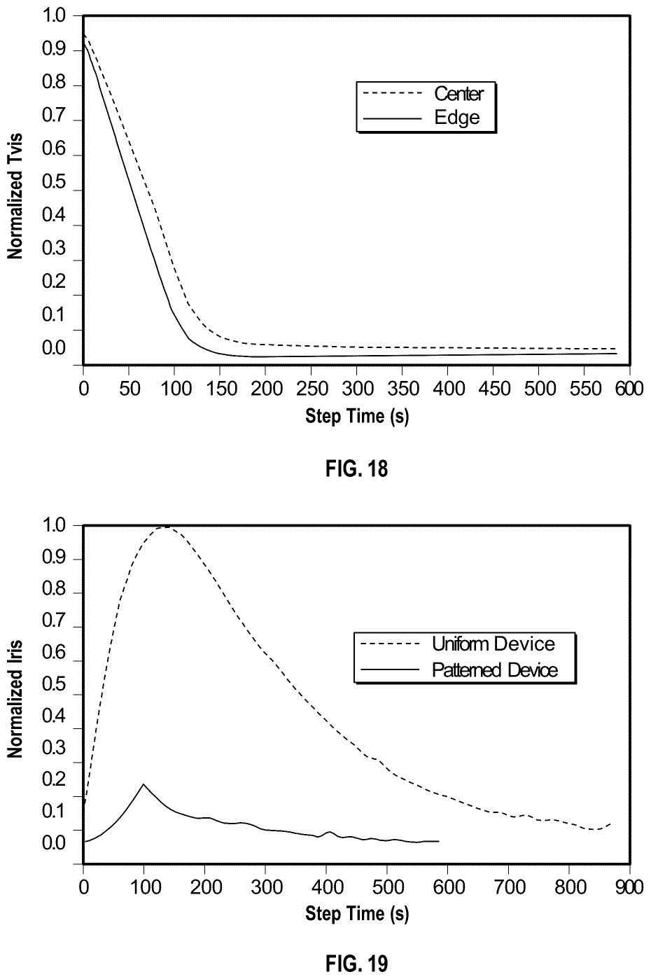

FIG. 18 shows the transmission of an electrochromic device incorporating the patterned electrically conductive layers shown in Example 2 (with resistances of sets of scribed lines described in FIG. 14B) as a function of time while switching from a bleached state to a dark state. The patterned device in this example was also approximately 75 cm long, and 130 cm wide. The bus bar on the top electrically conductive layer (the cathode in this case) was at x=0 cm, and the bus bar on the bottom electrically conductive layer (the anode in this case) was at approximately x=75 cm. The width (W) of both substrates and electrically conductive layers was 130 cm. The transmission of the device is shown at two different locations, one close to the center of the device and one approximately 2 cm from the edge of the device near one of the bus bars, over time. The lighter line is the transmission of the device close to the center, and the darker line is the transmission of the device close to the edge. The trigger for the device to start switching is at a “StepTime” of approximately 0 s. The transmission in FIG. 18 is normalized to transmission at the center of the device in the fully bleached state. The transmission of the device close to the edge switches from the bleached state to a dark state of less than 10% transmission in approximately 120 s. The transmission of the device close to the center switches from the bleached state to a dark state of less than 10% transmission in approximately 140 s.

FIG. 19 shows the difference in transmission near the edge of the device subtracted from the transmission near the center of the device for the uniform and patterned electrochromic devices described in this example. The difference in transmission from center to edge normalized to the maximum difference in the uniform case is referred to as the “normalized iris” in the figure. The data in FIG. 19 shows that the patterned device had much better optical uniformity than the uniform device during switching. At the peak of center to edge non-uniformity in the uniform case (i.e., about 150 s after triggering a switch from bleached to dark) the patterned device had less than 20% of the normalized iris compared to the uniform case.

### Example 4

Electrochromic Device with Patterned Electrically Conductive Layers

The transmission of an electrochromic device with uniform electrically conductive layers as a function of time while switching from a bleached state to a dark state will have an iris effect, where the switching rate at the center and the edge of the device will be different. The uniform device in this example was approximately 75 cm long, and 130 cm wide, and the bus bar on the top electrically conductive layer (the cathode in this case) was at x=0 cm, and the bus bar on the bottom electrically conductive layer (the anode in this case) was at approximately x=75 cm. The width (W) of both substrates and electrically conductive layers was 130 cm.

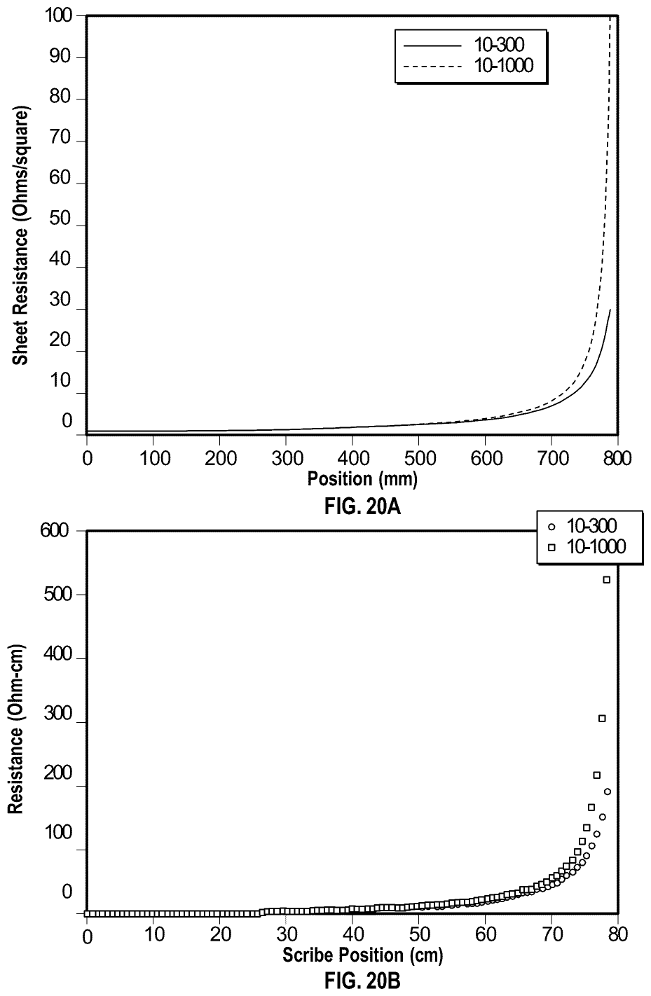

The patterned electrochromic devices incorporate patterned electrically conductive layers similar to those shown in Example 2. One of the patterned devices had patterned electrically conductive layers that approximate hyperbolic sheet resistance profiles from approximately 10 Ohms/sq. to approximately 300 Ohms/sq., and the other patterned device had patterned electrically conductive layers that approximate hyperbolic sheet resistance profiles from approximately 10 Ohms/sq. to approximately 1000 Ohms/sq. The patterned devices in this example were also approximately 75 cm in length, and 130 cm in width. The bus bar on the top electrically conductive layer (the cathode in this case) was at x=0 cm (along the length), and the bus bar on the bottom electrically conductive layer (the anode in this case) was at approximately X=75 cm (along the length). The width (W) of both substrates and electrically conductive layers was 130 cm. The 10-300 Ohm/sq. devices in this example, had the electrically conductive layer on the top substrate (cathodic) patterned to approximate the “10-300” sheet resistance profile shown in FIG. 20A, where the “Position (mm)” is along the length of the device. The 10-1000 Ohm/sq. devices in this example, had the electrically conductive layer on the top substrate (cathodic) patterned to approximate the “10-1000” sheet resistance profiles shown in FIG. 20A, where the “Position (mm)” is along the length of the device. The bottom electrically conductive layers (anodic) were also patterned to approximate the same sheet resistance profiles shown in FIG. 20A, with the x-axis inverted (similarly to those shown in FIGS. 17A and 17B). FIG. 20B shows the resistance of sets of scribed lines for the 10-300 Ohm/sq. and 10-1000 Ohm/sq. devices that approximated the sheet resistance profiles shown in FIG. 20A. Again, the discrete points plotted in FIG. 20B indicate the resistance of the sets of scribed lines (i.e., In as described above) to the flow of electrons in the x direction per cm width of the substrate (i.e., the resistance if the substrate were 1 cm wide, W=1 cm). The resistance per cm of width of the set of scribed lines in the x direction varied from approximately 0 Ohm-cm to approximately 200 Ohm-cm or 500 Ohm-cm. The values plotted in FIG. 20B are the resistances per cm width of the layer, and therefore need to be divided by 130 to give the absolute rₙ values (in Ohms) for the 130 cm wide substrates in this example.

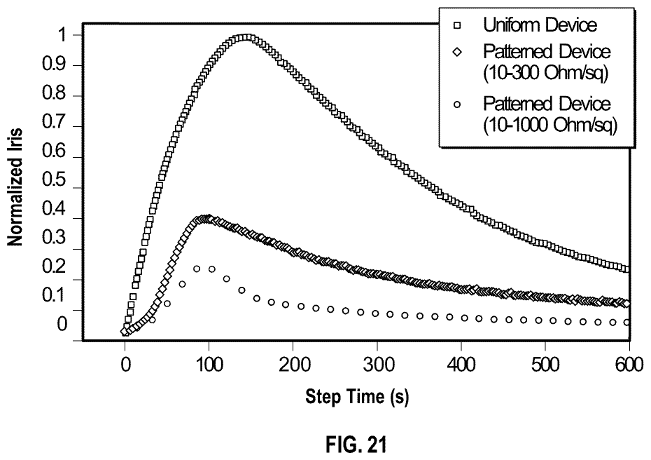

FIG. 21 shows the difference in transmission near the edge of the device subtracted from the transmission near the center of the device for the uniform and two different patterned electrochromic devices. The difference in transmission from center to edge normalized to the maximum difference in the uniform case is referred to as the “normalized iris” in the figure. The data in FIG. 21 shows that the patterned devices had improved optical uniformity compared to the uniform device during switching. At the peak of center to edge non-uniformity in the uniform case (i.e., about 100 s after triggering a switch from bleached to dark) the patterned device approximating the 10-300 Ohms/sq. sheet resistance profiles had approximately 40% of the normalized iris compared to the uniform case. At the peak of center to edge non-uniformity in the uniform case (i.e., about 100 s after triggering a switch from bleached to dark) the patterned device approximating the 10-1000 Ohms/sq. sheet resistance profiles had approximately 25% of the normalized iris compared to the uniform case.

### Example 5

Electrochromic Device with Visually Perceptible Patterns

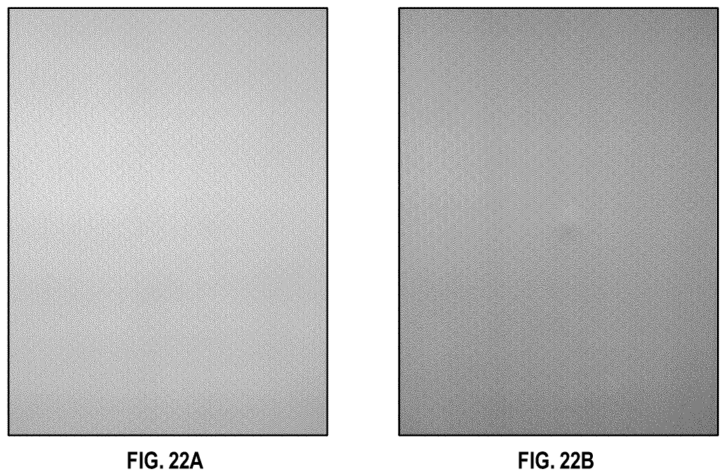

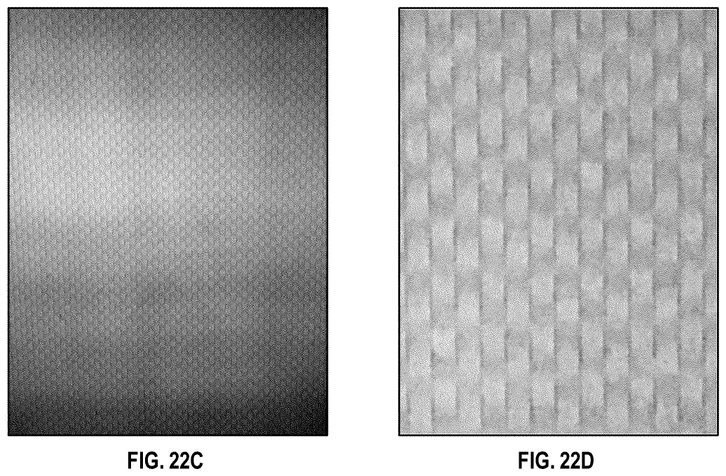

FIGS. 22A-22D show images of an electrochromic device that displayed visually perceptible patterns during switching. The electrochromic device in this example was a patterned electrochromic device incorporating patterned electrically conductive layers similar to those shown in Example 2. The device in this example had patterned electrically conductive layers that approximated hyperbolic sheet resistance profiles from approximately 10 Ohms/sq. to approximately 1000 Ohms/sq. The 10-1000 Ohm/sq. device in this example, had the electrically conductive layer on the top substrate (cathodic) patterned to approximate the “10-1000” sheet resistance profile shown in FIG. 20A, where the “Position (mm)” is along the length of the device. The bottom electrically conductive layers (anodic) were also patterned to approximate the same sheet resistance profiles shown in FIG. 20A, with the x-axis inverted (similarly to those shown in FIGS. 17A and 17B). FIG. 20B shows the resistance of sets of scribed lines for the 10-1000 Ohm/sq. device that approximated the sheet resistance profiles shown in FIG. 20A. Additionally, the device described in this Example had a period offset (e.g., element 309 in FIG. 11B) equal to approximately half of the period (e.g., element 305 in FIG. 11B).

FIG. 22A shows an image (optical photograph) of the device during bleaching (i.e., from a less transmissive state to a more transmissive state), illustrating that the device had different optical transmission at different locations during bleaching. FIG. 22B shows an image (optical photograph) of the device during darkening (i.e., from a more transmissive state to a less transmissive state), illustrating that the device had different optical transmission at different locations during darkening. FIG. 22C is the same image as FIG. 22A, with the contrast increased to accentuate the pattern. FIG. 22D is a zoomed in area of FIG. 22C. The visually perceptible patterns in the device in this Example were approximately periodic, and could be described as a honeycomb or a checkerboard pattern.

### Example 6

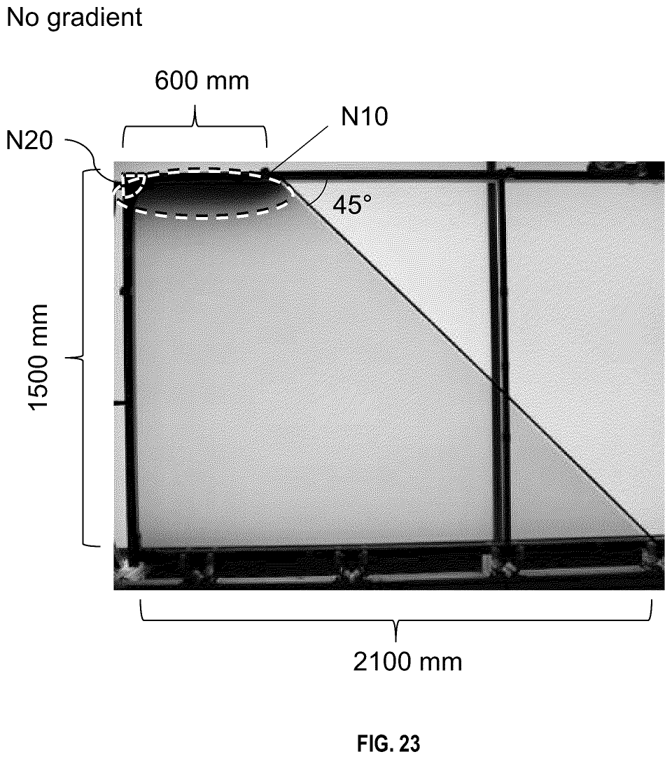

FIG. 23 shows an example of a non-rectangular electrochromic device 120 s after it has started switching from bleached to dark. The device has a right trapezoidal shape with an approximately 45° angle, with a 2100 mm long side, a 600 mm short side, and a height of approximately 1500 mm, as shown in FIG. 23. The electrically conductive layers in the device in this Example were TCO materials with a sheet resistance of approximately 10 Ohm/sq. The device in this example has no gradient in resistance in the electrically conductive layers, and a large non-uniformity in switching can be seen after 120 s, namely where the device has switched more quickly (is darker) near the short edge of the trapezoid in region N10. Region N20 is a region including the sense voltage pad.

The device was driven using a sense voltage measured using the sense voltage pad, as described herein. Specifically, a constant voltage and current were applied until a sense voltage (measured using a sense voltage pad) reached a predetermined threshold (or sense voltage limit) of 1.5 V. Then, a variable voltage and current were applied to maintain the sense voltage at or below the predetermined threshold.

### Example 7

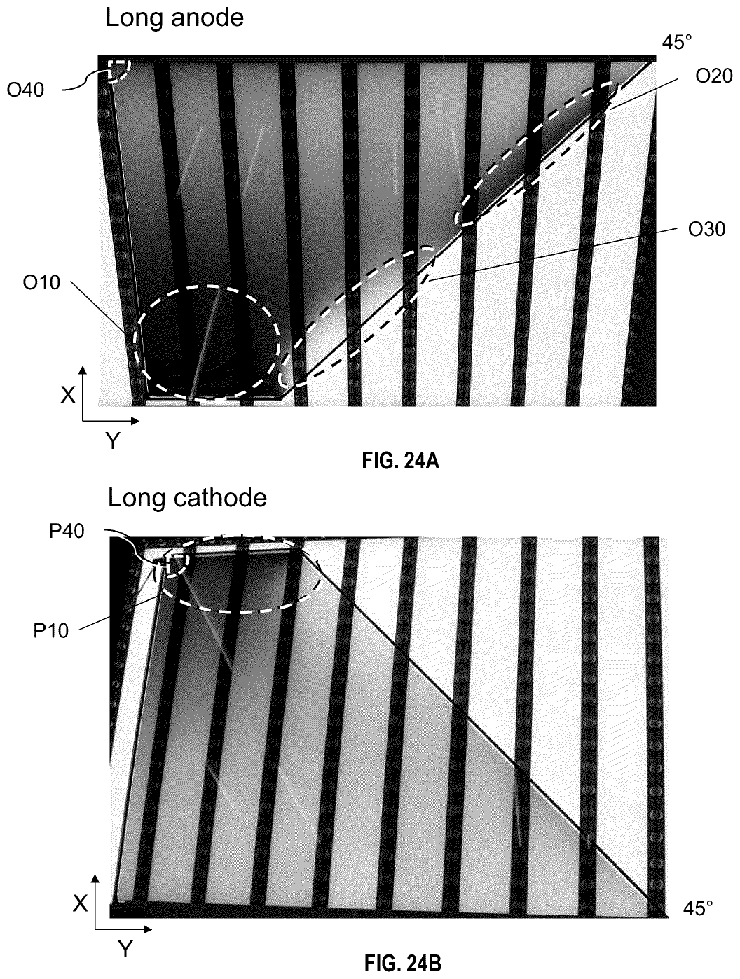

FIGS. 24A and 24B show examples of electrochromic devices 120 s after they have started switching from bleached to dark. The devices in this example have gradients in resistance in the electrically conductive layers that vary in the x-direction but that are constant in the y-direction. The resistance gradients in this Example were formed using scribe lines in the electrically conductive layers, which included TCO materials with a sheet resistance of approximately 10 Ohm/sq (before scribing). Some non-uniformity in switching can be seen after 120 s. For example, the devices have switched more quickly (are darker) near the short edge of the trapezoid in regions O10 and P10. Device in FIG. 24A has a longer anode bus bar than the cathode bus bar, and also shows prevalent non-uniformities along the diagonal edge, in regions O20 and O30. The device in FIG. 24B has a longer cathode bus bar than anode bus bar. Regions O40 and P40 are regions including the sense voltage pad.

The devices in this Example had similar dimensions to, and were driven using the same drive method as, those described with respect to Example 6.

### Example 8

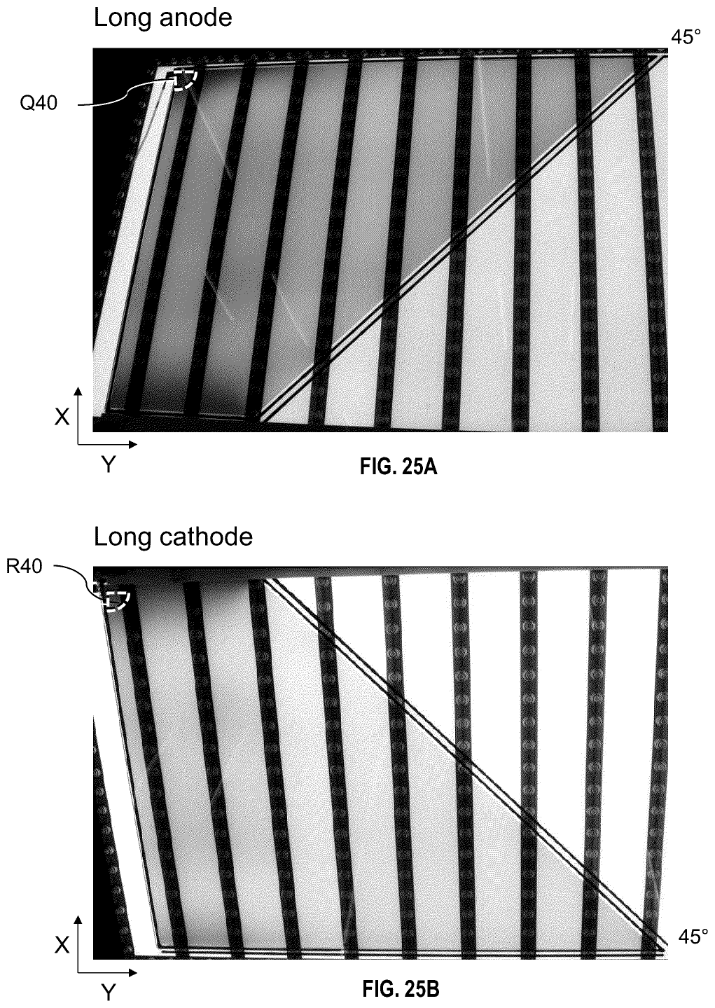

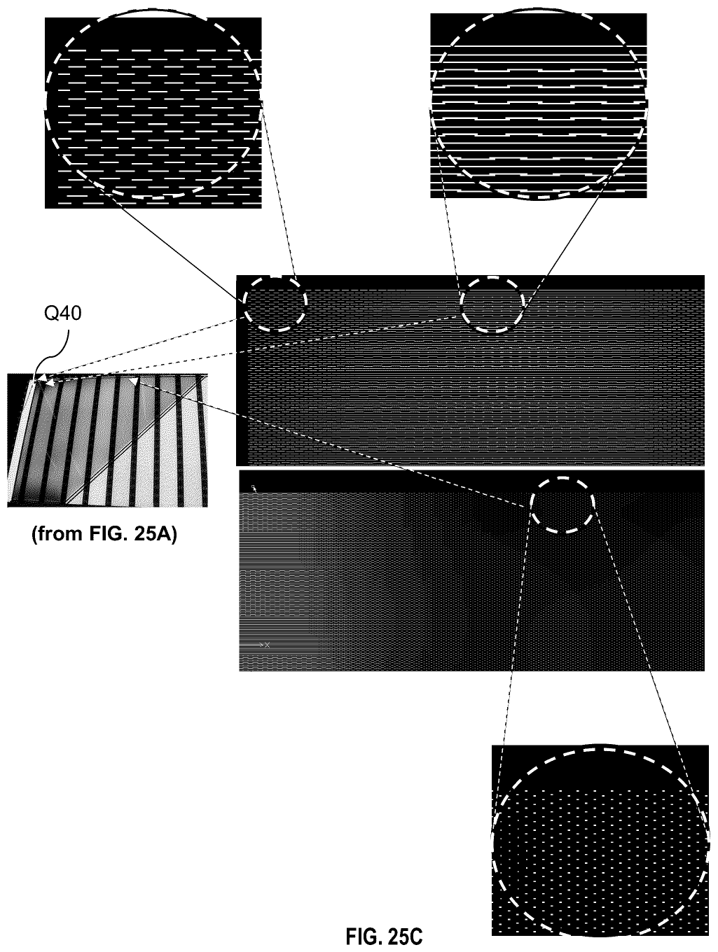

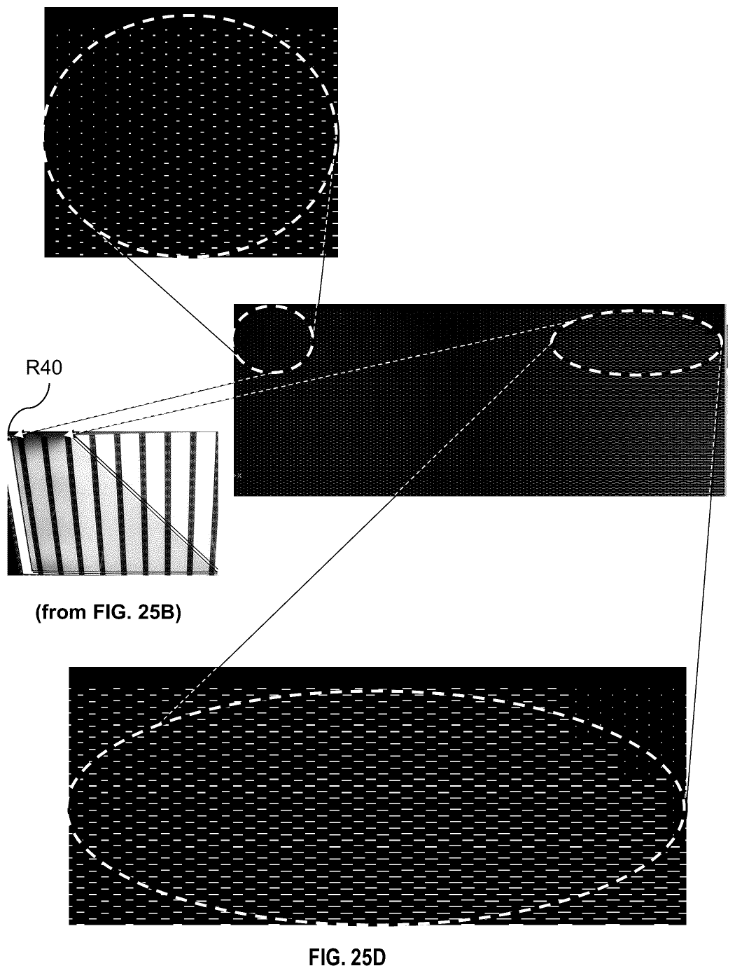

FIGS. 25A and 25B show examples of electrochromic devices 120 s after they have started switching from bleached to dark. The devices in this example have gradients in resistance in the electrically conductive layers that vary in both the x-direction and the y-direction. The resistance gradients in this Example were formed using scribe lines in the electrically conductive layers, which included TCO materials with a sheet resistance of approximately 10 Ohm/sq (before scribing). These devices are substantially more uniform during switching than the devices in Examples 6 and 7. However, some non-uniformity in switching can be seen after 120 s, for example where the device has switched more quickly (is darker) near the short edge of the trapezoid. The device in FIG. 25A has a longer anode bus bar than the cathode bus bar, while the device in FIG. 25B has a longer cathode bus bar than anode bus bar. The devices in this Example had similar dimensions to, and were driven using the same drive method as, those described with respect to Example 6.

The resistance gradients in the electrically conductive layers in the devices in Example 8 were also configured to form a region of maximum local cell potential (or, voltage drop), and the sense voltage pad was aligned to the region of maximum local cell potential. Therefore, the devices in FIGS. 25A and R may be less prone to damage than those in FIGS. 23, 24A and 24B. Regions Q40 and R40 are regions including the sense voltage pad, and that also include the maximum local cell potential (formed by the resistance gradients).

The resistance gradients in the electrically conductive layers in the devices in Example 8 were formed using sets of scribed lines parallel to the bus bars. FIGS. 25C and 25D show examples of regions of the scribe patterns that show how they were varied in the x- and y-directions to form resistance gradients and a region of maximum voltage. In this example, the length of the scribe segment (e.g., 304x in FIGS. 5, 8, 13A and 13B) was varied in both the x-direction and the y-direction to achieve the gradient in sheet resistance in the electrically conductive layers of the device. For example, FIG. 25C shows that the scribe segments have a first length near the right-angle corner of the long bus bar edge of the trapezoid, the scribe segments have a longer length near the right-angle corner of the long bus bar edge of the trapezoid, and the scribe segments have a shorter length even farther from the right-angle corner of the long bus bar edge of the trapezoid. FIG. 25D shows that the scribe segments have a first length near the right-angle corner of the short bus bar edge of the trapezoid, and the scribe segments have a longer length near the obtuse-angle corner of the short bus bar edge of the trapezoid. FIG. 25D also shows that the scribe segments have a first length near the bus bar near the obtuse-angle corner of the short bus bar edge of the trapezoid, and the scribe segments have a longer length father from the bus bar near the obtuse-angle corner of the short bus bar edge of the trapezoid.

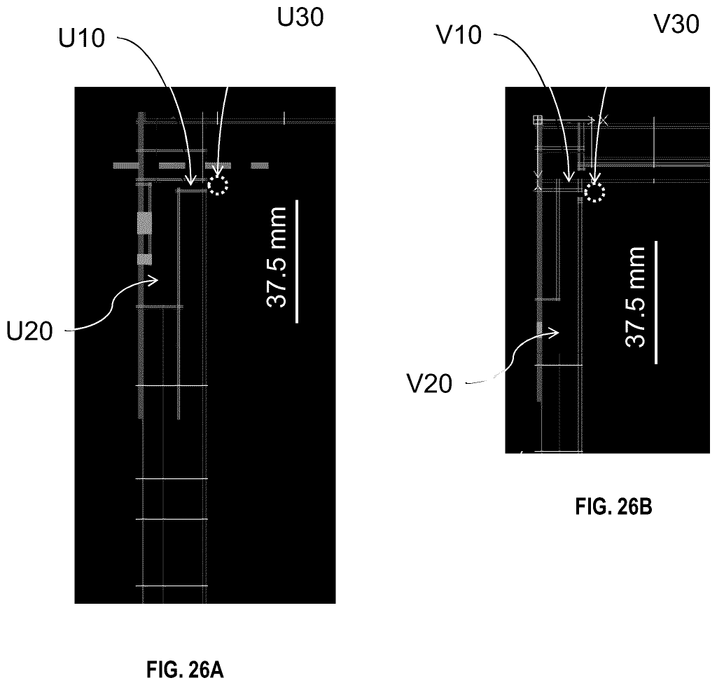

FIGS. 26A and 26B show top-down schematics of the sense voltage pads U10 and V10 on the anode side of the device and on the cathode side of the device, respectively, for the devices used in Examples 6-8. Regions U20 and V20 show areas of the sense voltage terminals, which were used to couple the sense voltage pads to a flex circuit, where the flex circuit had electrical connections to the driver. Sense voltage pads U10 and V10 and sense voltage terminals U20 and V20 in this example can be configured to measure local cell potentials at respective sense voltage measurement positions U30 and V30 within the electrochromic device. Sense voltage pads U10 and V10 and sense voltage terminals U20 and V20 in this example are similar to sense voltage pads D40 and E40 shown in FIGS. 1B and 1C.

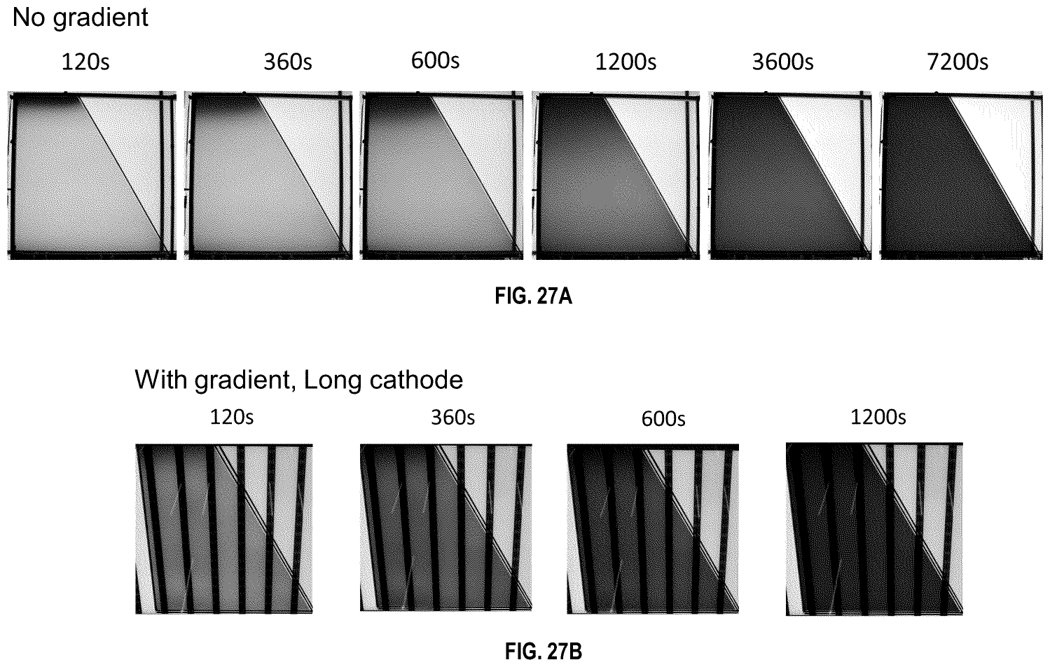

FIGS. 27A and 27B each show a time series of an electrochromic window during switching from bleached to dark. FIG. 27A shows the device in Example 6 over time, and FIG. 27B shows the device in Example 8 over time. The device in Example 8 switches more quickly and more uniformly due to the resistance gradients that were varied in the x- and y-directions, and that were configured to form a region of maximum local cell potential (or, voltage drop) where the sense voltage pad was aligned to the region of maximum local cell potential.

The device shown in FIGS. 23 and 27A (with no gradients in electrical resistance) had a sense voltage pad near the short bus bar, and the local cell potential in that region quickly reached the sense voltage limit, which caused the voltage (or bias) applied to the bus bars to be reduced while the voltage drop across the center regions of the device were low, resulting in slow and non-uniform switching. In contrast, the device shown in FIGS. 25A, 25B and 27B had gradients in electrical resistance formed such that the region of maximum local cell potential aligned with their sense voltage pads, resulting in faster more uniform switching. The gradients in these devices provided more uniform local cell potentials across the device, which allowed them to switch more quickly and more uniformly since there were higher local cell potentials in the central regions of the device even after the sense voltage limit was reached.

What is claimed is:

1. An electrochromic device, comprising:
a first transparent substrate and a second transparent substrate;
a first electrically conductive layer with a first resistance gradient arranged on an inner surface of the first transparent substrate;
a second electrically conductive layer with a second resistance gradient arranged on an inner surface of the second transparent substrate;
a first bus bar in contact with the first electrically conductive layer;
a second bus bar in contact with the second electrically conductive layer;
a first sense voltage pad arranged on the inner surface of the first transparent substrate configured to measure a local cell potential at a sense voltage measurement position within the electrochromic device; and
wherein the first and second resistance gradients are configured to form a region comprising a maximum local cell potential approximately coinciding with the sense voltage measurement position.

2. The electrochromic device of claim 1, wherein the first sense voltage pad is proximate to the region comprising the maximum local cell potential such that a sense voltage measured at the first sense voltage pad is approximately equal to the maximum local cell potential.

3. The electrochromic device of claim 1, further comprising a first sense voltage terminal electrically coupled to the first sense voltage pad, wherein the bus bars are coupled to a driver controlling the electrochromic device, and wherein the first sense voltage terminal is separately coupled to the driver such that the driver can separately address the first bus bar, the second bus bar and the sense voltage terminal.

4. The electrochromic device of claim 1, wherein the first resistance gradient comprises a set of resistances to the flow of electrical current through the first electrically conductive layer that varies as a function of position, and
wherein the second resistance gradient comprises a set of resistances to the flow of electrical current through the second electrically conductive layer that varies as a function of position.

5. The electrochromic device of claim 1, further comprising a second sense voltage pad in contact with the second electrically conductive layer, wherein the second sense voltage pad is configured to measure the local cell potential at the sense voltage measurement position within the electrochromic device.

6. The electrochromic device of claim 1, wherein the electrochromic device is non-rectangular.

7. The electrochromic device of claim 1, wherein the electrochromic device is trapezoidal (e.g., right trapezoidal), triangular, pentagonal, circular, ovular, semicircular, or compound rectilinear.

8. The electrochromic device of claim 1, wherein the first transparent substrate and the second transparent substrate are coupled together in an orientation wherein the first bus bar is at one edge of the electrochromic device and the second bus bar is at an opposing edge of the electrochromic device.

9. The electrochromic device of claim 1, wherein the electrochromic device is non-rectangular and comprises two parallel bus bars.

10. The electrochromic device of claim 1, wherein the electrochromic device is non-rectangular and comprises two non-parallel bus bars.

11. The electrochromic device of claim 1, wherein the first electrically conductive layer is patterned with a first plurality of scribed lines, the first plurality of scribed lines determining the resistance to the flow electrical current in the first electrically conductive layer,
wherein the second electrically conductive layer is patterned with a second plurality of scribed lines, the second plurality of scribed lines determining the resistance to the flow electrical current in the second electrically conductive layer, and
wherein the first and second plurality of scribed lines are configured to align the sense voltage measurement position with the region comprising the maximum local cell potential.

12. The electrochromic device of claim 11, wherein the first and second bus bars are parallel to each other,
wherein the first and/or second electrically conductive layer is patterned with sets of scribed lines substantially parallel to the bus bars, and
wherein adjacent sets of scribed lines determine the resistance to the flow of electrons traversing the adjacent sets of scribed lines in a direction substantially perpendicular to the respective first and/or second bus bar in the respective first and/or second electrically conductive layer.

13. The electrochromic device of claim 11, wherein the sets of scribed lines are made up of a series of segments, which are gaps in the respective first and/or second electrically conductive layer, wherein a length of the segments, a period, a valve width, and an offset between the segments in adjacent sets of scribed lines determine the resistance to the flow of electrons traversing the adjacent sets of scribed lines in a direction substantially perpendicular to the first bus bar in the first electrically conductive layer.

14. The electrochromic device of claim 11, wherein the electrochromic device is non-rectangular and comprises two parallel bus bars.

15. The electrochromic device of claim 11, wherein the electrochromic device is non-rectangular and comprises two non-parallel bus bars.

16. The electrochromic device of claim 1, wherein the first or the second electrically conductive layer comprises a gradient in thickness.

17. The electrochromic device of claim 1, wherein the first or the second electrically conductive layer comprises a gradient in electrical properties.

18. The electrochromic device of claim 1, wherein the first transparent electrically conductive layer comprises a transparent conductive oxide, metallic coatings, nanostructures, conductive metal nitrides, or composite conductors.

19. A method for controlling an electrochromic device, comprising:
applying a constant supply current to the electrochromic device using at least two bus bars of the electrochromic device;
determining an amount of charge transferred to the electrochromic device, as a function of time and current supplied to the electrochromic device;
measuring a sense voltage using a first sense voltage pad of the electrochromic device;
ceasing the applying the constant supply current, responsive to the sense voltage reaching a sense voltage limit;
applying one of a variable voltage or a variable current to the electrochromic device using the bus bars to maintain the sense voltage at the sense voltage limit, responsive to the sense voltage reaching the sense voltage limit; and
terminating the applying the variable voltage or the variable current to the electrochromic device, responsive to the determined amount of charge reaching a target amount of charge,
wherein the electrochromic device comprises two electrically conductive layers each comprising a gradient in electrical resistance,
wherein the sense voltage pad is coupled to one of the electrically conductive layers and is configured to measure a local cell potential at a sense voltage measurement position within the electrochromic device; and
wherein the gradients in electrical resistance are configured to form a region comprising a maximum local cell potential approximately coinciding with the sense voltage measurement position.

20. A method comprising:
applying a constant supply current to an electrochromic device, wherein the electrochromic device comprises:
a first electrically conductive layer arranged on an inner surface of a first transparent substrate, wherein the first electrically conductive layer comprises a first gradient in resistance to the flow of electrical current through the first electrically conductive layer that varies as a function of position;
a second electrically conductive layer arranged on an inner surface of a second transparent substrate, wherein the second electrically conductive layer comprises a second gradient in resistance to the flow of electrical current through the second electrically conductive layer that varies as a function of position;
a first bus bar in contact with the first electrically conductive layer;
a second bus bar in contact with the second electrically conductive layer; and
a first sense voltage pad arranged on an inner surface of the first transparent substrate configured to measure a local cell potential at a sense voltage measurement position within the electrochromic device,
wherein the first and second resistance gradients are configured to form a region comprising a maximum local cell potential approximately coinciding with the sense voltage measurement position, and
wherein the constant supply current to the electrochromic device is applied using the first and second bus bars;
determining an amount of charge transferred to the electrochromic device, as a function of time and current supplied to the electrochromic device;
measuring a sense voltage using the first sense voltage pad of the electrochromic device;
ceasing the applying the constant supply current, responsive to the sense voltage reaching a sense voltage limit;
applying one of a variable voltage or a variable current to the electrochromic device using the bus bars to maintain the sense voltage at the sense voltage limit, responsive to the sense voltage reaching the sense voltage limit; and
terminating the applying the variable voltage or the variable current to the electrochromic device, responsive to the determined amount of charge reaching a target amount of charge.

21. A method comprising:
forming an electrochromic device comprising:
forming a first electrically conductive layer arranged on an inner surface of a first transparent substrate, wherein the first electrically conductive layer comprises a first gradient in resistance to the flow of electrical current through the first electrically conductive layer that varies as a function of position;
forming a second electrically conductive layer arranged on an inner surface of a second transparent substrate, wherein the second electrically conductive layer comprises a second gradient in resistance to the flow of electrical current through the second electrically conductive layer that varies as a function of position;
forming a first bus bar in contact with the first electrically conductive layer;
forming a second bus bar in contact with the second electrically conductive layer; and
forming a first sense voltage pad arranged on an inner surface of the first transparent substrate configured to measure a local cell potential at a sense voltage measurement position within the electrochromic device,
wherein the first and second resistance gradients are configured to form a region comprising a maximum local cell potential approximately coinciding with the sense voltage measurement position;
applying a constant supply current to the electrochromic device using the first and second bus bars of the electrochromic device;
determining an amount of charge transferred to the electrochromic device, as a function of time and current supplied to the electrochromic device;
measuring a sense voltage using a first sense voltage pad of the electrochromic device;
ceasing the applying the constant supply current, responsive to the sense voltage reaching a sense voltage limit;
applying one of a variable voltage or a variable current to the electrochromic device using the bus bars to maintain the sense voltage at the sense voltage limit, responsive to the sense voltage reaching the sense voltage limit; and
terminating the applying the variable voltage or the variable current to the electrochromic device, responsive to the determined amount of charge reaching a target amount of charge.

22. A method for controlling an electrochromic device, comprising:
applying a constant supply current to the electrochromic device using at least two bus bars of the electrochromic device;
measuring a sense voltage using a first sense voltage pad of the electrochromic device;
ceasing the applying the constant supply current, responsive to the sense voltage reaching a sense voltage limit;
applying one of a variable voltage or a variable current to the electrochromic device using the bus bars to maintain the sense voltage at the sense voltage limit, responsive to the sense voltage reaching the sense voltage limit; and
terminating the applying the variable voltage or the variable current to the electrochromic device, responsive to a trigger, wherein the trigger optionally comprises a determined amount of charge reaching a target amount of charge, a time limit being reached, a current limit being reached, or a current flow dropping below a predetermined threshold,
wherein the electrochromic device comprises two electrically conductive layers each comprising a gradient in electrical resistance,
wherein the sense voltage pad is coupled to one of the electrically conductive layers and is configured to measure a local cell potential at a sense voltage measurement position within the electrochromic device; and
wherein the gradients in electrical resistance are configured to form a region comprising a maximum local cell potential approximately coinciding with the sense voltage measurement position.

23. A method comprising:
modeling resistance gradients of electrically conductive layers of an electrochromic device with two bus bars using a finite element model, wherein the modeling comprises:
starting with initial resistance gradients of the electrically conductive layers;
defining a first region comprising a sense voltage pad;
providing a target local cell potential map comprising a target local cell potential value across an active area of the electrochromic device, and a maximum local cell potential within the first region;
using the finite element model to produce final resistance gradients of the electrically conductive layers to form a final local cell potential map, wherein a difference between the final local cell potential map and the target local cell potential map is minimized by the finite element model, and wherein the final resistance gradients comprise gradients in an x-direction that is approximately perpendicular to the bus bars of the electrochromic device and in a y-direction that is perpendicular to the x-direction.

24. The method of claim 23, wherein the initial resistance gradients of the electrically conductive layers comprise a gradient in the x-direction and no gradients in the y-direction.

25. The method of claim 23, further comprising forming the resistance gradients of the electrically conductive layers of the electrochromic device.

26. The method of claim 25, wherein the electrically conductive layers comprise a transparent conductive oxide material, and wherein the forming the resistance gradients comprises forming a scribe pattern using a laser.

27. The method of claim 25, wherein the electrically conductive layers comprise a transparent conductive oxide material, and wherein the forming the resistance gradients comprises forming the electrically conductive layers with varying thicknesses.

28. The method of claim 25, wherein the electrically conductive layers comprise a transparent conductive oxide material, and wherein the forming the resistance gradients comprises forming the electrically conductive layers with varying electrical properties

29. The method of claim 25, further comprising:
forming the electrically conductive layers on two substrates;
forming a first electrochromic layer on one of the electrically conductive layers; and
coupling the two substrates together using an ion conducting layer such that the electrically conductive layers are facing one another and the two substrates are on the outside.

30. The method of claim 29, further comprising forming a second electrochromic layer on the other electrically conductive layer before coupling the substrates together.

31. The method of claim 23, wherein the initial resistance gradients of the electrically conductive layers are analytically produced, or are produced using discrete numerical methods.

32. The method of claim 23, wherein the final resistance gradients are produced for different external biases applied to the bus bars of the electrochromic device.

33. The method of claim 23, wherein the bus bars are parallel to each other.
